(19) United States
(12) Patent Application Publication
(10) Pub. No.: US 2024/0429391 A1
(43) Pub. Date: Dec. 26, 2024

(54) IONIC BINDERS FOR SOLID STATE ELECTRODES

(71) Applicant: DEAKIN UNIVERSITY, Victoria (AU)

(72) Inventors: Patrick Howlett, Victoria (AU); Maria Forsyth, Victoria (AU); Robert Kerr, Victoria (AU); Tiago Mendes, Victoria (AU); Hiroyuki Ueda, Victoria (AU); Yan Liang, Victoria (AU)

(21) Appl. No.: 18/684,742

(22) PCT Filed: Aug. 19, 2022
(86) PCT No.: PCT/AU22/50931

§ 371 Date: Feb. 19, 2024

(30) Foreign Application Priority Data
Aug. 20, 2021 (AU) 2021902629
Aug. 20, 2021 (AU) 2021902630

(51) Int. Cl. H01M 4/62; H01M 4/02; H01M 4/583; H01M 10/0565; H01M 50/417; H01M 50/46

(52) U.S. Cl. CPC H01M 4/622; H01M 4/583; H01M 10/0565; H01M 50/417; H01M 50/46; H01M 2004/027; H01M 2004/028; H01M 2300/0082

(57) ABSTRACT

An electrode for an all-solid-state energy storage device, the electrode comprising an electrode composition comprising an electroactive material and an internal ionic binder in the form of at least one organic ionic plastic crystal (OIPC) and ion transport salt composite which supports comparable performance of the electrode to one using liquid electrolyte.

### TECHNICAL FIELD

The invention relates to a new class of conductive, functional ionic binders, having plastic crystal properties for use in electrodes, e.g., for solid state batteries.

### BACKGROUND

Currently, lithium-ion batteries (LIBs), composed with carbon-based anodes and lithium metal oxide cathodes, separated by a liquid electrolyte, govern the battery market offering long service life and high energy density. Demand for large-scale LIB utilization is ever growing along with a rapid expansion of the electric vehicles (EVs) market. However, to extensively use LIBs in such a large-scale application, their safety must be ensured. However, at the cell-chemistry level, LIBs use flammable organic liquid electrolytes. The traditional liquid electrolyte is the bottle-neck from a safety stand point due to their high flammability which is more serious for next generation batteries where lithium metal anodes are used due to their tendency to short-circuit. Consequently, all solid-state batteries (ASSBs) have attracted a lot of attention for their no-leakage and the fact that they limit the growth of lithium dendrites by the presence of a physical barrier. ASSBs with solid electrolytes as ion-conductive pathways have higher thermal stability than conventional liquid electrolytes in LIBs. One goal of the invention is to provide cost effective ASSBs having comparable performance with LIBs which means replacement of LIBs with ASSBs becomes a viable possibility.

While in liquid-based batteries, electrode pores are filled with liquid electrolyte and the addition of interconnected carbon provides sufficient ionic and electronic pathways within the electrode, in truly solid-state systems, the electrodes remain dry of liquid and hence, empty of mobile ions fordoping and dedoping the active material. As result, a shift from porous to dense electrodes have been proposed with promising performance, where ionically conducting binder such as ionic liquid is used to provide the necessary ionic conductivity, while the use of traditional carbon additives remains to provide electronic conduction in solid-state devices. However, the ionic conductivity in conducting polymers is rarely reported and the use of ionic liquids does not overcome the issues related with liquid electrolyte, such as leakage.

Another important factor is process applicability of solid-state electrodes comprising active materials and solid electrolytes (plus, if necessary, conductive additives and binders) to current LIB production lines. Highly compatible electrode preparation methods would facilitate take up of ASSBs in energy storage applications. Although inorganic solid electrolytes are promising materials in terms of their bulk ionic conductivities, they require additional high temperature/high pressure steps to form void-free contacts between the solid electrolytes and active materials of the electrode. In this context, organic solid electrolytes become attractive candidates because of their excellent process applicability, for which current LIB fabrication technologies can be simply employed without implementing any additional low-throughput processes.

Used in organic solid electrolytes, organic ionic plastic crystals (OIPCs) are the emerging class of ion conductors. They are solid-state analogues of ionic liquids and inherit advantages from their ionic nature including low flammability, negligible vapor pressure, and high thermal and chemical stability. While OIPCs have been used in interlayers between cathodes and anodes, they have not been previously used inside solid-state electrode compositions or electrode composition slurry for electrode casting/compaction as an intrinsic component of an electrode slurry.

### STATEMENTS OF INVENTION

Described herein is an electrode and an all-solid-state energy storage device comprising the electrode, the electrode comprising an electrode composition comprising an electroactive material and an internal ionic binder in the form of at least one organic ionic plastic crystal (OIPC). Desirably, the electrode is free of ionically conducting polymer electrolyte. Suitably, the internal ionic binder is a preformed composite of organic ionic plastic crystal (OIPC) and transport ion salt. It should be understood that the preformed composite binder is intrinsically associated with the other electrode components during blending and slurry formation and is itself subjected to the same processing as the active components in the electrode e.g., solvent evaporation, compaction or densification etc. It should be understood that it is not added during manufacture to a preformed electrode, for example, by drop casting in a solution ortho like. The dry polymer electrolyte free electrodes are found to be sufficiently ionically conductive and stable on cycling in an ASS device so as to provide comparable cycling and/or capacity storage and release performance to an otherwise equivalent device provided with a liquid electrolyte. The invention provides an energy storage device comprising one or more electrodes of the invention, a counter electrode and an electrolyte, preferably a solid electrolyte.

The invention provides a use of an organic ionic plastic crystal (OPIC) as an internal ionic binder in a conversion material electrode; as an internal ionic binder in an intercalation electrode; as an internal ionic binder in an alloying electrode.

In one aspect, the invention provides an electrochemical energy storage device comprising at least one positive electrode and at least one negative electrode pair, wherein at least one electrode is a solid-state electrode in the form of a dry electrode composition comprising: -particles of an electrochemically active material; optional particles of electronically conductive additive; optional particles of a non-ionically conducting polymer binder; and an internal ionic binder in the form of a preformed intimate composite of organic ionic plastic crystal (OIPC) and transport ion salt. The invention extends to a cell (e.g. half cell) where the positive electrode is the working electrode and the negative electrode is a counter electrode.

Preferably, voids between the particles are filed with the internal ionic binder. The voids block or interrupt ion conduction pathways in the electrode. Filling the voids with the OIPC composite completes such interrupted ion conduction pathways. Thus in the electrodes of the invention the OIPC composite complete or produces new ion conduction pathways that are otherwise not present.

Desirably, the device is configured as an all solid state energy storage device and further comprising an ion transport interlayer disposed between each pair of the electrodes, where a separated portion of interlayer is in direct contact with each electrode in a pair and contact between the ion transport interlayer and each electrode involves substantially void free contact.

In another aspect, the invention provides all-solid-state energy device comprising at least one positive electrode and at least one negative electrode pair, wherein the negative electrode is an alloying or an insertion type solid state negative electrode, comprising a dry electrode composition including: particles of an electrochemically active material selected from hard carbon, graphite; silicon; phosphorus; selenium; antimony; bismuth; lithium alloys such as lithium titanates, particularly lithium titanium oxide; or metallic anode materials such as lithium metal and sodium metal; optional particles of electronically conductive additive; optional particles of a non-ionically conducting polymer binder; and an internal ionic binder in the form of a preformed intimate composite of organic ionic plastic crystal (OIPC) selected from the group consisting of: C₂mpyrBF₄; C₂mpyrFSI; and C₂mpyrTFSI, and transport ion salt selected from the group consisting of LiFSI, LiBF₄, LiTFSI, LiOTf₂, NaFSI, NaBF₄, NaTSI, NaTFSI, or NaOTf₂.

In a fifth aspect, the invention provides an all-solid-state energy device comprising at least one positive electrode and at least one negative electrode pair, and an ion transport interlayer comprising at least an organic ionic plastic crystal (OIPC) selected from the group consisting of: C₂mpyrBF₄; C2mpyrFSI; and C₂mpyrTFSI, and transport ion salt selected from the group consisting of LiFSI, LiBF₄, LiTFSI, LiOTf₂, NaFSI, NaBF₄, NaTSI, NaTFSI, or NaOTf₂, disposed between each pair of the electrodes, where a separate portion of interlayer is in direct contact with each electrode in a pair, wherein the negative electrode is an alloying or an insertion type solid-state negative electrode free of ionically conducting polymer electrolyte or monomer of ionically conducting polymer electrolyte, comprising a dry electrode composition including: particles of an electrochemically active material selected from hard carbon, graphite; silicon; phosphorus; selenium; antimony; bismuth; lithium alloys such as lithium titanates, particularly lithium titanium oxide; or metallic anode materials such as lithium metal and sodium metal; optional particles of electronically conductive additive; optional particles of a non-ionically conducting polymer binder; and an internal ionic binder in the form of a preformed intimate composite of organic ionic plastic crystal (OIPC) and transport ion salt which are the same as the OIPC and the transport ion salt in the ion transport interlayer.

Desirably, the OIPC composite is a preformed mixture of e.g., [C₂mpyr][FSI] and LiFSI·ss

Desirably, the all solid state device has a negative electrode is a silicon or a graphite electrode.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

Further aspects of the invention appear below in the detailed description of the invention.

### DETAILED DESCRIPTION OF THE DRAWINGS

Embodiments of the invention will herein be illustrated by way of example only with reference to the accompanying drawings in which:

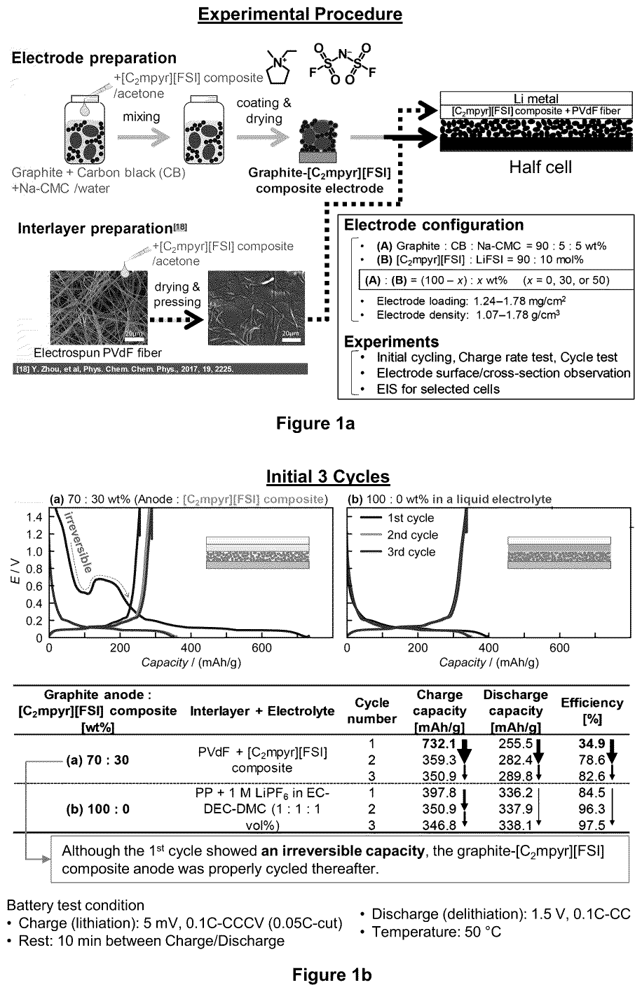

FIG. 1a shows a schematic of the procedure for forming a solid state device including a graphite-OIPC:salt ionic binder of the invention and configuration in an all solid state half cell involving Li metal as counter electrode, the interlayer is a membrane in the form of a composite of electrospun PVdF fibre and embedded OIPC:salt ASSB with a Li metal counter electrode; FIG. 1b shows charge-discharge curves for a solid-state graphite-[C₂mpyr][FSI] ionic binder composite anode (70 wt % graphite anode+30 wt % [C₂mpyr][FSI] composite) compared to charge-discharge curves for the same graphite anode with a liquid electrolyte, 1.0 M LiPF₆ in EC-DEC-DMC (1:1:1 volume ratio) at the first three cycles at 50° C. Comparison shows similarly of performance;

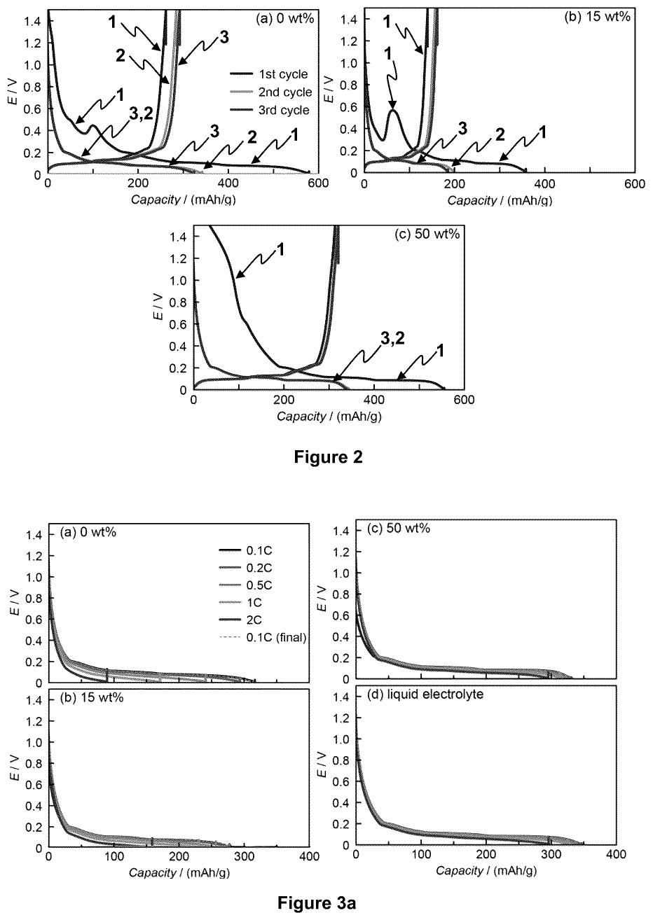

FIG. 2 shows charge-discharge curves for (a) the solid-state graphite anode with 0 wt % [C₂mpyr][FSI] composite (no ionic binder) and the solid-state graphite-[C₂mpyr][FSI] composite anodes with (b) 15 wt % and (c) 50 wt % [C₂mpyr][FSI] composite at the first three cycles at 50° C.;

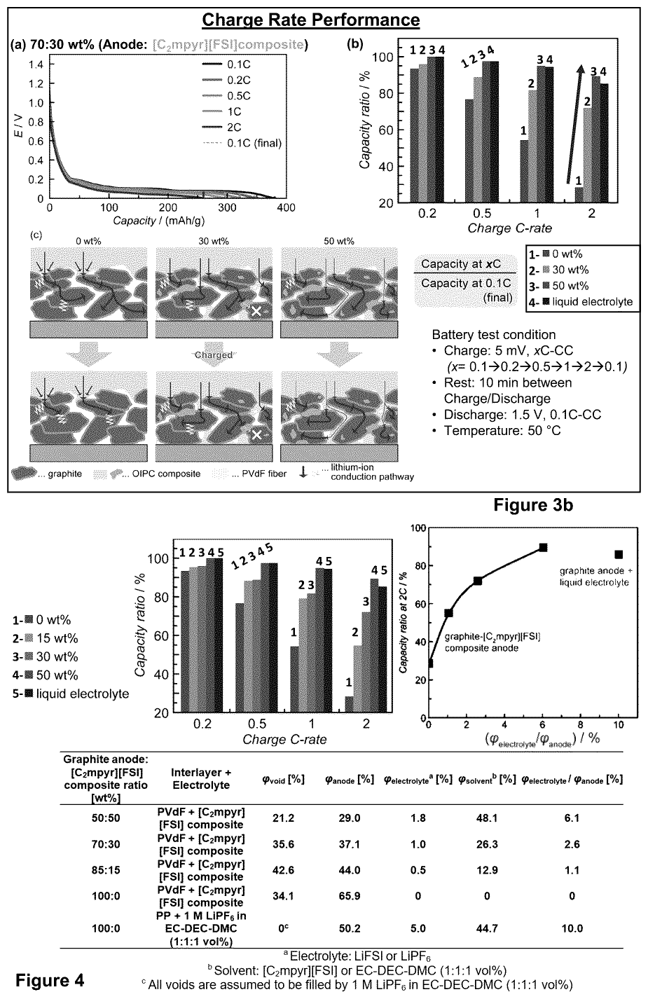

FIG. 3a shows (a) charge curves for (a) the solid-state graphite anode without the [C₂mpyr][FSI] composite, the solid-state graphite-[C₂mpyr][FSI] composite anodes with (c) 15 wt % and (c) 50 wt % [C₂mpyr][FSI] composite, and (d) the graphite anode with a liquid electrolyte, 1.0 M LiPF₆ in EC-DEC-DMC (1:1:1 volume ratio) at 50° C. (e) Capacity ratio at each charge C-rate. FIG. 3b shows (a) charge curve for the solid-state graphite-[C₂mpyr][FSI] composite anodes with 30 wt % [C₂mpyr][FSI] composite; (b) plots of the capacity ratio at 2 C charging vs. σelectrolyte/σanode at 50° C.; schematic of blocked ion transport channels and blockages filled with ionic binder; void free contacts between current collection and electrode, and electrode and interlayer are shown to be facilitated by the ionic binder;

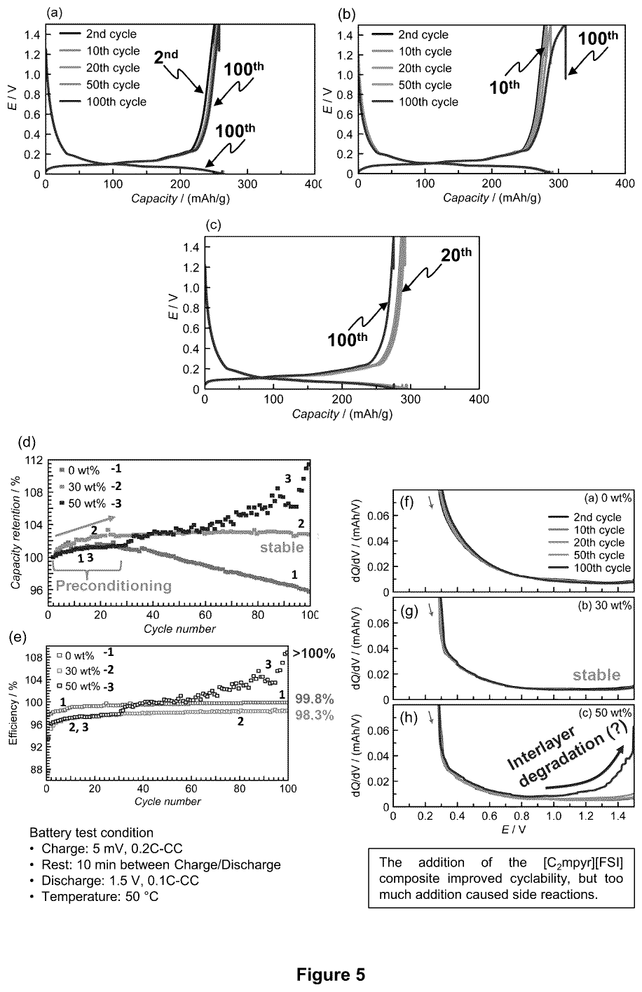

FIG. 4 shows plots of the capacity ratio at 2 C charging vs. σelectrolyte/σanode at 50° C.; Table in figure shows composition, volume fractions of voids (σvoid), an anode (including graphite, carbon black, and Na-CMC) (σanode), an electrolyte (σelectrolyte), and a solvent (σsolvent), and σelectrolyte/σsolvent; (f) to (g) show DQ/dV curves for the 0, 30, and 50 wt % systems; FIG. 5 shows charge-discharge curves for the solid-state graphite-[C₂mpyr][FSI] composite anode (a) 70 wt % graphite anode+30 wt % [C₂mpyr][FSI] composite, (b) 50 wt % graphite anode+50 wt % [C₂mpyr][FSI] composite, (c) the solid-state graphite anode 0 wt % [C₂mpyr][FSI] at the 2nd, 10th, 20th, 50th, and 100^{th} cycles at 50° C., (d) capacity retention and (e) Coulombic efficiency at each cycle.

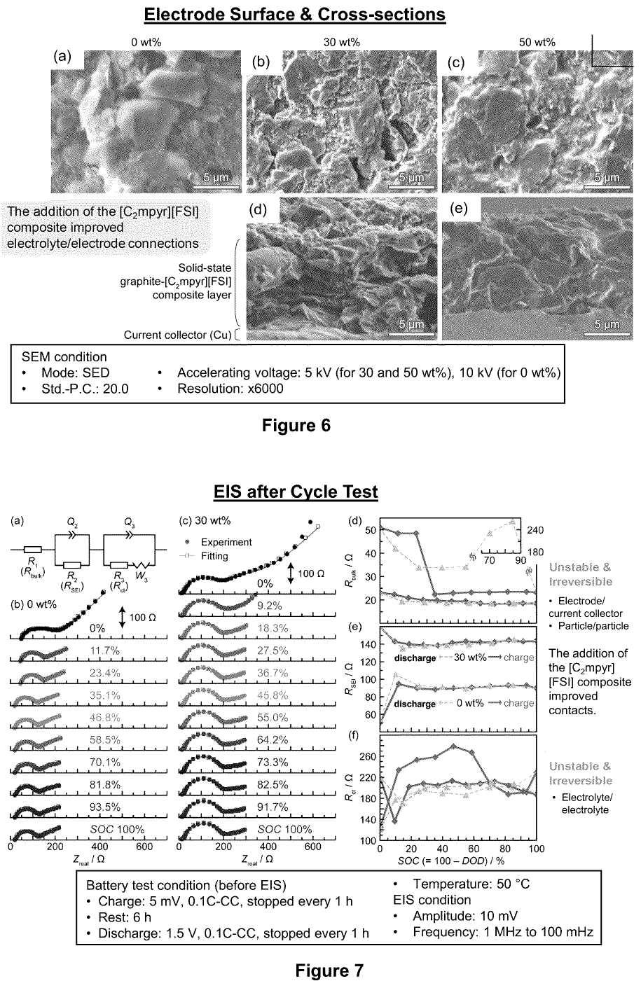

FIG. 6 shows SEM images of (a) the 0 wt % solid-state graphite anode and (b-e) the solid-state graphite-[C₂mpyr][FSI] composite anodes; (b,d) 70 wt % graphite anode+30 wt % [C₂mpyr][FSI] composite; (c,e) 50 wt % graphite anode+50 wt % [C₂mpyr][FSI] composite;

FIG. 7 shows results of EIS studies showing addition of OIPC composite ionic binder improved contacts;

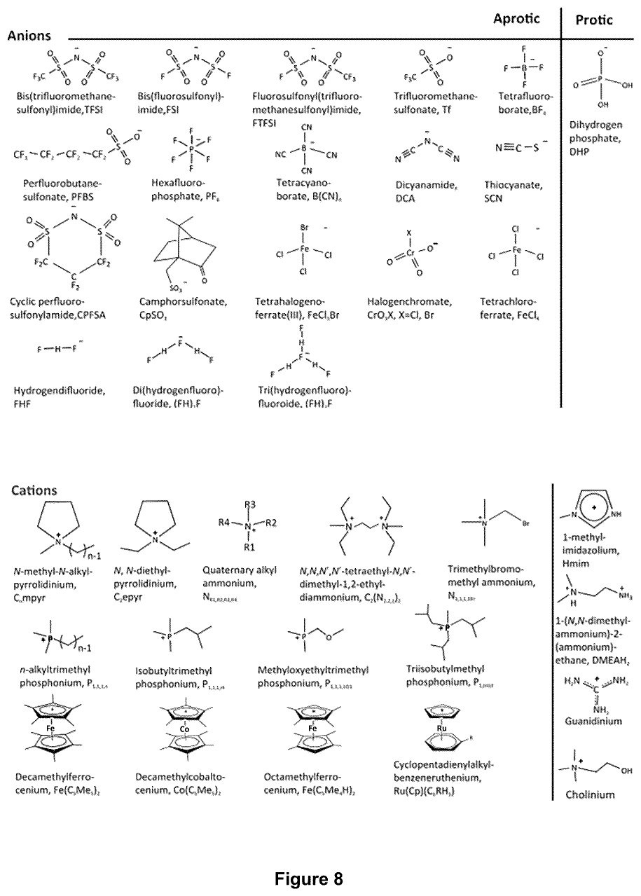

FIG. 8 shows examples of typical OIPC cations and anions;

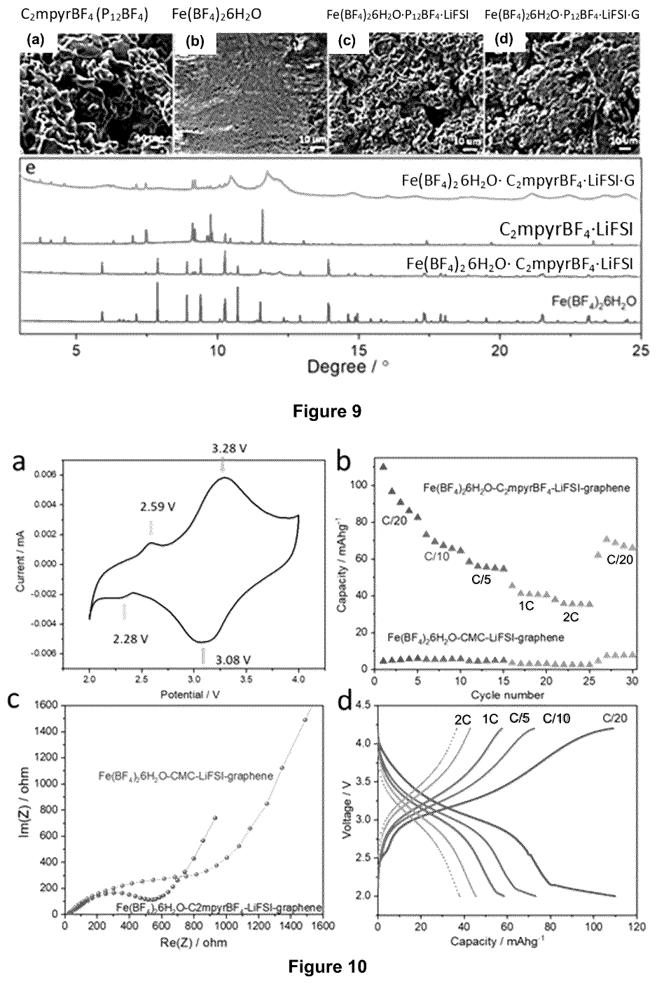

FIG. 9 shows (a) C₂mpyrBF₄ (P12BF₄), (b) Fe(BF₄)₂×6H₂O, (c) Fe(BF₄)₂×6H₂O/C₂mpyrBF₄-LiFSI and (d) Fe(BF₄)₂×6H₂O—C₂mpyrBF₄-LiFSI-graphene; (e) X-Ray Diffraction;

FIG. 10 shows (a) the CV curves of Fe(BF₄)₂×6H₂O/C₂mpyrBF₄/LiFSI/graphene cathode in the voltage range between 2.0 V and 4.0 V with 0.1 mV/s scan speed, (b) Rate performance and
(c) Electrochemical impedance spectroscopy (EIS) plots of Fe(BF₄)₂×6H₂O/C₂mpyrBF₄/LiFSI/graphene and Fe( BF₄)₂×6H₂O/CMC/LiFSI/graphene tested at 50° C.; (d) The galvanostatic charge—is charge first cycling of Fe(BF₄)₂6H₂O/C₂mpyrBF₄/LiFSI/graphene at different current rate. The electrolyte is PVDF film supported Pdadma/C₃mpyrFSI/LiFSI, the anode is Li metal;

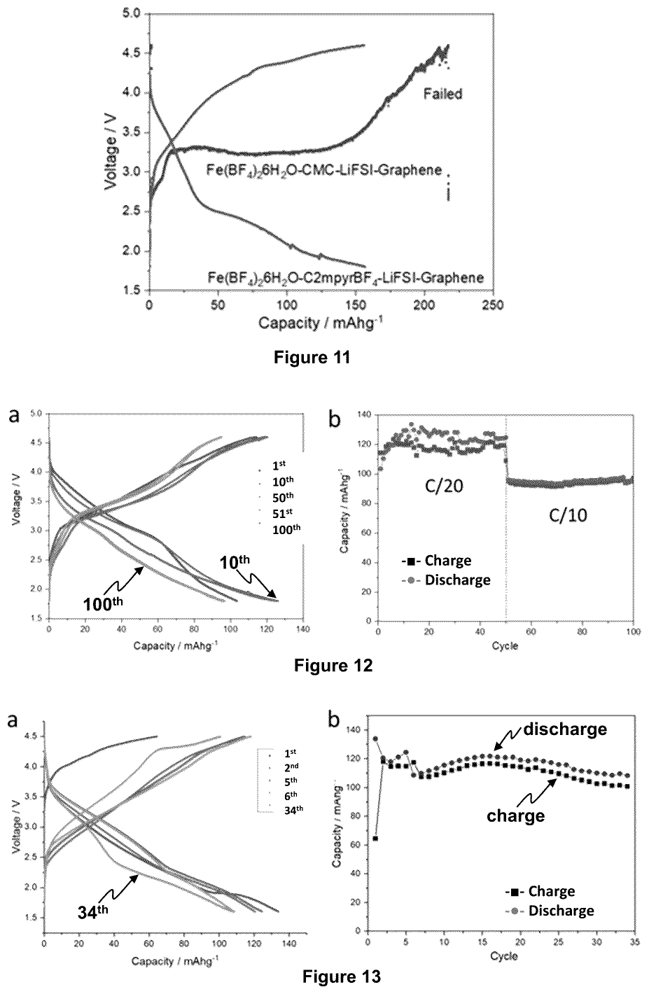

FIG. 11 shows (a) the galvanostatic charge-discharge first cycling of Fe(BF₄)₂6H₂O/C₂mpyrBF₄/LiFSI/graphene and Fe(BF₄)₂6H₂O/CMC/LiFSI/graphene at 50° C. with cathode loading 0.8 mg/cm². The charge rate is 0.05 C. The electrolyte is PVDF powder/C₂mpyrBF₄/LiFSI, the anode is Li metal;

FIG. 12 shows the galvanostatic charge-discharge first cycling of Fe(BF₄)₂6H₂O/C₂mpyrBF₄/LiFSI/graphene tested in lithium battery at 50° C., with cathode loading 0.72 mg/cm². (b) The corresponding cycle number-capacity curves over 100 cycles. The charge rate is 0.05 C for 1^{st}-50^{th} cycle and 0.1 C for 51^{st}-100^{th} cycle. The electrolyte is PVDF powder/C₂mpyrFSI/LiFSI, the anode is Li metal;

FIG. 13 shows the galvanostatic charge-discharge first cycling of Fe(BF₄)₂6H₂O/C₂mpyrBF₄/NaFSI/graphene tested in sodium battery at 50° C., with cathode loading 0.8 mg/cm²; (b) The corresponding cycle number-capacity curves over 100 cycles. The charge rate is 0.05 C for 1^{st}-5^{th} cycle and 0.1 C 6^{th}-100^{th} cycle. The electrolyte is PVDF powder/C2mpyrFSI//NaFSI, the anode is Na metal;

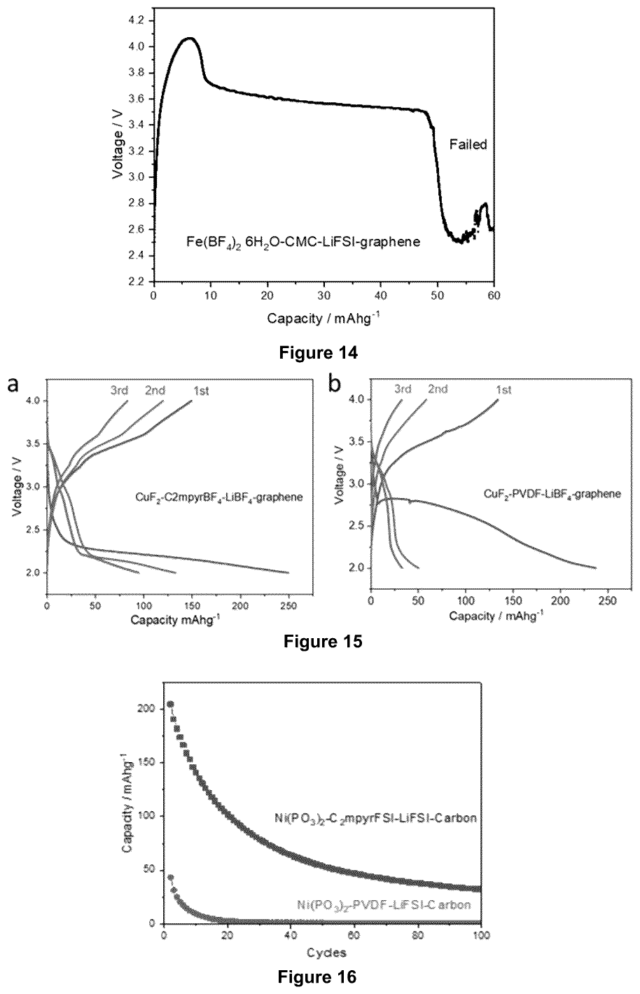

FIG. 14 shows (a) the galvanostatic charge-discharge first cycling of Fe(BF₄)₂6H₂O/CMC/LiFSI/graphene at 50° C. with cathode loading 0.6 mg/cm². The charge rate is 0.05 C. The electrolyte is C₃mpyrFSI/LiFSI (liquid), the anode is Li metal;

FIG. 15 shows the first three galvanostatic charge-discharge cycles of (a) CuF₂/C₂mpyrBF₄/Li BF₄/graphene cathode (cathode loading 0.6 mg/cm²) and (b) CuF₂/PVDF/LiBF₄/graphene (cathode loading 1.1 mg/cm²). The cells were tested at 50° C. and the charge rate is 0.05 C. The electrolyte is PVDF film supported PDADAMA/C₃mpyrFSI/LiFSI, the anode is Li metal;

FIG. 16 shows the stability performance of Ni(PO₃)₂-PVDF-LiFSI-Carbon (cathode loading 1 mg/cm²) and Ni(PO₃)₂-C₂mpyrFSI-Carbon (cathode loading 3 mg/cm²) over 100 cycles at 50° C. within the voltage range 1-3.7 V. The charge rate is 0.05 C. The electrolyte is PVDF powder/C2mpyrFSI/LiFSI, the anode is Li metal;

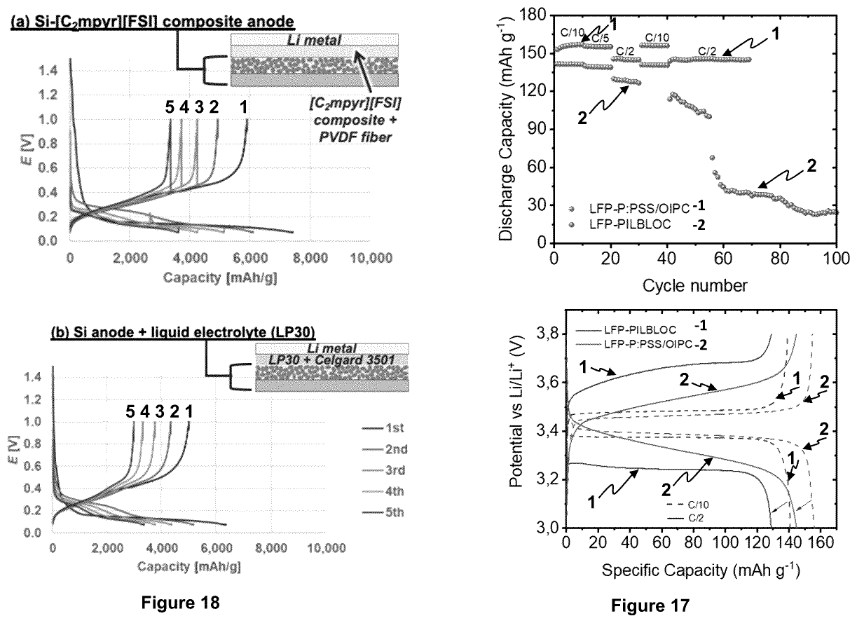

FIG. 17 shows a) Cycling performance at C/10, C/5 and C/2; and b) voltage profiles at C/10 and C/2 of Li| PILBLOC|LFP cell different conducting binders cycled at 70° C.;

FIG. 18 shows the cycling performance of Si anodes (loading 0.22-0.28 mg/cm², C/50, 50° C.) of (a) [C₂mpyr][FSI] composite anode, composition Si:carbon black:Na-CMC:[C₂mpyr][FSI]:LiFSI=59.5:12.8:12.8:9.2:5.8 wt % employing a [C₂mpyr][FSI] PVDF fibre composite interlayer electrolyte and (b) a Si anode, composition Si:carbon black:Na-CMC=70:15:15 wt % employing a liquid electrolyte, 1 M LiPF₆ in EC-DMC (1:1 vol %);

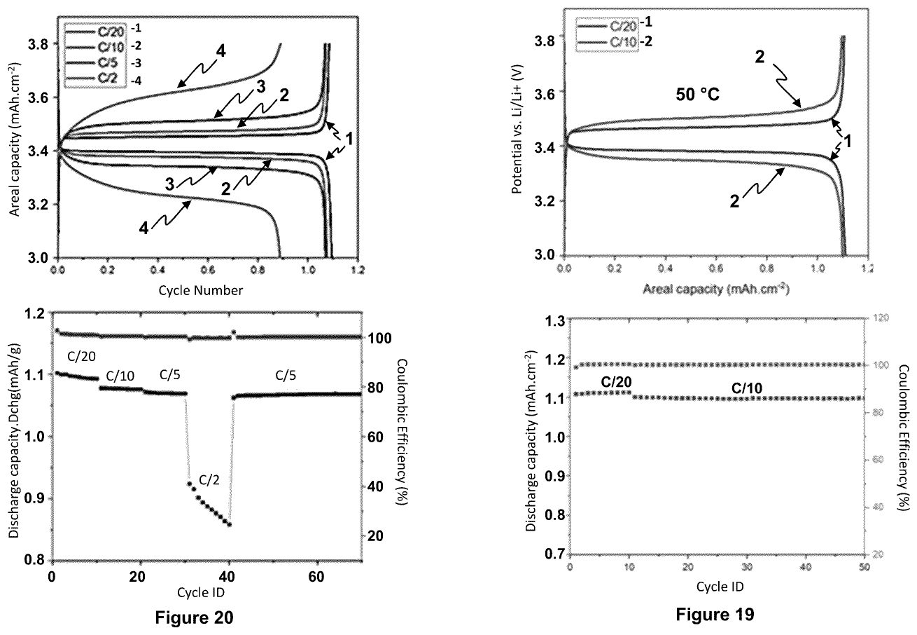

FIG. 19 shows the cycling performance of LiFePO₄ composite electrode (60 wt % LiFePO₄, 25 wt % [C₂mpyr][FSI], 10 wt % C65, loading 1.1 mAh/cm²) at C/20 and C/10 at 50° C. using a PILBLOC solid electrolyte membrane (3 mols LiFSI/PIL unit and 1.5 mols C₃mpyrFSI/PIL unit);

FIG. 20 shows the cycling performance of LiFePO₄ composite electrode (60 wt % LiFePO₄, 25 wt % [C₂mpyr][FSI], 10 wt % C65, loading 1.1 mAh/cm²) at C/20, C/10, C/5 and C/2 at 50° C. using a PILBLOC solid electrolyte membrane (3 mols LiFSI/PIL unit and 1.5 mols C₃mpyrFSI/PIL unit);

FIG. 21 shows the cycling performance of LiMn₂O₄ composite electrode (60 wt % LiFePO₄, 25 wt % [C₂mpyr][FSI], 10 wt % C65, loading 1.1 mAh/cm²) at C/10 (first 2 cycles) and then 1 C at 50° C. using a PILBLOC solid electrolyte membrane (3 mols LiFSI/PIL unit and 1.5 mols C₃mpyrFSI/PIL unit);

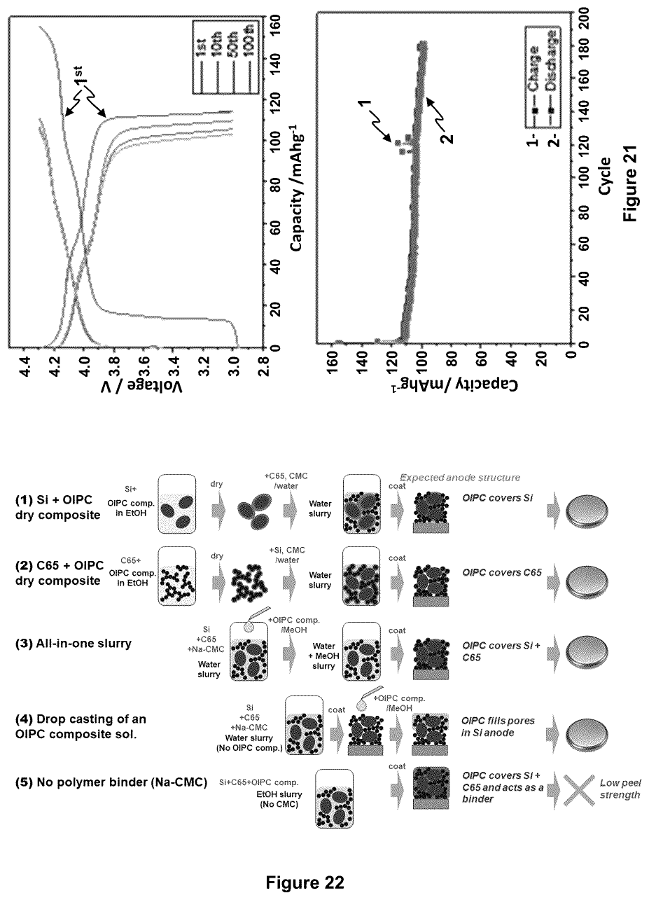

FIG. 22 shows schematically the preparation of a number of different Si-ionic binder electrodes which can be used to incorporate ionic binder into the electrode as (1) coating on silicon particles, (2) coating on conducting carbon (C₆₅) particles, (3) coating on both Si and C65 particles. Contrast to (4) drop casting of OIPC composite on a preformed electrode; or (Ref) electrode without CMC binder which had a low peel strength;

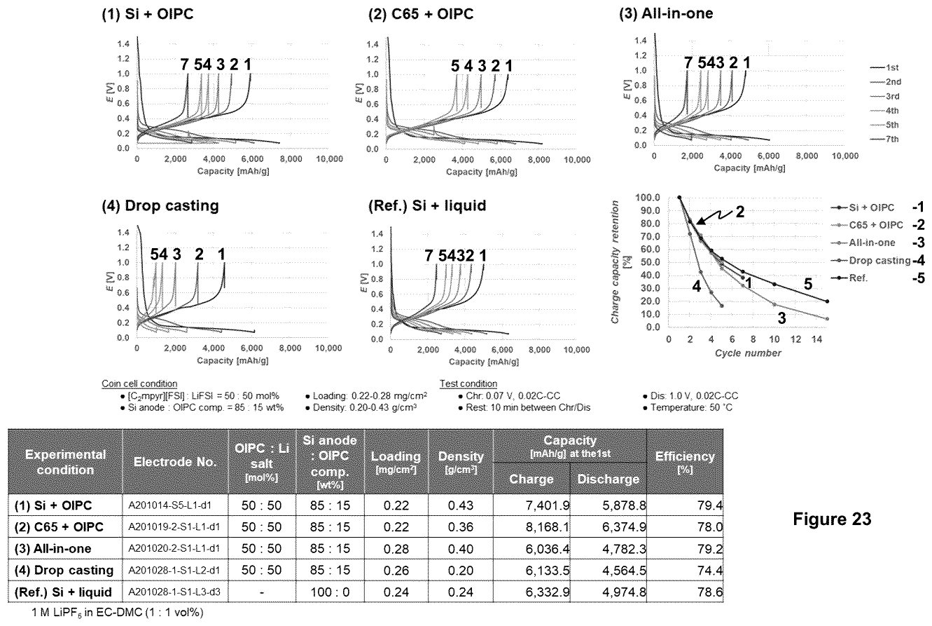

FIG. 23 shows cycling performance of electrodes prepared according to FIG. 22;

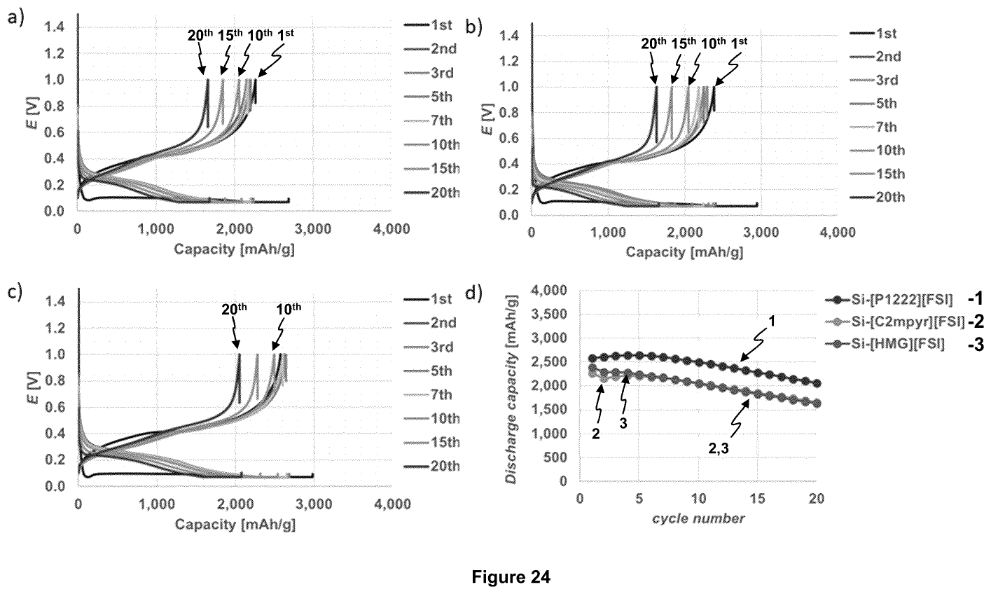

FIG. 24 shows the cycling performance of Si-OIPC composite anodes (Si loading 1.22-1.48 mg/cm², employing a polypropylene separator filled with the Li-doped [P₁₂₂₂][FSI] electrolyte, C/10 for charging, C/50 for discharging, 50 C) where the OIPC is (a) [C₂mpyr][FSI], (b) [HMG][FSI] and (c) [P₁₂₂₂][FSI]. The composition of the Si-OIPC composite anodes is Si:graphene:Na-CMC:citric acid:KOH:OIPC:LiFSI=w1:w2:w3:w4:w5:w6 wt %, where (w1:w2:w3:w4:w5:w6)=(61.5, 9.6, 6.0, 7.0, 0.8, 9.2, 5.9) for [C₂mpyr][FSI], (61.6, 9.5, 6.1, 7.0, 0.8, 9.5, 5.5) for [HMG][FSI], and (61.4, 9.4, 6.0, 7.0, 0.8, 9.6, 5.7) for [P₁₂₂₂][FSI]. (d) shows the discharge capacity for 20 charge-discharge cycles for each of the cells;

FIG. 25 shows the discharge capacity for 15 charge-discharge cycles for Si-OIPC composite anodes with C₂moxa, employing a polypropylene separator filled with the Li-doped [C₂mpyr][FSI] salt 50:50 mol % electrolyte, C/10 for charging, C/50 for discharging, 50° C.) and

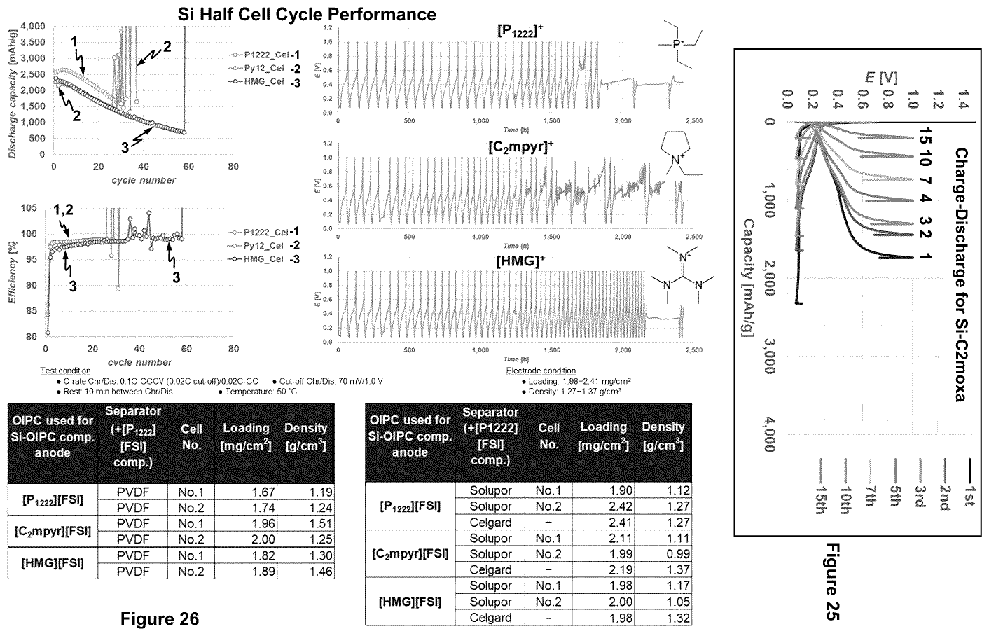

FIG. 26 shows half cell cycle performance of Si electrode with (1) [P₁₂₂₂][FSI]:LiFSI salt 50:50 mol % composite; (2) [C₂mpyr][FSI]:LiFSI salt 50:50 mol % composite and (3) [HMG][FSI]:LiFSI salt 50:50 mol % composite in half cell configuration with PVDF, Solupor or Celgard membrane separator filled with [P₁₂₂₂][FSI] composite.

### DETAILED DESCRIPTION OF THE INVENTION

Inclusion of organic ionic plastic crystal compounds (OIPCs) as conductive, functional and/or ionic binders (or inclusion of an intimate OIPC composite with ion transport salt) (collectively described herein as OIPC binder) as a fundamental individual component as an electrode composition has been found to provide favourable affects in electrode performance, particularly where the electrodes are used in solid state electrodes and particularly in all-solid state energy storage devices which include a solid state electrolyte. By composite it is meant an intimate dry mixture of OIPC and transport metal ion in a desired ratio that is preformed separately and then added to the other components of the electrode composition to prepare a slurry used to form the electrode. Thus when it is added to the electrode composition during formation, the OIPC/salt combination in composite form functions as a distinct, intimate ionic binding component where the OPIC and salt are inextricably associated together as a single component in the electrode compositions. This is not the same as drop casting OIPC in liquid monomer into an already made electrode as carried out by Ogawa 2019, Polymer 178 (2019) 121614. Desirably, the OIPC binder/composite binder described herein incorporates significant ionic conductivity into a solid state electrode while advantageously providing favourable additional performance effects including one or more of: (i) improved mechanical properties of the electrodes incorporating OIPCs/OIPC composite binders due to the soft and plastic nature of the OIPC; (ii) production of target-ion (e.g., Li, Na, Fe, etc.) conduction pathways, sometimes through formation of new highly ionically conductive new phases(s) within the electrode composition which have particularly favourable ion conduction pathways; (iii) improved interfacial contact between (a) electrode/solid electrolyte and/or (b) electrode/current collector substrate through e.g., SEI formation at the respective interfaces and/or improved adhesion arising from the plastic nature of the OIPC. Also OIPC binder enhances one or more of electrolyte/electrode interfacial contact and electrode/current collector interfacial contact and adhesion, e.g. by forming void free contacts between these components. This is an important advance in the development of ASSBs and other ASS energy storage devices. Furthermore, inclusion of OIPC in the electrode composition reduces interfacial resistance, suggesting the incorporation of the OIPC/OIPC composite in an electrode can facilitate metal ion redox processes such as a lithiation/dilithiation processes in a lithium device.

A preferred aspect of the invention provides an all-solid-state energy storage device comprising at least one positive electrode and at least one negative electrode pair, and an ion transport interlayer disposed between any of the pairs of the electrodes, where a separate portion of interlayer is in direct contact with a face of each electrode, wherein each electrode is free of ionically conducting polymer electrolyte, and comprises a dry electrode composition comprising: particles of an electrochemically active material; optional particles of electronically conductive additive; optional particles of a non-ionically conducting polymer binder; and an internal ionic binder in the form of a preformed composite of organic ionic plastic crystal (OIPC) and transport ion salt. Suitably, contact between the ion transport interlayer and each electrode involves substantially void free contact. Desirably, voids between the particles are filed with the internal ionic binder. Preferably, the OIPC to transport ion salt ratio in the composite is between about 9:1 to about 1:9 mol % or between about 9:1 to about 1:9 wt %, preferably, about 1:1 mol % or about 1:1 wt %. Desirably, the internal ionic binder is present in an amount of at least about 15 wt % and not more than about 50 wt % of the total electrode composition. Desirably, the dry electrode composition is free of organic solvent. More desirably, the composition is ideally free of one or more of: organic solvent, ionic liquid that is not an OIPC, polymerizable ionic liquid monomer and/or a polymerised poly(ionic liquid), ionogel, polyionic liquid ionogel and/or a polymerisation initiator such as AIBN. Preferably, the ion transport interlayer is an ion transport membrane incorporating an ion transport salt, e.g., a solid electrolyte composite including the ion transport salt. Incorporation of the OIPC binder or OIPC composite binder of the invention in an electrode not only facilitates generation of transport metal ion conduction pathways inside the electrode to enhance ionic conductivity within inner part/regions of the electrode through filling of pores/voids in the electrode with OIPC/composite. It also enhances the quality of electrolyte/electrode and electrode/current collector interfacial contact by promoting void free contact between the solid electrolyte and solid electrode, thereby further improving conductivity across the electrode/electrolyte interface. These effects result in the improvement of charge rate capability and cycle life for the electrode when used in a cell.

Inclusion of OIPC or OIPC composite as an ionic binder allows if desired use of electrodes in a dry (e.g., liquid, organic solvent, gel or sol free) state in an energy storage device. Advantageously, a liquid, ionically conductive polymer electrolyte e.g., gel or sol electrolyte is not required within the electrode for device operation leading to significant enhancements in safety. Furthermore, in some embodiments, the electrode material including the OIPC/OIPC binder is compacted or densified to provide for reduced voids/increased void free contacts. Furthermore, use of the modified electrodes as described with a solid state electrolyte provides for reduced voids (i.e., increased void free contacts) between the solid electrolytes and active materials in the electrode. This makes the OIPC electrodes described herein particularly useful for ASSBs as higher volumetric energy densities are possible for devices using the OIPC electrodes of the invention are provided given more electrochemically active materials can be included in the electrode due to the improved ionic conductivity provided by OIPC/OIPC composite. However, if desired, they can also be used in devices relying on liquid electrolyte. Additionally, where the OIPC electrodes described herein are used in a device, the overall amount of transport ion salt required can also be reduced compared to an equivalent liquid electrolyte system to show the same charge rate capability. This also improves the volumetric energy density of devices using the OIPC electrodes. In some cases, the OIPC provides a new phase e.g., a liquid phase inside the OIPC electrode, which is thought to only be generated during charging/discharging. The transport ion can move through the liquid phase easily and thus the electrode requires less salt than a corresponding electrode without OIPC/OIPC composite. In some OIPC electrodes, it is further believed that a new phase is formed which may solvate or otherwise incorporate the active materials of the electrode composite in a way that facilitates ion transport of a charge carrier present and/or facilitates the change transfer.

Suitably, the OIPC composites of the invention are preformed and are added into the electrode composition as the preformed composite during electrode manufacture. Suitably, the OIPC composites of the invention may comprise any useful amount of OIPC and ion transport salt, or OIPC and OMIEC polymer. For example, the ratio of the OIPC in the composite may be any amount up to 97 wt % OIPC and the reminder, 3% or more is the other salt component of the composite. In some embodiments, up to 95 wt % OIPC, up to 90 wt % OIPC, up to 85 wt % OIPC, up to 80 wt % OIPC, up to 75 wt % OIPC, up to 70 wt % OIPC, up to 65 wt % OIPC, up to 60 wt % OIPC, up to 55 wt % OIPC, up to 50 wt % OIPC, up to 45 wt % OIPC, up to 40 wt % OIPC, up to 35 wt % OIPC, up to 30 wt % OIPC, up to 25 wt % OIPC, up to 20 wt % OIPC, up to 15 wt % OIPC, up to 10 wt % OIPC, up to 5 wt % OIPC, up to 2.5 wt % OIPC, with the remainder being the other salt component of the composite. Lower amounts of OIPC are preferred typically. In some embodiments, a 90 wt % OPIC composite is preferred, where the salt is 10 wt %. In other embodiments, a 50 wt % OIPC composite is preferred. The other component is preferably a ion transport salt such as LiFSI or NaFSI. In other embodiments, the OMIEC polymer is PEDOT:PSS. In some embodiments, a composite of 90 wt % OIPC: 10 wt % PEDOTT:PSS is preferred. In other embodiments, a composite of 50 wt % or less OPIC: transport ion salt is preferred.

In other embodiments, the ratio of the OIPC in the composite may be an amount of 40 wt % or more of OIPC and the reminder, 60% or less is the other salt component of the composite. In some embodiments, an amount of 40 wt % or more of OIPC, 55 wt % or more of OIPC, 60 wt % or more of OIPC, 75 wt % or more of OIPC may be used. In particularly preferred embodiments the composite comprises 40 wt % to 60 wt % OIPC with the remainder being the ion transport salt. In preferred embodiments, the OIPC is present in the composite in an amount of 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 52 wt %, 54 wt %, 55 wt %, 56 wt %, 57 wt %, 58 wt %, 59 wt %, or 60 wt %, with the remainder being ion transport salt.

In particularly preferred embodiments the composite comprises an OIPC to salt molar ratio of from 1:1.85 mol % to 1:0.5 mol % to 1:0.5 mol %. In some embodiments, the OIPC to salt ratio ranges from 1:1.5 mol % to 1:0.66 mol %. In some embodiments, the OIPC to salt ratio ranges from 1:1.22 mol % to 1:0.82 mol %. In some particularly preferred embodiments, the OIPC to salt ratio ranges from 1:1.25 mol % to 1:0.75 mol %, more preferably from 1:1.15 mol % to 1:0.90 mol %. Most preferably, the ratio is about 1:1 mol % of OIPC to ion transport salt. About here means±5%. ion transport salt Suitably, the preformed OIPC/transport ion salt composite is selected from the group consisting of: OIPC and LiFSI; OIPC and LiFSI; or OIPC and LiFSI or cation BF₄ and LiFSI; cation FSI and LiFSI; or cation TFSI and LiFSI, where ‘cation’ is an OIPC cation, preferably C₂mpyrBF₄ and LiFSI; C2mpyrFSI and LiFSI; or C₂mpyrTFSI and LiFSI.

Desirably, the electrode comprises up to and including 50 wt % of the OIPC/ion transport salt composite as a portion of the total electrode composition weight, particularly for a graphite based electrode. In some embodiments, 45 wt % or less, 40 wt % or less, 35 wt % or less, 30 wt % or less, 25 wt % or less, 20 wt % or less, 15 wt % or less, of the OIPC/ion transport salt composite is included. In some embodiments, a minimum of 10 wt % of the composite is included.

Desirably, the electrode comprises 15 wt %, 30 wt % or 50 wt % of the OIPC/ion transport salt composite as a portion of the total electrode composition weight. This is particularly the case for a graphite electrode, and most preferably around 30 wt % for a graphite electrode.

Suitably, the composite is an about 1:1 mol % OIPC/transport ion salt composite, such as about 1:1 mol % [C₂mpyr][BF₄] and LiFSI, or about 1:1 mol % [C₂mpyr][FSI] and LiFSI composite, although any ratio falling within the range of from 1:1.85 mol % to 1:0.5 mol % to 1:0.5 mol % can be used.

In other embodiments, composite is an about 1:1 wt % OIPC/transport ion salt composite, such as about 1:1 wt % [C₂mpyr][BF₄] and LiFSI, or about 1:1 wt % [C₂mpyr][FSI] and LiFSI composite, although any ratio falling within the range of from 1:1.85 wt % to 1:0.5 wt % to 1:0.5 wt % can be used.

In other embodiments, the active material is thought to remain as a separate phase within the OIPC/salt composite electrode. Preferred OIPC electrodes comprise soft interphases in which the interface inhabits both the electrode and electrolyte structures in a solid-state device. It is believed that the interphases provide an ionically conductive bridge or other means for improved connectivity between the electrode composition and the solid electrolyte.

In preferred embodiments, a new type of organic-salt hybrid material with a new phase(s) results, whereby the new phase(s) can reversibly incorporate counter ions and support redox reactions, alloying or intercalation, thus enabling charge storage and achieving high energy, long life, and high safety performance.

The data presented highlights multiple advantageous functions of the OIPC binders/OIPC composite binders in a variety of electrode types, particularly intercalation electrodes such as a graphite anode or layered metal oxide cathodes, conversion reaction material based electrodes which involve a redox couple as active material and alloy type electrodes such as silicon. In some particularly preferred embodiments, the above mol % ratio composites described are of particular benefit in alloying or insertion electrodes especially negative alloying or insertion electrodes such as graphite, hard carbon, silicon, phosphorus, selenium, antimony, bismuth. It is particularly the case that the above mol % ratios, especially the about 1:1 mol % ratios, are advantageous to alloying electrodes such as silicon electrodes.

Indeed, the beneficial effects imparted by the OIPC are such that cycling conversion reaction material based electrodes are formed. Such cycling for these materials is not possible in absence of the OIPC binder/OIPC composite binders.

Thus in one aspect, the invention relates to an OIPC electrode, preferably for an all-solid-state energy storage device, wherein the electrode comprises an electrode composition comprising at least one electroactive material and at least one internal ionic binder in the form of at least one organic ionic plastic crystal (OIPC) compound. Desirably, the OIPC is a non-polymeric OIPC compound. Desirably, the OPIC is a not a monomeric OIPC compound, that is, it does not comprise polymerizable functional groups particularly vinyl or allyl groups that form polyionic liquids (polymerised ionic liquids) in the electrode composition.

Preferably the composition is free of ionic liquid ionogels, that is, polymerised ionic liquid of any form. It will be understood that the electrode may be pressed during manufacture, that is, subjected to pressure to compact or densify the components in the electrode. Thus, the OIPC in the composition is compacted together with all other components present. This is in contrast to, for example, Owaga electrodes where after electrode formation (e.g, casting and drying) an ionogel is formed within the preformed electrode, for example, by bulk polymerisation of a drop cast ionic liquid monomer in the presence of an initiator such as AIBN.

Suitably, the electrochemically active material is in particulate form in the composition. Typically, electronically conductive additives will also be present in particulate form. Desirably, the OIPC or OPIC composite is homogeneously dispersed or at least substantially dispersed throughout the composition. While the surface of the electrode composition may have some undispersed OIPC grains, in some embodiments, the overall electrode structure is homogenous, e.g., as determined by elemental mapping and BSE imagining which confirm the high dispersibility of the OIPC binder materials/composites throughout the electrode.

Preferably the electrode composition including the OIPC/OIPC composite is pressed or compacted or otherwise densified to reduce pores in the electrode, e.g., into a 3D form having opposing faces. Preferably, a first face of the electrode composition is in electronic contact with a current collector, especially Al or Cu current collectors. Suitably, the contact between the electrode and current collector is substantially void free. Preferably, another face of the electrode is in electronic contact with a solid electrolyte. Suitably, the contact between the electrode and electrolyte is substantially void free.

In some embodiments, the OIPC covers or substantially surrounds the electroactive material particles in a manner that contact or cover the active particles in a way that tightly connects the active particles in the composition with each other. The OIPC composite may coat all or some of the electrode compositions particle components. For example, the OIPC composite may coat the electroactive material particles only, the conductive additive particles only, or a combination of both the electroactive material particles and the conductive additive particles at the same time. In these embodiments preferably the OIPC composite is a 1:1.85 mol % to 1:0.5 mol % to 1:0.5 mol % OIPC to salt composite as described above, most preferably involving [C₂mpyr][NTf₂](P12NTf₂) as OIPC and LiNTf₂ as salt. In particular, an about 1:1 mol % composite as described above, most preferably involving [C₂mpyr][NTf₂](P12NTf₂) as OIPC and LiNTF₂ as salt is used.

Advantageously, the more OIPC that is present, the better coated the particles are. Furthermore, due to stickiness or adhesive quality of OIPCs, inclusion of more OIPC increases binding and adhesion/interfacial contact and reducing voids between the electrode composition and the current collector and/or solid electrolyte leading to increased performance improvements. The inventors are not aware of any other dry electrode compositions that use OIPC in conjunction with ion transport salt s as a composite that is directed used as an intrinsic component in formulated and cast electrodes. Preferably, the OIPC is dispersed between and around the electroactive material particles and/or the conductive particles which can lead to a reduction in contact resistance between the OIPC/OIPC composite and the electroactive material particles. In preferred embodiments, the OIPC component forms a network of transport ion conduction pathways inside the electrode. Without the OIPC binder, the electrode does not have such transport ion conduction pathways and there is a higher contact resistance between the particles of electroactive material.

In some embodiments, the transport ion conduction pathways may be formed from a plurality of OIPC or OIPC composite grains or particles which contact each other so that they are well connected to each other, as well as other components of the electrode composition, particularly the active material particles. Suitably, the OIPC or OIPC composite grains or particles fill the majority or substantially all of the voids or pores between the active material particles to provide ion conductive pathways therebetween. As the OIPC/composite is compacted with the other components, the effects described herein are amplified. In particular preferred embodiments, the OIPC is believed to form areas of a new liquid phase (non-solvent or non-electrolyte) or other semi solid phase within the solid electrode which may be generated only during charging/discharging, which act as particularly efficient and stable transport ion pathways/channels. Suitably, the transport ion conduction pathways contact with the solid electrolyte or interlayers on the first face of the electrode. In this manner, the soft and plastic nature of the OIPC allows a much better interfacial contact between the first face of the electrode and the solid electrolyte when also present in the ASSB which facilitates ion transport to and from the electrodes to improve the charge/discharge performance in an ASSB or other energy storage device.

It is believed that incorporation of the OIPC/OIPC composite binder in an electrode reduces interfacial resistance to facilitate redox processes at electrodes comprising the OIPC. Furthermore, it is believed that inclusion of an OIPC/OIPC composite binder within an electrode composition may mitigate undesired reactions between an electrolyte and the active materials. In some embodiments, the OIPC/OIPC composite improves the interfacial adhesion between the electrode surface layer and a solid electrolyte interlayer. Advantageously, improved interfacial adhesion enhances ion conductivity to the electrode from the solid electrolyte in the ASSB and from the electrode to the solid electrolyte. This addresses a significant challenge for current solid state devices.

Suitably, the OIPC/OIPC composite is well dispersed throughout the electrode composition all the way through from a first face/first surface of the electrode facing the electrolyte, right through all inner parts of the electrode composition to a second face/second surface corresponding to an innermost boundary with the current collector. Preferred electrode compositions, particularly graphite electrode compositions, on SEM examination through across section thereof, exhibit a morphology or features whereby active material particles at the surface of the first face (directed toward the solid electrolyte/interlayer during use) are more densely packed together (e.g., adopting a horizontal arrangement with fewer or compressed void/pores between the particles) than at the second face (directed towards the current collector during use). The particles at the first face/surface are directed towards the interlayer with their basal planes. In contrast, the inner region active material particles (located away from the first and second faces/surfaces) are more randomly orientated with larger or more expanded voids between the particles due to the nature of the packing, especially for graphite.

Preferably the majority of voids between particles are fully or partially filled with a concentrated portion of the intimate OIPC/OIPC:ion transport salt composite. The intimate material thus ionically connects particles that were otherwise not ionically connected or poorly ionically connected. Further the presence of the intimate material reduced interfacial resistance between the particles. Overall the presence of the OIPC/OIPC composite improves ion flow through the dry electrode. Performance is enhanced and in some cases is close to an equivalent system where liquid electrolyte was used. In some cases, some of the inner particles are aligned vertically to the current collector. This is believed to result in particularly efficient target ion insertion and extraction at least for an intercalation electrode. This morphology is particularly desirable where the electrode is a graphite electrode, and the electroactive material is in the form of graphite particles. At least in the case of a graphite anode, the inventors believe that as a higher fraction of horizontally orientated active particles (i.e., a higher density) tends to decelerate ion conduction while random orientations of inner active material particles are beneficial for ion conduction.

Transport ion salts—Suitably, the transport ion salt is an inorganic metal salt which is typically used in an energy storage device. Suitably, the transport ion salt is an ionic salt which is one or more of an alkali metal, alkaline earth, or transition metal salt. Preferred ionic salts include Li, Na, K, Ca, Al, Mg, Zn salts. Suitably anions for these salts include bis(trifluoromethanesulfonyl)imide, TFSI; bis(fluorosulfonyl)imide, FSI; fluorosulfonyl(trifluoro-methanesulfonyl)imide, FTFSI; trifluoromethane-sulfonate; tetrafluoro-borate, BF₄; perfluorobutane-sulfonate, PFBS; hexafluorophosphate, PF₆; tetracyanoborate, B(CN)₄; dicyanamide, DCA; thiocyanate, SCN; cyclic perfluoro-sulfonylamide, CPFSA, and carboranes.

Desirably, the ionic salt is a lithium salt, for example, selected from the group consisting of: lithium tetrafluorborate (LiBF₄) lithium bis(trifluoromethanesulfonyl)imide (Li[TFSI]), lithium (bis(fluorosulfonyl)imide (Li[FSI]), lithium trifluoromethanesulfonate (Li[OTf]), lithium perchlorate (LiClO₄), lithium dicyanamide (LiDCA), lithium cyanate (LiOCN), lithium thiocyanate (LiSCN), lithium bis[(pentafluoro-ethyl)sulfonyl]imide, lithium 2,2,2-trifluoromethylsulfonyl-N-cyanoamide (TFSAM), lithium 2,2,2-trifluoro-N-(trifluoromethylsulfonyl) acetamide (TSAC), lithium nonafluorobutanesulfonate (NF), lithium carborane, lithium difluoro(oxolato)borate and combinations thereof. Preferably, the salt is a Li salt, such as LiTFSI.

Desirably, the ionic salt is a sodium salt, for example, selected from the group consisting of: sodium tetrafluorborate (NaBF₄), sodium bis(trifluoromethanesulfonyl)imide (Na[TFSI]), sodium(bis(fluorosulfonyl)imide (Na[FSI]), sodium trifluoromethanesulfonate (Na[OTf]), sodium perchlorate (NaClO₄), sodium dicyanamide (NaDCA), sodium cyanate (NaOCN), sodium thiocyanate (NaSCN), lithium bis[(pentafluoro-ethyl)sulfonyl]imide, sodium 2,2,2-trifluoromethylsulfonyl-N-cyanoamide (TFSAM), sodium 2,2,2-trifluoro-N-(trifluoromethylsulfonyl) acetamide (NaTSAC), lithium nonafluorobutanesulfonate (NaNF), sodium carborane, sodium difluoro(oxolato)borate and combinations thereof. Particularly preferred Na salts include sodium bis(trifluoromethanesulfonyl)imide (Na[TFSI]), sodium (bis(fluorosulfonyl)imide (Na[FSI]), sodium triflate (NaOTf), sodium perchlorate (NaClO₄), sodium dicyanamide (NaDCA), sodium cyanate (NaOCN) sodium tetrafluoroborate (NaBF₄), sodium hexafluorophosphate (NaPF₆), and combinations thereof. A preferred ion transport salt is an inorganic metal salt for an energy storage device such an inorganic lithium salt or a sodium salt. Preferably, the ion transport salt has an anion selected from the group consisting of: BF₄, TFSI, FSI and OTf. Suitably, a preferred ion transport salt is selected from LiFSI, LiBF₄, LiTFSI, LiOTf, NaFSI, NaBF₄, NaTSI, NaTFSI, or NaOTf.

Conductivity enhancing additives—Preferred electrodes comprising one or more conductivity enhancing additives such as conductive carbon-based materials including a carbonaceous material such as carbon, carbon black, graphene, carbon nanomaterials including carbon nanotubes, carbon fibres, mixed ionic-electronic conductors, and combinations thereof. However, where an OIPC binder in the form of a mixed ionic-electronic conducting polymer (MIEC) is used, the ionic and electronical conductive of the binder may be sufficiently high such that other conductivity enhancing additives are not required. In such cases, a carbon free electrode may be formed. Suitably, the OIPC/MIEC polymer binder composite is an OIPC/PEDOT:PSS binder composite. Preferably, the mixed ionic electronic conducting polymer (MIEC) is PEDOT:PSS in a ratio of 50:50 to 95:5 PEDOT:PSS/OIPC, preferably 60:40 to 85:15 PEDOT:PSS/OIPC, preferably 80:20 PEDOT:PSS/OIPC, most preferably 80:20 PEDOT:PSS/C₂mpyrFSI.

Polymeric binders—In some embodiments, a preferred electrode comprises one or more polymeric (non ionically conductive polymeric material) binders such as carboxyl methyl cellulose (CMC), polyvinylidene fluoride PVdF, styrene butadiene rubber (SBR), polyacrylic acid (PAA), polyethylene (PE), polypropylene (PP), polyurethane (PU), poly(tetrafluoroethylene) (PTFE), Nafion, and combinations thereof.

Electrode materials—Preferred electrodes comprise electroactive materials for a cathode (positive electrode) or for an anode (negative electrode). In a cell, the electrode having the higher reduction potential is more easily reduced and corresponds to the cathode (positive material) of the cell where reduction occurs. Likewise, the anode (negative material) is the electrode having the lower reduction potential. While materials are described herein as typical cathode or anode materials, it will be understood that the correct term depends on any particular cell arrangement used.

Examples of material which a typical negative electrode may comprise (or be made of) include graphite, particularly expanded graphite, hard carbon (non-graphitisable carbon), low potential transition-metal oxides and phosphates such as NASICON-type NaTi₂(PO₄)₃ vanadates such as vanadium layered oxides (e.g. O₃NaVO₂ and P2Na_{0.7}VO₂), titanates such as Na₂Ti₃O₇, NaTi₃O₆(OH)·2H₂O, Na₂Ti₆O₁₃, TiNb₂O₇, Na_{0.66}Li_{0.22}Ti_{0.78}O₂, Na_{0.6}Ni_{0.3}Ti_{0.7}O₂, and titanates/carbon black composites, alloying materials such as antimony, tin, phosphorus and their combinations (e.g. Sn—Sb alloys), tin-based composites such as tin powder/resin (e.g. polyacrylate), microcrystalline antimony-based composites such as microcrystalline antimony-black carbon electrodes, amorphous phosphorus, sodium (including sodium or lithium metal), and combinations thereof. In some embodiments, the negative electrode comprises sodium or lithium or iron. In some embodiments, the electrode is an anode and the electroactive material is selected from hard carbon, graphite; silicon; lithium alloys such as lithium titanates particularly lithium titanium oxide; or metallic anode materials such as lithium metal and sodium metal. In other embodiments, the negative electrode consists essentially of sodium or lithium. In yet other embodiments, the negative electrode comprises sodium metal or lithium metal. Other examples of material which the negative electrode may comprise (or be made of) include those disclosed in The Emerging Chemistry of Sodium Ion Batteries for Electrochemical Energy Storage, Angewandte Chemie Int. Ed. 2015, volume 54, pages 3431; Na-ion batteries, recent advances and present challenges to become low cost energy storage systems, Energy & Environmental Science 2012, volume 5, page 5884; Energy Storage Materials Synthesized from Ionic Liquids Angewandte Chemie Int. Ed. 2014, volume 53, page 13342; Chemical Review 2014, volume 114, page 11636, the contents of which are included herein in their entirety. For example, an electroactive material for a typical cathode or positive electrode may be selected from the group consisting of: a transition metal oxide; spinel materials, a transition metal polyanionic compound; sulfur; and a conversion reaction material involving a redox centre.

Suitably, the cathode material comprises a transition metal material selected from the group consisting of: lithium cobalt oxide (LCO), lithium iron phosphate (LFP), lithium manganese phosphate (LMP), lithium nickel manganese cobalt oxide (NMC), and lithium nickel cobalt oxide doped with alumina (NCA), lithium manganese oxide (LMO). LFP is an example of a polyanionic compound, while LCO, LMO etc. are layered oxide intercalation materials.

A suitable conversion reaction electroactive material involving a redox centre preferably comprises a transition metal ion based redox couple. Preferred such transition metal ion based redox couples involve Fe²⁺/Fe³⁺, Co²⁺/Co³⁺, Ni²⁺/Ni³⁺, Mn²⁺/Mn³⁺ or Cu²⁺/Cu³⁺. Desirably, preferred conversion reaction materials involve a redox centre is a transition metal ion based redox couple involving Fe²⁺/Fe³⁺ from Fe(BF₄)·6H₂O, or Co²⁺/Co³ from Cobalt TFSI or Fe(II)Triflate. Other suitable conversion materials include Ni(PO₃)₂. Other examples of conversion materials are found in Energy Environ. Sci., 2017, 10, 435-459 and ACS Omega 2018, 3, 4591-4601, the relevant content of which are incorporated herein by reference. For example, useful conversion electrode materials include transition metal oxides, transition metal chalogenides (sulfides and selenides), phosphides, hydrides, and ternary chalcogenides such as MS×S. However, among different conversion electrodes, transition metal oxides are best known and include binary and ternary oxides of 3d transition metals such as Cr, Mn, Fe, Co, Ni and Cu, as well as 4d transition metals including Nb and Mo. Transition metal compounds with different anion species with formula MₐX_{b}, where X=F, O, S, P and H can support metal ion (e.g., Li+/Na+) insertion by reversible conversion reaction. Some examples include Fe₂O₃, Co₃O₄, Mn₃O₄, FeS₂, CoS₂, MoS₂, FeP, NiP₂, and ternary oxides.

Examples of material which the positive electrode may comprise (or be made of) include layered transition metal oxides (AMO2 type including solid solutions of NaCoO₂, NaFeO₂, NaMnO₂, NaNiO₂). These are typically designated as O₃ (ABCABC stacking), P2 (ABBA stacking) and P3 (ABBCCA stacking) where Na′ adopts either prismatic (i.e., P) or octahedral (i.e., O) coordination environments. These include P2-Na_{0.66}Co_{0.66}Mn_{0.33}O₂. Sodium polyanion materials also can be used as positive electrode materials, these include olivine-type NaFePO₄, fluorophosphates and pyrophosphates, Nasicon type phases of general formula Na₅M₅(XO₂)₄ (M=transition metal and X=P, S. Na₃V(PO₄)F, Fluorosulfates and Sulfates (e.g. NaF₅SO₄F, and NaM(SO₄)·4H₂O (M=Mg, Fe, Co, Ni)), ferrophosphates (e.g. Na₅FePO₄) and silicates. Prussian-blue analogues have also been used as positive electrodes (i.e., Na,M[Mp(CN)], -zH0-M, and Mg are transition metals and hexacyanometallate vacancies exist.) Other examples of materials which the negative or positive electrode may comprise (or be made of) include those disclosed in Angew. Chem. Int. Ed. Engl. 2018, 57, 102; and Adv. Energy Mater. 2018, 8, 1703137.

OIPCs—Organic ionic plastic crystals (OIPCs) can be categorized into protic and aprotic classes, depending on the availability of dissociable protons on the cations and/or anions. Protic OIPCs typically exhibit non-negligible vapor pressure, and some are distillable media with boiling points lower than their decomposition temperature. Recently, more OIPC families have been discovered, including new OIPCs with pyrrolidinium, imidazolium, phosphonium, and metallocenium cations, coupled with a range of anions, such as tetracyanoborate, tetrahalogenoferrate(III), camphorsulfonate, and nonafluorobutanesulfonate.

One property of an OIPC can include at least thermal phase behaviour which includes one or more solid-solid phase transitions before melting (a pre-melting or sub-melting solid-solid phase transition). Techniques for measuring and characterising a solid-solid phase transition of an OIPC include Differential Scanning Calorimetry (DSC) whereby a solid-solid phase transition is characterised by a DSC plot in which a discontinuity (e.g., a spike) of the heat flow in the sub-melting temperature range is observed which is in addition to, and distinct from, the discontinuity arising from the solid-liquid (melting) transition of the OIPC. Another feature of molecular disorder in the solid state is determined from static solid-state NMR, whereby plastic OIPCs exhibit one or more NMR linewidths of 20 KHz or less. Desirably, the linewidths narrow further with increasing temperature. Desirably, the NMR linewidths are 10 KHz or less, preferably, 5 KHz or less, and in some embodiments are 1 KHz or less. Another feature of molecular disorder in the solid state is determined by the observations on the microstructure/morphology by SEM analysis. Features include observations of several grains with different orientations, observation of slip and glide planes on SEM analysis, sets of slip planes within different grains, observation of grain boundaries from fractured surfaces of the material. Further evidence of plasticity increases with increasing temperature. Another feature can include exhibition of an entropy of fusion, ΔS_{f} of less than about 60 JK⁻¹ mol⁻¹, more preferably less than about 50 JK⁻¹ mol⁻¹, more preferably less than about 40 JK⁻¹ mol⁻¹, more preferably less than about 30 JK⁻¹ mol⁻¹, more preferably less than about 20 JK⁻¹ mol⁻¹. Other useful studies include X-ray diffraction, Raman spectroscopy, synchrotron X-ray diffraction and molecular modelling such as molecular dynamics (MD) or combinations thereof.

Preferred OIPC compounds are plastic solids at application operation temperatures, for example at about −100° C. to about 200° C., at about −50° C. to about 100° C., most preferably at about −10° C. to about 80° C. Particularly preferred compounds are plastic solids at least at room temperature. By ‘room temperature’ it is meant a temperature of from about 20° C. to about 25° C., preferably 25° C. Preferred OIPC compounds have a melting point ≥60° C., ≥70° C., ≥80° C., ≥80° C., ≥100° C., ≥150° C., ≥200° C. or ≥250° C. Preferred compounds exhibit plastic behaviour at temperatures of from about −100° C. to about 100° C. By ‘melting point’, it is meant the extrapolated onset temperature associated with a phase transition on melt from a solid to a liquid as determined by differential scanning calorimetry (DSC). Where a compound exhibits plasticity at very low temperatures, e.g., <0° C., typically it indicates that the compound will be advantageously very disordered at room temperature.

OIPC formation/identification—OIPCs can be provided starting from at least one cation and at least one anion. The combination of cations and anions is a plastic crystal where the compound exhibits molecular disorder (and thus plasticity), for example, which can be observed from characteristic features in two or more of thermal studies, solid-state NMR studies and SEM studies, there is no particular limitation on the type of cations and associated counter anions that can be employed.

In preferred OIPC compounds, at least one of the positive functional groups of the OIPC is derived from a small cationic component, such as an optionally substituted saturated or unsaturated heterocyclic ring, for example, pyrrolidine, morpholinium, oxazolidinium, piperidinium, thiolane, benzotriazole or tetrahydrofuran. Desirably, at least one of the negative functional groups of a preferred OIPC is derived from a charge delocalizing anionic group such as fluoroborate, oxalatoborate, sulfonylimide, fluorosulfonylimide (FSI), bis(trifluoromethanesulfonyl)imide (TFSI). Substitutions include methyl, ethyl or propyl substituents.

Some suitable cations may be di-cations or tri-cations. Preferred cations are symmetrical. In some embodiments, the cation is a chiral cation. Examples of suitable cations include pyrrolidinium, imidazolium, oxazolidinium, phosphonium, metallocenium cations, which can be unsubstituted or substituted with one or more functional groups selected from C₁₋₆ alkyl, preferably methyl, ethyl or propyl, CN, OMe, OEt and CN.

Suitably, one or more of the functional groups carrying a positive charge can be selected from the group of cations and particularly aprotic cations, consisting of: Cₙ(N_{2,2},m)₂ where n=2, 3, 4, 6 and m=1, 2, 3, 4, 6; N_{2,1,1,1}; N_{2,2,1,1}; N_{2,2,2,1}; N_{2,3,3,3}; N_{2,2,3,3}; N_{2,2,2,3}; N_{4,4,4,4}; P_{1,2,2,2}; N_{1,2,3,i3}; N_{2,2,2,2}; N_{3,3,3,3} and C₂epyr. Cations that are capable of rotational motions (e.g., tetramethylammonium) are particularly desirable. Preferred cations include C_{2mpyr} cations as well as C₂epyr, C₂moxa, phosphonium cations, [N₂₍₂₀₂₀₂₎₃]⁺, [P₁₂₂ᵢ₄]⁺, [P₁(DEA)₃]⁺.

Desirably, at least one of the positively charged functional group carrying at least one positive charge is derived from an ammonium cation, a phosphonium cation or a sulfonium cation, which contain a nitrogen having a positive charge, a phosphorus having a positive charge, and a sulfur having a positive charge respectively.

Desirably, at least one positively charged functional group carrying at least one positive charge is derived from an ammonium cation which contains nitrogen and has a positive charge. A preferred ammonium cation may have general formula [NR⁴R³R²R¹]⁺. Desirably, at least one positively charged functional group carrying at least one positive charge is derived from a sulfonium cation which contains sulfur and has a positive charge. A preferred sulfonium cation may have general formula [SR³R²R¹]⁺. Desirably, at least one positively charged functional group carrying at least one positive charge is derived from a phosphonium cation which contains phosphorus and has a positive charge. A preferred phosphonium cation may have general formula [PR⁴R³R²R¹]⁺. In each case above, each of R¹ to R⁴ may be the same or different and may be independently selected from optionally substituted alkyl and optionally substituted aryl, or where one R group is selected from optionally substituted alkyl and optionally substituted aryl and the remaining two R groups together with P form an optionally substituted heterocyclic ring, and R¹ is selected from H, optionally substituted alkyl, and optionally substituted aryl. Examples of suitable phosphonium cations include tetra(C₁₋₂₀ alkyl) phosphonium, tri(C₁₋₉ alkyl) mono(C₁₀₋₂₀ alkyl) phosphonium, tetra(C₆₋₂₄aryl) phosphonium, phosphonium, phosphinanium and phosphorinanium.

Desirably, at least one of the positively charged functional groups carrying at least one positive charge is derived from a morpholinium cation, a pyrrolidinium cation or an imidazolium, each of which contain nitrogen having a positive charge. The ring of the pyrrolidinium cation or an imidazolium may be unsubstituted or substituted with one or more of R¹ and R². In each case, each of R¹ and R² may be the same or different and may be independently selected from optionally substituted alkyl and optionally substituted aryl, or where one R group is selected from optionally substituted alkyl and optionally substituted aryl and the remaining two R groups together with P form an optionally substituted heterocyclic ring, and R¹ is selected from H, optionally substituted alkyl, and optionally substituted aryl.

Other preferred cations include dialkylpyrrolidinium, pyrrolidinium, monoalkylpyrrolidiniun, dialkylimidazolium, monoalkylammonium, imidazolium, tetraalkylammonium, quaternary ammonium, trialkylammonium, dialkylammonium, dialkylammonium, dialkanolalkylammonium, alkanoldialkylammonium, bis(alkylimidazolium), bis(dialkyl)ammonium, bis(trialkyl)ammonium, diallylammonium, dialkanolammonium, alkylalkanolammonium, alkylallylammonium, guanidinium, diazabicyclooctane, tetraalkyl phosphoniums, trialkylphosphoniums, trialkylsulfoniums, tertiarysulfoliniums, imidazolinium, cholinium, formamidinium, formadinium, bicyclic (spiro) ammonium, pyrazolium, benzimidazolium, dibenzylammonium, caffineium, piperazinium, dialkyl(amino)ammonium, alkyl(diamino)ammonium, triaminoammonium, aminopyrrolidium, and aminoimidazolium.

Examples of cations and anions of OIPCs which can be used as a starting point for design of OIPC compounds of the present invention are found in Trends in Chemistry, April 2019, Vol. 1, No. 1; J. Mater. Chem., 2010, 20, 2056-2062, and Phys. Chem. Chem. Phys., 2013, 15, 1339 (particularly FIG. 1, FIG. 2, FIG. 3 and Table 1), the entire contents of which describing cations and anions and OIPCs are incorporated herein by reference. Preferred examples of known OIPCs include [N_{1,1,1,1}][DCA], [C₂mpyr][FSI], [C₂mpyr][BF₄], [P_{1,2,2,2}][FSI], [P_{1,2,2,i4}][PF₆], [P_{1,4,4,4}][FSI], [H₂ᵢₘ][Tf], [Hmim][Tf], [N_{2,2,3,3}][BBu₄], [N_{3,3,3,3}][BF₄], [C₂epyr][TFSI], [C₂epyr][FSI], [C₂epyr][PF₆], [C₂epyr][BF₄], [C₁mpyr][(FH)₂F] and [C₂mpyr][(FH)₂F], [C₄mpyr][TFSI], [(NH₂)₃][Tf], [2-Me-im][Tf], and [TAZm][PFBS].

Anion component—Suitably, at least one of the negatively charged functional groups carrying at least one negative charge may be derived from an anion from a known OIPC. Some preferred anions may be protic or aprotic anions, depending on the availability of labile proton(s). Some preferred anions may be di-anions or tri-anions. Some preferred anions may be symmetrical. Some preferred anions may be chiral.

Preferred anions may possess a ‘globular’ structure whereby the anion has a configurational shape presenting spherical symmetry around its centre by rotation around an axis. A further anion may be one that has a diffuse or mobile negative charge which is able to reside or average across the anion structure when tethered in the OIPC compound.

Suitably, one or more of the functional groups carrying a negative charge can be selected from the group of anions and particularly aprotic anions, consisting of: Tf, (FH)ₙF, where 1≤n≤3, and TFSI. Other suitable anions for forming the one or more of the functional groups carrying a negative charge can be selected from the group of anions consisting of: I, Br, PF₆, TFSI, BBu₄, CrO₃Cl, CrO₃Br, BF₄, FTFSI, DCA, FSI, and Tf. Centrosymmetric anions (e.g., hexafluorophosphate and tetrafluoroborate) are particularly preferred.

Desirable, at least one negatively charged functional group carrying at least one negative charge (F⁻) is derived from an anion, such as BF₄⁻, PF₆⁻, N(CN)₂, (CF₃SO₂)₂N⁻, (FSO₂)₂N⁻, OCN, SCN⁻, dicyanomethanide, carbamoyl cyano(nitroso)methanide, (C₂F₅SO₂)₂N⁻, (CF₃SO₂)₃C, C(CN)₃⁻, B(CN)₄⁻, (C₂F₅)₃PF₃⁻, alkyl-SO₃⁻, perfluoroalkyl-SO₃⁻, aryl-SO₃⁻, I⁻, H₂PO₄⁻, HPO₄²⁻, sulfate, sulphite, nitrate, trifluoromethanesulfonate, p-toluenesulfonate, bis(oxalate)borate, acetate, formate, gallate, glycolate, BF₃(CN)⁻, BF₂(CN)₂⁻, BF(CN)₃⁻, BF₃(R)⁻, BF₂(R)₂⁻, BF(R)₃⁻ where R is an alkyl group (for example methyl, ethyl, propyl), cyclic sulfonyl amides, bis (salicylate)borate, perfluoroalkyltrifluoroborate, chloride, bromide, and transition metal complex anions (for example [Tb(hexafluoroacetylacetonate)₄]). Preferably, the anion is a fluorinated anion, for example, selected from the group consisting of: BF₄⁻, PF₆⁻, (CF₃SO₂)₂N⁻, (FSO₂)₂N⁻, BF₃(CN)⁻, BF₂(CN)₂⁻, BF(CN)₃⁻, BF₃(R)⁻, BF₂(R)₂⁻, BF(R)₃⁻ where R is an alkyl group (for example methyl, ethyl, propyl, butyl) (C₂F₅SO₂)₂N⁻, (C₂F₅)PF₃⁻, (C₂F₅PO₂)₂N, (CF₃SO₂)NCN, (CF₃SO₂)N(SO₂F), (CF₃CO)N(SO₂F) and perfluoroalkyl-SO₃⁻. Other anions are [B(tfe)₄]⁻ and [B(hfip)₄]⁻.

OIPC—Examples of known OIPCs include N,N-methylethylpyrrolidinium tetrafluoroborate, N,N-methylpropylpyrrolidinium tetrafluoroborate, dimethylpyrrolidinium tetrafluoroborate, dimethylpyrrolidinium thiocyanate, N,N-ethylmethylpyrrolidinium thiocyanate, tetramethylammonium dicyanamide, tetraethylammonium dicyanamide, N,N-methylethylpyrrolidinium bis(trifluoromethanesulfonyl)amide, diethyl(methyl)isobutyl)phosphonium bis(fluorosulfonyl)amide, diethyl(methyl)(isobutyl)phosphonium tetrafluoroborate, diethyl(methyl)(isobutyl)phosphonium hexafluorophosphate, methy(triethyl)phosphonium bis(fluorosulfonyl)amide, methyl(triethyl)phosphonium bis(trifluoromethylsulfonyl)amide, triisobutyl(methyl)phosphonium hexafluorophosphate, triisobutyl(methyl)phosphonium bis(fluorosulfonyl)amide, triisobutyl(methyl)phosphonium tetrafluoroborate, triisobutyl(methyl)phosphonium thiocyanate, triethyl(methyl)phosphonium bis(fluorosulfonyl)imide, methylethylpyrrolidium bis(fluorosulfonyl)amide, dimethylpyrrolidinium bis(fluorosulfonyl)amide, choline dihydrogen phosphate, choline trifluoromethanesulfonate, N—N-dimethylpropylenediammonium triflate, tri(isobutyl)phosphonium bis(trifluoromethanesulfonyl)amide, tri(isobutyl)phosphonium methanesulfonate, tri(isobutyl)phosphonium trifluoromethanesulfonate, tri(isobutyl)ammonium bis(trifluoromethanesulfonyl)amide, tri(isobutyl(phosphonium nitrate, tri(isobutyl)ammonium methanesulfonate, tri(isobutyl(ammonium trifluoromethanesulfonate, tri(isobutyl)ammonium nitrate, 1,2-bis[N-(N′-hexylimidazolium)ethane bis(hexafluorophosphate), and combinations thereof.

As used herein, an organic ionic plastic crystal (OIPC) compound is one comprising at least one cation and at least one anion, and which exhibits molecular disorder in the solid state. An OIPC compound may be formed and/or identified by a method comprising the steps of: (i) providing a compound to be screened for OIPC behaviour, the compound comprising: at least one positively charged functional group carrying at least one positive charge, and at least one negatively functional group carrying at least one negative charge; (ii) establishing the compound is an organic ionic plastic crystal (OIPC) compound by screening the compound for evidence of molecular disorder in the solid state which identifies the compound as an organic ionic plastic crystal (OIPC) compound, wherein molecular disorder is evidenced by the compound exhibiting two or more, preferably three or more, more preferably all of the following:—thermal phase behaviour which includes one or more solid-solid phase transitions before melting; —in the static solid state NMR spectra, one or more NMR linewidths of 20 KHz or less; and
a microstructure or a morphology including slip and glide planes on SEM analysis. Desirably, the NMR linewidths are 10 KHz or less, preferably, 5 KHz or less, and in some embodiments are 1 KHz or less;
ionic conductivity of at least 10⁻⁴ S/cm, more preferably at least 10⁻³ S/cm when in sub-melting phase at an application operating temperature (e.g., 50° C.) as determined by electrochemical impedance spectroscopy (EIS). In the context of being an organic ionic plastic crystal, the expression ionic conductivity of at least 10⁻⁴ S/cm, more preferably at least 10⁻³ S/cm when in sub-melting phase refers to the value of ionic conductivity that is determined by Electrochemical Impedance Spectroscopy (EIS) according to the following procedure. The OIPC is first shaped into a 30 pellet (nominally 1 mm thick and 13 mm in diameter) under dry conditions, then sandwiched between two stainless steel blocking electrodes that are locked together and hermetically sealed. The ionic conductivity is measured by EIS using a frequency response analyzer driven by an impedance measurement software (which would be available to a skilled person). Data is collected over a 10 MHz to 0.1 Hz frequency range and at a temperature at which the OIPC is solid and in the sub-melting phase. The temperature of the cell is controlled using a high accuracy temperature controller (with accuracy better than ±1° C.), with the temperature measured using a thermocouple in close proximity to the blocking electrodes. The sample is heated (typically at 0.5° C./min) and thermally equilibrated (typically for 5-20 minutes) prior to impedance measurement at each temperature point. For avoidance of doubt, those skilled in the art would be capable to practically devise the appropriate conditions of heating rate and thermal equilibration <10 duration based on the physical consistency of the sample material. For example, OIPCs of soft consistency undergoing wire-based EIS measurements, where the quantity of sample is much larger, will need longer thermal equilibration stages (e.g., up to 20 minutes) while for OIPCs with firmer consistency undergoing plate-based EIS measurements, with smaller quantity of material, a shorter thermal equilibration step (down to 5 minutes) will be sufficient.

A solid-solid phase transition of an OIPC may be determined using Differential Scanning Calorimetry (DSC) which is typically performed by linearly scanning the sample temperature through a range of values and allows a plot to be obtained of the heat flow into or out of the OIPC versus a reference sample. From this, the heat capacity, transition temperatures, transition enthalpy and entropy and melting point can also be determined. In general, a DSC plot allows visualising phase transitions of a material in the form of a discontinuity of the heat flow, versus a reference, at specific temperatures, for example in the form of a spike in the heat flow signal. Frequently, a solid-solid phase transition of an OIPC is characterised by a DSC plot in which a discontinuity (e.g., a spike) of the heat flow in the sub-melting temperature range is observed. For avoidance of doubt, such discontinuity will be in addition to, and distinct from, the discontinuity arising from the solid-liquid transition of the OIPC (i.e., melting). Provided the combination a given cation and counter anion results in an OIPC that (i) contains at least one cation and at least one counter anion, (ii) is a plastic crystal and (iii) has ionic conductivity of at least 10⁻⁴ S/cm when in its sub-melting phase, there is no particular limitation on the type of cation and associated counter anion that can be employed.

Preferred OIPCs comprise at least one cation selected from the group consisting of: pyrrolidinium, imidazolium, phosphonium, guanidinium, oxazolidinium and metallocenium cation. Desirably, a preferred OIPC comprises at least one anion selected from the group consisting of: tetrafluoroborate, FSI, TFSI, tetracyanoborate, tetrahalogenoferrate(III), camphorsulfonate, hexafluorophosphate, triflate and nonfluorobutanesulfonate (nonaflate). Suitably, the OIPC may be selected from [C₂mpyr][BF₄], [C₂mpyr][FSI], [C₂mpyr][TFSI]. The OIPCs [C₂mpyr][FSI] or [C₂mpyr][BF₄] are particularly preferred. Suitably, OIPC is provided as an the OIPC/transport ion salt composite as described above. In such cases, the ion transport salt is preferably one described herein.

Electrode compositions—Preferred electrode compositions comprise the following components: electroactive material; optionally at least one conductivity enhancing additive; optionally at least one non ionically conducting polymeric binder; at least one OIPC; and at least one transport ion salt.

More suitably, the electrode compositions comprise the following components in the recited amounts: from about 40 wt % to about 96 wt % electroactive material; optionally, up to about 25 wt % of at least one conductivity enhancing additive; optionally, up to about 15 wt % of at least one polymeric binder; from about 0.5 wt % to about 60 wt % of an OIPC/transport ion salt composite.

Desirably, the dry electrode comprises 15 wt %, 30 wt % or 50 wt % of the OIPC/ion transport salt composite. Suitably, the mol % ratio or the wt % of components in the composite is an about 1:1 OIPC/transport ion salt composite such as about 1:1 [C₂mpyr][BF₄] and LiFSI, or about 1:1 [C₂mpyr][FSI] and LiFSI composite. Desirably, the electroactive material is graphite, hard carbon a transitional metal salt, silicon, phosphorous, selenium, bismuth, antimony, or a transition metal oxide or a polyanionic layered material.

Suitably, a preferred electrode comprises: from about 40 wt % to about 96 wt % graphite; optionally, up to about 25 wt % of carbon black; optionally, up to about 15 wt % of Na-CMC; from about 0.5 wt % to about 60 wt % of an [C₂mpyr][FSI] and LiFSI composite.

Suitably, a preferred electrode comprises: from about 20 wt % to about 96 wt % of a reversible redox couple material; from about 2 wt % to about 20 wt % of graphene; from about 0.5 wt % to about 60 wt % of an OIPC/transport ion salt composite.

Desirably, the reversible redox couple material is derived from a transition metal salt selected from the group consisting of: Fe(BF₄) salt; copper fluoride preferably CuF₂; cobalt fluoride preferably CoF₃; cobalt chloride preferably CoCl₂·6H₂O; iron chloride preferably FeCl₃.

Suitably, in some embodiments, one or more new material phases are formed in the electroactive material.

A preferred transition metal salt is Fe(BF₄)₂·6H₂O, Co(II)TFSI, Fe(II)Triflate or Ni(PO₃)₂. One preferred electrode comprises 76 wt % Fe(BF₄)₂·6H₂O; 10 wt % graphene; and 14 wt % of an about 1:1 mol % C₂mpyrBF₄ and LiFSI. Other preferred electrodes comprise LiFePO₄ or LiMn₂O₄.

For example, one embodiment, a desirable electrode comprises about 60 wt % of LiFePO₄, about 28 wt % PEDOT:PSS, about 7 wt % C2mpyrFSI, and about 5 wt % LiFSI. Suitably, another preferred electrode comprises about 60 wt % of LiFePO₄, about 30 wt % [C₂mpyr][FSI], 5 wt % PVDF, and 5 wt % carbon.

In one embodiment, a preferred electrode is in the form of a silicon anode comprising: from about 50 wt % to about 75 wt % silicon; optionally, up to about 15 wt % of at least one conductivity enhancing additive; optionally, up to about 15 wt % of at least one polymeric binder; from about 0.5 wt % to about 60 wt % of at least one OIPC/transport ion salt composite.

Desirably, the OPIC/transport ion salt composite may be selected from the group consisting of: C₂mpyrBF₄ and LiFSI; C2mpyrFSI and LiFSI; or C₂mpyrTFSI and LiFSI.

A preferred electrode comprises about 50 wt % to 90 wt % silicon, preferably about 70 wt % to 88 wt % silicon, most preferably the remainder of OIPC:salt, preferably 50:50 mol % ratio.

A preferred electrode comprises about 59.5 wt % silicon; about 12.8 wt % of carbon black; about 12.8 wt % of Na-CMC; about 9.1 wt % of at least one OIPC; and from 5.8 wt % of at least one transport ion salt.

Preferred electrodes comprise [C₂mpyr][FSI], [C₂mpyr][BF₄], [P1222][FSI], [HMG][FSI] OIPCs, preferably in 50:50 mol % combination with ion transport salt, which is most preferably LiFSI or NaFSI. These are particular suitable for use in an all solid state device using an interlayer, e.g., membrane comprising a composite of PVDF, Solupor or Celgard membrane separator filled with the OIPC composite or e.g., [P1222][FSI] composite.

Particularly preferred transport salts comprises LiFSI or NaFSI.

In some embodiments, where the electrode is a graphite anode, the electrode composition comprises: graphite; optionally at least one conductivity enhancing additive; optionally at least one non ionically conductive polymeric binder; at least one OIPC; and at least one transport ion salt.

More suitably, the graphite anode composition comprised the following components in the recited amounts: from about 40 wt % to about 96 wt % graphite; optionally, up to about 10 wt % of at least one conductivity enhancing additive; optionally, up to about 10 wt % of at least one polymeric binder; from about 3 wt % to about 50 wt % of at least one OIPC; and from about 0.5 wt % to about 5 wt % of at least one ion transport salt.

In one embodiment, a preferred graphite anode composition comprises: from about 40 wt % to about 96 wt % graphite; optionally, up 0 wt % to about 5 wt % of carbon black; optionally, up 0 wt % to about 5 wt % of Na-CMC; from about 3 wt % to about 50 wt % of [C₂mpyr][FSI]; and from about 0.75 wt % to about 3.75 wt % of LiFSI.

It will be understood that preferred composites include as much electroactive material is possible to ensure high charge and discharge capacities.

In one embodiment, a preferred graphite anode composition comprises: about 35 wt % graphite; about 5 wt % of carbon black; about 5 wt % of Na-CMC; about 50 wt % of [C₂mpyr][FSI]; and about 3.75 wt % of LiFSI.

In some embodiments, where the electrode is a conversion reaction active material cathode, the electrode composition comprises: a reversible redox couple material derived from a transition metal salt; at least one conductivity enhancing additive; at least one OIPC; and at least one ion transport salt.

In some embodiments, where the electrode is a conversion reaction active material electrode cathode, the electrode composition comprises: from about 40 wt % to about 95 wt % of a reversible redox couple material derived from a transition metal salt; from about 2 wt % to about 20 wt % of graphene; from about 1 wt % to about 50 wt % of an OIPC; and from about 0.75 wt % to about 3.75 wt % of a transport ion salt.

A particularly preferred device has about 90 to about 95 wt % graphite.

In some embodiments, the amounts of transport ion can be much higher. For example, up to 50 mol % ion transport salt (e.g. Li or Na salt) vs OIPC can be used in the composite, that is, up to an about 1:1 mol ratio of ion transport salt (e.g. Li or Na salt) to OIPC is preferably used. Such levels are favoured for improved conductivity and stability.

A preferred transition metal salt may be selected from the group consisting of: iron borate, e.g., a Fe(BF₄)₂ salt, preferably Fe(BF₄)₂·6H₂O; copper fluoride preferably CuF₂; cobalt fluoride preferably CoF₃; cobalt chloride preferably CoCl₂·6H₂O; iron chloride preferably FeCl₃. Preferably, the transition metal salt is Fe(BF₄)₂·6H₂O, Co(II)TFSI, Fe(II)Triflate or Ni(PO₃)₂. In a preferred embodiment, the transition metal salt is Fe(BF₄)₂·6H₂O. Advantageously, one or more new material phases are formed in the composition, e.g., as it the case for Fe(BF₄)₂·6H₂O, Co(II)TFSI, Fe(II)Triflate or Ni(PO₃)₂, particular in combination with an OIPC or OIPC composite as described herein. Preferred, compositions comprise an about 1:1 mol % combination of the OIPC and the inorganic metal salt to form a composite of OIPC and the metal salt. Suitably, the an OIPC/transport ions salt composite selected from the group consisting of: C₂mpyrBF₄ and LiFSI; C₂mpyrFSI and LiFSI; or C₂mpyrTFSI and LiFSI. In a preferred embodiment, the electrode composition comprises 76 wt % Fe(BF₄)₂·6H₂O; 10 wt % graphene; and 14 wt % of 1:1 C₂mpyrBF₄:14 wt % LiFSI.

Ion transport interlayer, e.g., solid state electrolyte—Suitable ion transport interlayer may comprise any solid polymers, glasses or ceramics having suitable ionic conductivity such as composites of such materials which include OIPC, ILs, ion transport salt s, or both. Suitable interlayers include solid state electrolytes for use in preferred ASS devices include any solvent free inorganic solid electrolytes (ISEs), solid polymer electrolytes (SPEs) and composite polymer electrolytes (CPEs). Inorganic solid electrolytes (ISEs) include various ceramics, e.g., oxides (e.g., Li_{1.3}Al_{0.3}Ti_{1.7}(PO₄)₃ (LATP), SiO₂, Al₂O₃, TiO₂, LiAlO₂), sulfides (e.g., Li₂S·P₂S₅, (LPS)) and phosphate based inorganic materials, LISICON, gamet (e.g., Li₅La₃M₂O₁₂), NASICON, lithium nitrides, lithium hydrides, perovskite materials, as well as glass ceramics assuming an amorphous state instead of a regular crystalline structure. Organic solid electrolyte are preferred for compatibility with existing battery manufacturing lines.

Suitable solid-state polymer electrolytes include any solvent free salt solutions in a polymer host material that conducts ions through the polymer chains. Typical solid state polymer electrolytes include polyethylene oxide (PEO), polyvinylidene fluoride (PVdF), polycarbonates, polyesters, polynitriles, polyalcohols, polyamines, polysiloxanes, and fluoropolymers. In some embodiments, ionogels are suitably used as solid-state electrolyte. Ionogels are composite materials comprising an ionic liquid or an OIPC immobilised by an inorganic or a polymer matrix including the above mentioned materials. Suitably, the solid polymers are doped with ionic liquids and/or OIPCs. In particular, polymerised ionic liquids, that is, poly(ionic liquid) (polyIL) represents a promising class of polymer host showing high dielectric constant and high chemical/electrochemical stability. Desirably, the electrolyte is a polyIL or a ionic and non-ionic block copolymer, such as poly(styrene-b-1-((2-acryloyoxy)ethyl)-3-butylimidazolium bis(trifluoromethanesulfonyl)imide, so-called PILBLOC polymer with incorporated ionic liquid and transport ion salt, such as C₂mpyrFSI and LiFSI). Exemplary polymers are described in US2020/0280095. Other studies have shown that the polyIL, poly(diallyldimethylammonium) bis(trifluoromethanesulfonyl)imide (PDADMA NTf₂), can facilitate the dissociation of Li salt and improve Li⁺ transport. Preferably the electrolyte comprises a mixed ionic liquid and transport ion salt, such as poly(diallyldimethylammonium) bis(trifluoromethanesulfonyl)imide (PDADMA NTf₂).

Desirably, the ion transport interlayer, e.g., any solid electrolyte including gelling polymers, ceramics or glasses may be provided as a composite with an OIPC or OIPC composite, which is preferably the same as that used in the electrode as described elsewhere herein. In some embodiments the interlayer is provided as a membrane. In some embodiments, the interlayer comprises a fluoropolymer such as polyvinylidene fluoride (PVdF) or a polymer such as polypropylene. Desirably, the interlay comprises an ionically conducting but electronically insulating material comprises one or more of at least one transport ion salt, e.g., a Na or Li salt; and an organic ionic liquid polymer (OIPC), ideally which are the same of that used in the electrode.

In one example, the interlay is a solid electrolyte comprises a fluoropolymer such as PVdF. Preferably, the PVdf is in fibre form suitable nanofibre form, particularly in the form of a PVdF membrane coated with an OIPC e.g., [C₂mpyr][FSI] or a composite of an OIPC with a transport ion salt, e.g., a Na or Li ion salt used in energy storage application. Where a composite is used as a coating for a membrane, preferably the composite comprises [C₂mpyr][FSI] and LiFSI, preferably about 40 wt % [C₂mpyr][FSI]:LiFSI. About means±5%. One preferred ion transport interlayer/electrolyte that may be used is a mechanically enhanced composite polymer electrolyte comprising electrospun nano-poly(vinylidene fluoride) (PVDF) fibers treated with high ratio of an ionic liquid and/or OIPC and transport ion salt (e.g., LiFSI) to realise high ionic conductivity.

In one embodiment, a composite of [C₃mpyr][FSI] and 3.2 m LiFSI was mixed with PDADMA NTf₂ (60 wt %:40 wt %) by adding a suitable solvent such as acetonitrile and stirring at room temperature until a homogeneous solution was obtained. Then the solution was cast on PVDF fibrous matrix to form a composite polymer electrolyte as exemplified herein.

Energy Storage Devices—An aspect of the invention provides an energy storage device as described herein. A preferred device comprises one or more electrodes as described herein comprising an OIPC or OIPC composite ionic binder, a counter electrode and an ion transport interlayer (e.g., a solid electrolyte), preferably a solid electrolyte such as a solid polymer composite (e.g., microporous polypropylene or PVdF nanofibers) having associated therewith the OIPC composite. Desirably, the energy storage device is configured as an all-solid-state battery. A preferred all-solid-state battery is configured as a lithium or a sodium all-solid-state battery. In some preferred embodiments, the device may comprise an OIPC anode as described herein or an OIPC cathode as described herein. In such cases, the non-OIPC electrode can be any other conventionally used electrode. In some cases, the device may comprise an OIPC anode as described herein and an OIPC cathode as described herein.

Desirably, the electrolyte in the energy storage device is a solid electrolyte, particularly a solid polymer electrolyte comprising an OIPC. In one embodiment, the polymer electrolyte comprises PVdF coated with an OIPC/transport ion salt composite. The PVdF is preferably electrospun PVdF in the form of a membrane.

Suitably, the polymer electrolyte comprises poly(diallyldimethylammonium). Desirably, the polymer electrolyte comprises poly(diallyldimethylammonium) bis(trifluoromethanesulfonyl)imide (PDADMA·NTf₂).

In one embodiment, the energy storage device has a solid polymer electrolyte comprising C₃mpyrFSI and LiFSI, preferably mixed with PDADMA·NTf₂. Desirably, the polymer electrolyte is C₃mpyrFSI containing 3.2 m LiFSI mixed with PDADMA·NTf₂ in a ratio of 60 wt %:40 wt %. Desirably, the polymer electrolyte is C₃mpyrFSI containing 3.2 m LiFSI mixed with PDADMA·NTf₂ in a ratio of 60 wt %:40 wt %.

In one embodiment, the energy storage device has a polymer electrolyte type interlayer comprising an ionic liquid, preferably C₃mpyrFSI and LiFSI, mixed with poly(styrene-b-1-((2-acryloyloxy)ethyl)-3-butylimidazolium bis(tri-fluoromethanesulfonyl)imide) (EMIM TFSI).

Suitable triblock ionogel polymers for use are described in U.S. patent application Ser. No. 16/649,753, 2020, and in Journal of The Electrochemical Society 167 (7), 070525, the content of which is incorporated herein by reference.

The invention extends to the use of an organic ionic plastic crystal (OIPC) as an internal ionic binder in a conversion material electrode. Suitably, the conversion material is for a cathode. Alternatively, the conversion material is for an anode.

Definitions—As used herein, the expression ‘energy storage device’ or ‘electrochemical cell’ is intended to mean a cell that converts chemical energy to electrical energy or converts electrical energy to chemical energy based on the specific interaction between transport metal ions and the negative electrode. Examples of such interactions include chemical oxidation/reduction, intercalation/insertion and alloying-dealloying. As it is understood in the art, these specific interactions also involve collective migration of electrons within the negative electrode, which can therefore generate electric current in an external electric circuit connected to the negative electrode.

In the context of the present invention, the expression ‘alloying/dealloying’ used herein indicates a mechanism providing for the reversible and intimate amalgamation of transport metal ions within the atomic structure of the electrode. The principles and requirements for alloying or so-called re-constitution reaction electrodes are well established[Huggins][Guo], these include various Li—Al, Li—Si, Li—Sb, Li—Bi, Li—Sn, Li—Pb, Li—In, Li—Ga and Li—Cd binary systems as well as ternary and beyond. Likewise, sodium and other target ions (Mg, Ca, K . . . ) have been demonstrated and their phase reactions and materials engineering have been widely reported [Dahbi][Farbod][Orzech][Zhang][Cheng][Baltruschat]. In general, the varying materials engineering and design approaches that can be applied for each target ion and alloying system, that are designed to enhance the utilisation, efficiency and stability of the alloying/de-alloying reactions, are shown to be applicable across multiple systems[Guo][Liang]. See Huggins, Robert A. “Materials science principles related to alloys of potential use in rechargeable lithium cells.” Journal of Power Sources 26.1-2 (1989): 109-120. Dahbi, Mouad, et al. “Negative electrodes for Na-ion batteries.” Physical chemistry chemical physics 16.29 (2014): 15007-15028. Farbod, Behdokht, et al. “Anodes for sodium ion batteries based on tin-germanium-antimony alloys.” ACS nano 8.5 (2014): 4415-4429. Orzech, Marcin W., et al. “Synergic effect of Bi, Sb and Te for the increased stability of bulk alloying anodes for sodium-ion batteries.” Journal of Materials Chemistry A 5.44 (2017): 23198-23208. Wang, Anni, et al. “Bi-based electrode materials for alkali metal-ion batteries.” Small 16.48 (2020): 2004022. Zhang, Huang, Ivana Hasa, and Stefano Passerini. “Beyond Insertion for Na-Ion Batteries: Nanostructured Alloying and Conversion Anode Materials.” Advanced Energy Materials 8.17 (2018): 1702582. Cheng, Yingwen, et al. “Interface promoted reversible Mg insertion in nanostructured Tin-Antimony Alloys.” Advanced Materials 27.42 (2015): 6598-6605. Baltruschat, Helmut, and Da Xing. “Investigation of Calcium Alloying with Sb, Sn and Bi As Negative Electrode Materials for Rechargeable Calcium Battery in Non-Aqueous Electrolytes.” ECS Meeting Abstracts. No. 6. IOP Publishing, 2021. Guo, Songtao, et al. “Architectural Engineering Achieves High-Performance Alloying Anodes for Lithium and Sodium Ion Batteries.” Small 17.19 (2021): 2005248. Liang, Suzhe, et al. “A chronicle review of nonsilicon (Sn, Sb, Ge)-based lithium/sodium-ion battery alloying anodes.” Small Methods 4.8 (2020): 2000218. The content of which is hereby incorporated by reference.

As used herein, ‘negative electrode’ refers to the electrode at which electrons leave the cell during discharge as a consequence of an interaction between the electrode and the transport ions of the kind described herein. By reference to its functionality during discharge, the negative electrode is also commonly referred to in the art as an ‘anode’. The negative electrode may comprise (or be made of) materials that can reversibly intercalate transport ions within their atomic structure, interact with transport ions (e.g., absorption/desorption) by promoting reversible oxidation/reduction reactions, or promote alloying/dealloying reactions with the transport ions.

As used herein, and as a person skilled in the art would know, the expression ‘positive electrode’ refers to the electrode at which electrons enter the cell during discharge. By reference to its functionality during discharge, the positive electrode is also commonly referred to as a ‘cathode’. A positive electrode may comprise (or be made of) material that can reversibly intercalate transport ions within their lattice structure, absorb/desorb transport ions by reversible oxidation/reduction reactions, or promote alloying/dealloying reactions with a transport ion as described herein.

As used herein, the term ‘alkyl’ describes a group composed of at least one carbon and hydrogen atom, and denotes straight chain, branched or cyclic alkyl, for example C₁₋₂₀ alkyl, e.g. C₁₋₁₀ or C₁₋₆. Examples of straight chain and branched alkyl include methyl, ethyl, n-propyl, isopropyl, n-butyl, sec-butyl, t-butyl, n-pentyl, 1,2-dimethylpropyl, 1,1-dimethyl-propyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethyl pentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4- butyloctyl, 1-2-pentylheptyl and the like. Examples of cyclic alkyl include mono- or polycyclic alkyl groups such as cyclopropyl, cyclobutyl, cyclopentyl, cyclohexyl, cycloheptyl, cyclooctyl, cyclononyl, cyclodecyl and the like. Where an alkyl group is referred to generally as ‘propyl’, butyl’ etc, it will be understood that this can refer to any of straight, branched and cyclic isomers where appropriate. An alkyl group may be optionally substituted by one or more substituents, which include substituents in which a carbon has been substituted with a heteroatom (such as O, N, S), as herein defined.

Examples of optional substituents include alkyl, (e.g. C₁₋₆alkyl such as methyl, ethyl, propyl, butyl, cyclopropyl, cyclobutyl, cyclopentyl or cyclohexyl), hydroxyalkyl (e.g. hydroxymethyl, hydroxyethyl, hydroxypropyl), alkoxyalkyl (e.g. methoxymethyl, methoxyethyl, methoxypropyl, ethoxymethyl, ethoxyethyl, ethoxypropyl etc) alkoxy (e.g. C₁₋₆alkoxy such as methoxy, ethoxy, propoxy, butoxy, cyclopropoxy, cyclobutoxy), halo, trifluoromethyl, trichloromethyl, tribromomethyl, hydroxy, phenyl (which itself may be further substituted e.g., by C₁₋₆alkyl, halo, hydroxy, hydroxyC₁₋₆alkyl, C₁₋₆alkoxy, haloC₁₋₆alkyl, cyano, nitro OC(O)C₁₋₆alkyl, and amino), benzyl (wherein benzyl itself may be further substituted e.g., by C₁₋₆alkyl, halo, hydroxy, hydroxyC₁₋₆alkyl, C₁₋₆alkoxy, haloC₁₋₆alkyl, cyano, nitro OC(O)C₁₋₆alkyl, and amino), phenoxy (wherein phenyl itself may be further substituted e.g., by C₁₋₆alkyl, halo, hydroxy, hydroxyC₁₋₆alkyl, C₁₋₆alkoxy, haloC₁₋₆alkyl, cyano, nitro OC(O)C₁₋₆alkyl, and amino), benzyloxy (wherein benzyl itself may be further substituted e.g., by C₁₋₆alkyl, halo, hydroxy, hydroxyC₁₋₆alkyl, C₁₋₆ alkoxy, haloC₁₋₆alkyl, cyano, nitro OC(O)C₁₋₆ alkyl, and amino), amino, alkylamino (e.g. C₁₋₆alkyl, such as methylamino, ethylamino, propylamino etc), dialkylamino (e.g. C₁₋₆alkyl, such as dimethylamino, diethylamino, dipropylamino), acylamino (e.g. NHC(O)CH3), phenylamino (wherein phenyl itself may be further substituted e.g., by C₁₋₆alkyl, halo, hydroxy, hydroxyC₁₋₆alkyl, C₁₋₆alkoxy, haloC₁₋₆alkyl, cyano, nitro OC(O)C₁₋₆alkyl, and amino), nitro, formyl, —C(O)-alkyl (e.g. C₁₋₆alkyl, such as acetyl), O—C(O)-alkyl (e.g. C₁₋₆ alkyl, such as acetyloxy), benzoyl (wherein the phenyl group itself may be further substituted e.g., by C₁₋₆alkyl, halo, hydroxy hydroxyC₁₋₆alkyl, C₁₋₆ alkoxy, haloC₁₋₆alkyl, cyano, nitro OC(O)C1-6alkyl, and amino), replacement of CH2 with C═O, CO₂H, CO₂alkyl (e.g. C₁₋₆alkyl such as methyl ester, ethyl ester, propyl ester, butyl ester), CO2phenyl (wherein phenyl itself may be further substituted e.g., by C₁₋₆alkyl, halo, hydroxy, hydroxyl C₁₋₆alkyl, C₁₋₆alkoxy, halo C₁₋₆alkyl, cyano, nitro OC(O)C₁₋₆alkyl, and amino), CONH₂, CONHphenyl (wherein phenyl itself may be further substituted e.g., by C₁₋₆alkyl, halo, hydroxy, hydroxyl C₁₋₆alkyl, C₁₋₆ alkoxy, halo C₁₋₆alkyl, cyano, nitro OC(O)C₁₋₆alkyl, and amino), CONHbenzyl (wherein benzyl itself may be further substituted e.g., by C₁₋₆alkyl, halo, hydroxy hydroxyl C₁₋₆alkyl, C₁₋₆alkoxy, halo C₁₋₆alkyl, cyano, nitro OC(O)C₁₋₆alkyl, and amino), CONHalkyl (e.g. C₁₋₆alkyl such as methyl ester, ethyl ester, propyl ester, butyl amide) CONHdialkyl (e.g. C₁₋₆alkyl) aminoalkyl (e.g., HN C₁₋₆alkyl-, C₁₋₆alkylHN—C₁₋₆alkyl- and (C₁-6alkyl)₂N—C₁₋₆alkyl-), thioalkyl (e.g., HS C₁₋₆alkyl-), carboxyalkyl (e.g., HO₂CC₁₋₆alkyl-), carboxyesteralkyl (e.g., C₁₋₆ alkylO₂CC₁₋₆alkyl-), amidoalkyl (e.g., H₂N(O)CC₁₋₆alkyl-, H(C₁₋₆alkyl)N(O)CC₁₋₆alkyl-), formylalkyl (e.g., OHCC₁₋₆alkyl-), acylalkyl (e.g., C₁₋₆alkyl(O)CC₁₋₆alkyl-), nitroalkyl (e.g., O₂NC₁₋₆alkyl-), sulfoxidealkyl (e.g., R^{f}(O)SC₁₋₆alkyl where R^{f} is as herein as defined for example alkyl, such as C₁₋₆alkyl(O)SC₁₋₆alkyl-), sulfonylalkyl (e.g., R^{f}(O)₂SC₁₋₆alkyl where R^{f} is as herein defined for example alkyl, such as C₁₋₆alkyl(O)₂SC₁₋₆alkyl-), sulfonamidoalkyl (e.g., 2HR^{f}N(O)SC₁₋₆alkyl where R^{f} is as herein defined, for example alkyl, such as H(C₁₋₆alkyl)N(O)SC₁₋₆alkyl-).

The term ‘halogen’ (‘halo’) denotes fluorine, chlorine, bromine or iodine (fluoro, chloro, bromo or iodo). Preferred halogens are chlorine, bromine or iodine.

The heterocyclyl group may be saturated or partially unsaturated, i.e., possess one or more double bonds. Particularly preferred heterocyclyl are 5-6 and 9-10 membered heterocyclyl. Suitable examples of heterocyclyl groups may include azridinyl, oxiranyl, thiiranyl, azetidinyl, oxetanyl, thietanyl, 2H-pyrrolyl, pyrrolidinyl, pyrrolinyl, piperidyl, piperazinyl, morpholinyl, indolinyl, imidazolidinyl, imidazolinyl, pyrazolidinyl, thiomorpholinyl, dioxanyl, tetrahydrofuranyl, tetrahydropyranyl, tetrahydropyrrolyl, tetrahydrothiophenyl, pyrazolinyl, dioxalanyl, thiazolidinyl, isoxazolidinyl, dihydropyranyl, oxazinyl, thiazinyl, thiomorpholinyl, oxathianyl, dithianyl, trioxanyl, thiadiazinyl, dithiazinyl, trithianyl, azepinyl, oxepinyl, thiepinyl, indenyl, indanyl, 3H-indolyl, isoindolinyl, 4H-quinolazinyl, chromenyl, chromanyl, isochromanyl, pyranyl and dihydropyranyl. A heterocyclyl group may be optionally substituted by one or more optional substituents as herein defined. The term ‘heterocyclylene’ is intended to denote the divalent form of heterocyclyl.

The term ‘heteroaryl’ includes any of monocyclic, polycyclic, fused or conjugated hydrocarbon residues, wherein one or more carbon atoms are replaced by a heteroatom so as to provide an aromatic residue. Preferred heteroaryl have 3-20 ring atoms, e.g., 3-10. Particularly preferred heteroaryl are 5-6 and 9-10 membered bicyclic ring systems. Suitable heteroatoms include, O, N, S, P and Se, particularly O, N and S. Where two or more carbon atoms are replaced, this may be by two or more of the same heteroatom or by different heteroatoms. Suitable examples of heteroaryl groups may include pyridyl, pyrrolyl, thienyl, imidazolyl, furanyl, benzothienyl, isobenzothienyl, benzofuranyl, isobenzofuranyl, indolyl, isoindolyl, pyrazolyl, pyrazinyl, pyrimidinyl, pyridazinyl, indolizinyl, quinolyl, isoquinolyl, phthalazinyl, 1,5-naphthyridinyl, quinozalinyl, quinazolinyl, quinolinyl, oxazolyl, thiazolyl, isothiazolyl, isoxazolyl, triazolyl, oxadialzolyl, oxatriazolyl, triazinyl, and furazanyl. A heteroaryl group may be optionally substituted by one or more optional substituents as herein defined. The term ‘heteroarylene’ is intended to denote the divalent form of heteroaryl.

The term ‘sulfoxide’, either alone or in a compound word, refers to a group R^{f}—S(O)R^{f} wherein R^{f} is selected from hydrogen, alkyl, alkenyl, alkynyl, aryl, heteroaryl, heterocyclyl, carbocyclyl, and aralkyl. Examples of preferred R^{f} include C₁₋₂₀alkyl, preferably C₁₋₆alkyl, most preferably C₁₋₃alkyl, phenyl and benzyl.

The term ‘sulfonyl’, either alone or in a compound word, refers to a group S(O)₂-R^{f}, wherein R^{f} is selected from hydrogen, halides, alkyl, alkenyl, alkynyl, aryl, heteroaryl, heterocyclyl, carbocyclyl and aralkyl. Examples of preferred R^{f} include C₁₋₂₀alkyl, phenyl and benzyl.

The term ‘sulfonamide’, either alone or in a compound word, refers to a group S(O)NR^{f}R^{f} wherein each R^{f} is independently selected from hydrogen, alkyl, alkenyl, alkynyl, aryl, heteroaryl, heterocyclyl, carbocyclyl, and aralkyl. Examples of preferred R^{f} include C₁₋₂₀alkyl, phenyl and benzyl. In a preferred embodiment at least one R^{f} is hydrogen. In another form, both R^{f} are hydrogen.

The term ‘heteroatom’ or ‘hetero’ as used herein in its broadest sense refers to any atom other than a carbon atom which may be a member of a cyclic organic group. Particular examples of heteroatoms include nitrogen, oxygen, sulfur, phosphorous, boron, silicon, selenium and tellurium, more particularly nitrogen, oxygen and sulfur.

As used herein, ‘about’ means±5% of the stated value.

The present invention is described with reference to the following examples. It is to be understood that the examples are illustrative of and not limiting to the invention described herein.

Example 1—OIPC binder in graphite anode—In this first example, inclusion of an OIPC binder in the form of an OIPC/Li salt composite binder improved charge rate capability and cyclability of graphite anode in an all-solid-state battery. An exemplary OIPC, N-ethyl-N-methylpyrrolidinium bis(fluorosulfonyl)imide ([C₂mpyr][FSI]), was incorporated as an OIPC/Li salt composite as an ionic binder within a graphite anode at a range of tested OIPC/Li salt binder concentrations. The Li salt used was LiFSI, although other salts could be used as desired.

The positive effect of preferred OIPC binders on charge/discharge rate capability and cycle life is demonstrated for a solid-state cell comprising that the OIPC/graphite composite anodes. In particular, the cell performance of solid-state cells comprising the OIPC/graphite composite anodes of the invention has been compared to a cell comprising a graphite anode (without OIPC) with a liquid electrolyte. The highest charge capacity ratio was measured for the graphite/OIPC composite anode with an OIPC composite ratio of 50 wt % (89.5%, 295.7 mAh/g at 2 C charge), which was almost the same charge capacity ratio as that of the graphite anode but using a liquid electrolyte (85.7%, 295.9 mAh/g at 2 C charge), i.e., not a solid-state cell format. For the system tested herein, it was found that more favorable lithium-ion conduction pathways were resolved for the preferred anodes with higher OIPC amounts or OIPC/Li salt composite amounts up to 50 wt % of the total electrode material. In some embodiments, the transport ion salt is not directly included in the electrode, but the cell can be designed with an excess of alkali (lithium) ions e.g., in the electrolyte or opposing electrode, such that on cycling, the lithium becomes incorporated within the electrode in the desired amounts. However, for the particular graphite electrode composition studied herein, an excess amount of OIPC composite binder (50 wt %+) caused fluctuations in long-term cyclability. Indeed, the most stable discharge capacity retention was obtained using the graphite composite anode with 30 wt % OIPC composite (102.7%, 257.4 mAh/g at the 100^{th} cycle). Furthermore, the lithiation/delithiation process of the preferred solid-state graphite-[C₂mpyr][FSI] composite anode of the invention was evaluated to be stable and reversible.

A simple electrode fabrication process was employed which differs from conventional methods in the addition of the OIPC composite solution to a water-based graphite anode slurry, ensuring high applicability of this method to a roll-to-roll process. Other methods for preparation are show in Figure X. Surface and cross-sectional structures of solid-state graphite composite anodes with various amounts of the OIPC were examined by scanning electron microscopy (SEM). Thereafter the effect of the incorporated OIPC on the charge rate capability and cyclability of the anodes in coin cell cycling tests was considered.

Preparation of solid-state graphite electrodes—The exemplary OIPC, N-ethyl-N-propylpyrrolidinium bis(fluorosulfonyl)imide ([C₂mpyr][FSI], Boron Molecular, >99%) was used after vacuum drying at 60° C. for >12 h. Lithium bis(fluorosulfonyl)imide (LiFSI, Nippon Shokubai, LF-101) was used as received. Both [C₂mpyr][FSI] and LiFSI were weighed in an Ar-atmosphere glove box (02<10.0 ppm, H₂O<0.1 ppm) followed by the addition of acetone (Chem-Supply, >99.5%) outside the glove box to make a 40 wt % [C₂mpyr][FSI] composite acetone solution (90 mol % [C₂mpyr][FSI] and 10 mol % LiFSI). 1.2 g sodium carboxymethylcellulose (Na-CMC, Sigma-Aldrich, average molecular weight: 70,000 g/mol) was dissolved in 78.6 g distilled water at a room temperature using a magnetic stirrer. After confirming the complete dissolution of Na-CMC in water, 1.2 g carbon black (C₆₅, Imerys Graphite & Carbon) was added to the solution followed by stirring at a room temperature for >12 h to obtain the dispersion, 1.5 wt % Na-CMC+1.5 wt % C65 in water. Graphite (Merck, fine powder extra pure) was weighed in another vial for the electrode slurry preparation. A desired amount of the 40 wt % [C₂mpyr][FSI] composite acetone solution was dropped into this vial and, then, an appropriate amount of the Na-CMC+C65 dispersion was added. This graphite slurry was stirred at a room temperature for >12 h to acquire a homogenous mixture. Then, the slurry was coated onto Cu sheets (thickness: 20 μm) using a doctor blade with a wet gap of 80 μm. The solvent inside the coated slurry was evaporated in an oven at 80° C. for >1 h. Dried sheets were punched to get solid-state graphite electrode disks with diameter of 8 mm. Each disk was sandwiched by two Teflon disks ((σ16 mm) followed by pressing using a pellet die ((σ16 mm) at a room temperature under 3,000 psi. After pressing, weight and thickness of the electrode disks were measured. The electrode disks were further vacuum dried at 60° C. for >12 h and used for coin cell assembly.

The compositions of graphite anodes without the OIPC composite ([C₂mpyr][FSI]+LiFSI) were 90 wt % graphite, 5 wt % C65, and 5 wt % Na-CMC. The ratios of the graphite anode to the [C₂mpyr][FSI] composite were set to be (100−x):x wt % (x=0, 15, 30, or 50). The actual composition, electrode loading, and density of tested solid-state graphite anode disks are summarized in Table 1 below:

TABLE 1
Composition, electrode loading, and density of the solid-state graphite anode disks

| Graphite | | Actual Graphite:C65:Na— | Electrode | Electrode |
|---|---|---|---|---|
| anode:[C₂mpyr][FSI] | Solid Interlayer + | CMC:[C₂mpyr][FSI]:LiFSI | loading | density |
| composite ratio [wt %] | Electrolyte | ratio [wt %] | [mg/cm²] | [g/cm³] |
| 50:50 | PVdF + [C₂mpyr] [FSI] | 45.00:2.50:2.50:46.70: | 1.78 | 1.27 |
| | composite | 3.30 | | |
| 50:50 | PVdF + | 45.00:2.50:2.50:46.70: | 1.73 | 1.23 |
| | [C₂mpyr] [FSI] | 3.30 | | |
| | composite | | | |
| 50:50 | PVdF + | 45.00:2.50:2.50:46.70: | 1.73 | 1.23 |
| | [C₂mpyr] [FSI] | 3.30 | | |
| | composite | | | |
| 70:30 | PVdF + [C₂mpyr] [FSI] | 63.00:3.50:3.50:28.02: | 1.55 | 1.19 |
| | composite | 1.98 | | |
| 70:30 | PVdF + [C₂mpyr] [FSI] | 63.00:3.50:3.50:28.02: | 1.24 | 1.13 |
| | composite | 1.98 | | |
| 85:15 | PVdF + [C₂mpyr] [FSI] | 76.50:4.25:4.25:14.01: | 1.55 | 1.10 |
| | composite | 0.99 | | |
| 100:0 | PVdF + [C₂mpyr] [FSI] | 90.02:4.99:5.00:0:0 | 1.61 | 1.07 |
| | composite | | | |
| 100:0 | PP + 1 M LiPF₆ in EC- | 90.02:4.99:5.00:0:0 | 1.69 | 1.40 |
| | DEC-DMC | | | |
| | (1:1:1 vol%) | | | |

Preparation of interlayers for graphite electrode coin cell tests—Electrospun poly(vinylidene fluoride) (PVdF) fiber was made by previous described procedure (ChemSusChem 10, No. 15 (2017): 3135-3145). The PVdF fiber was provided on an Al sheet and was then punched into (σ12.7 mm disks. The 40 wt % [C₂mpyr][FSI] composite acetone solution described above was dropped onto the PVdF fiber disks followed by drying under an Ar atmosphere at a room temperature for >3 h. Then, the coated PVdF fiber disks (coated with dried [C₂mpyr][FSI] composite) were further vacuum dried at 60° C. for >12 h. Each disk was sandwiched by two Teflon disks ((σ16 mm) and pressed under an Ar atmosphere using a pellet die ((σ16 mm) at a room temperature under 2,000 psi. After removing Al sheets, the resultant PVdF-[C₂mpyr][FSI] composite fiber disks were used as solid state electrolyte and separator in coin cell assembly. The composition of the disks was 90 wt % [C₂mpyr][FSI] composite and 10 wt % PVdF.

Coin cell assembly—CR2032-type coin cells were assembled in an Ar-filled glove box. Both sides of lithium strip (Sigma-Aldrich, thickness: 0.3 mm) was brushed and then punched into round disks ((σ10 mm). This brushed lithium disk was attached onto a coin cell component and covered by a PVdF-[C₂mpyr][FSI] composite fiber disk. Then, a solid-state graphite electrode under consideration was placed onto it. After crimping, coin cells were transferred to an oven at 50° C. and stored there for >12 h to ensure temperature equilibrium of the battery test environment. The coin cells were used to study lithium metal plating and stripping from the graphite anode.

Battery tests—All battery tests were conducted at 50° C. using either a Neware battery cycler or a BioLogic VMP-300 potentiostat. The 1 C current rate (mA) was calculated as follows: the weight of the active material for each cell (g) was multiplied by the actual discharge capacity of graphite used in this study (340 mAh/g) and, then, this number was divided by 1 h.

Firstly, coin cells were cycled three times using the constant-current-constant-voltage (CCCV) mode with the current rate of 0.1 C for charging (lithiation) and the constant-current (CC) mode with 0.1 C for discharging (delithiation). The lower and upper cut-off voltages were 0.005 V and 1.5 V, respectively. The cut-off current rate for the CV charging was 0.05 C and the rest time between charging and discharging was 10 min. After three cycles, the charge rate test was performed at 50° C. Specifically, the test condition was the same as that of the first three cycles, except for the test mode and the current rate at each charging. The CC mode was used and the charge current rate was changed every cycle in the following order: 0.1 C→0.2 C→0.5 C→1 C→2 C→0.1 C (six cycles in total). The charge rate capability was evaluated as the ratio of the charge capacity at a higher C-rate (>0.1 C) to that measured at the first 0.1 C-CC charging.

After the charge rate test, the selected cells were further cycled at 50° C. To check the capacities, the cells were initially cycled at 0.1 C-CC. Then, the cells were tested at 0.2 C-CC charging and 0.1 C-CC discharging for 99 cycles. Finally, the capacities after the cycle test were measured at 0.1 C-CC. The cut-off voltages and the rest time were the same as those of the first three cycles.

Structural analysis—SEM was carried out for selected solid-state graphite anodes using a JSM IT 300 series microscope. The cross-sections of the electrodes were obtained using razor blades. Specifically, the electrode was sandwiched by two plastic films and fixed in a holder. Then, it was cut from the electrode surface to the copper current collector while keeping the point contact between the electrode and the fresh edge of the razor blade. All samples were prepared in a glove box and transferred to the SEM observation room using an air-sensitive holder. Elemental analysis of the electrodes was performed by means of EDX with an Oxford X-Max 50 mm² EDX detector.
Results and Discussion—Example 1—OIPC binder in Graphite Anode—Initial charge-discharge behavior of the solid-state graphite-[C₂mpyr][FSI] composite anodes was compared with that of an equivalent graphite anode using a liquid electrolyte (1.0 M LiPF₆ in EC-DEC-DMC). FIG. 1a shows charge-discharge for the solid-state graphite-[C₂mpyr][FSI] composite anode with an OIPC content of 30 wt %. As a reference, the charge-discharge profile for the graphite anode using a liquid electrolyte is also illustrated in FIG. 1b. At the first charging, a peak appeared at around 0.4 V for the solid-state graphite-[C₂mpyr][FSI] composite anode, which was also found for the other electrode compositions (i.e., OIPC contents of 0, 15, and 50 wt %, see FIG. 2 for their charge-discharge profiles). This may be attributed to one of two origins: (i) solid electrolyte interphase (SEI) formation affected by the decomposition of [C₂mpyr][FSI] and (ii) [C₂mpyr]⁺ insertion into graphite. Graphite/Li half cells containing [FSI]⁻ anions in a liquid electrolyte show a large irreversible capacity at the first charging and present a shoulder in their charge profile at 0.2-1.5 V. In contrast, it has been reported that the graphite anode in a bis(trifluoromethylsulfonyl)imide ([TFSI]⁻)-based ionic liquid with [C₃mpyr]⁺ and Li⁺ cations exhibits reversible intercalation of [C₃mpyr]⁺ cations at 0.4-0.7 V.

The characteristic peak was observed only in the first charging step and the charge-discharge profiles for subsequent cycles were almost identical to that of the graphite anode with the liquid electrolyte (FIG. 1a vs. FIG. 1b at the second and third cycles). Therefore, the origin of the peak is believed to be due to SEI formation stemming from OIPC decomposition. Table 2 summarizes capacities and Coulombic efficiencies for the solid-state graphite-[C₂mpyr][FSI] composite anodes and the graphite anode with the liquid electrolyte.

TABLE 2
Capacities and Coulombic efficiencies for the solid-state
graphite-[C₂mpyr][FSI] composite anodes and the graphite
anode with the liquid electrolyte

| Graphite | | | | | |
|---|---|---|---|---|---|
| anode: | | | | | |
| [C₂mpyr][FS] | Solid | | Charge | Discharge | Coulombic |
| composite | Interlayer + | Cycle | capacity | capacity | Efficiency |
| [wt %] | Electrolyte | number | [mAh/g] | [mAh/g] | [%] |
| 50:50 | PVdF + | 1 | 554.5 | 313.0 | 56.5 |
| | [C₂mpyr][FSI] | 2 | 343.0 | 319.4 | 93.1 |
| | composite | 3 | 337.9 | 320.5 | 94.9 |
| 70:30 | PVdF + | 1 | 732.1 | 255.5 | 34.9 |
| | [C₂mpyr][FSI] | 2 | 359.3 | 282.4 | 78.6 |
| | composite | 3 | 350.9 | 289.8 | 82.6 |
| 100:0 | PVdF + | 1 | 577.9 | 261.5 | 45.3 |
| | [C₂mpyr][FSI] | 2 | 341.6 | 284.5 | 83.3 |
| | composite | 3 | 324.0 | 291.9 | 90.1 |
| 100:0 | PP + 1M | 1 | 397.8 | 336.2 | 84.5 |
| | LiPF₆ in | 2 | 350.9 | 337.9 | 96.3 |
| | EC-DEC-DMC | 3 | 346.8 | 338.1 | 97.5 |
| | (1:1:1 vol %) | | | | |

The graphite/Li half-cell containing the liquid electrolyte shows a first cycle Coulombic efficiency of 84.5%, whereas half-cells containing the solid-state graphite-[C₂mpyr][FSI] composite anodes present much lower first cycle Coulombic efficiencies (34.9-56.5%). This is due to the irreversible capacity caused by the SEI formation stated above. For all half-cells, the Coulombic efficiency gradually increases with cycle number. The details for the dependence of Coulombic efficiency and discharge capacity on the OIPC composite ratio is discussed below. In short, a higher OIPC composite ratio (>30 wt %) showed higher Coulombic efficiency and discharge capacity at the third cycle, which were close to those measured for the graphite anode with a liquid electrolyte. This suggests that inclusion of more of the OIPC composite (>30 wt %) provided more favorable ion conduction within the anode compared to lower amounts of OIPC. Surprisingly, the solid-state graphite anode without the OIPC composite could also be cycled, due to the interparticle diffusion of lithium ions. The increasing capacity and efficiency is not fully evident after 3 cycles and the enhanced stability and rate performance provided by the incorporation of OIPC becomes more evident at longer cycling times as shown later (FIG. 5).

Charge rate performance—FIG. 3 shows charge curves at various C-rates for the solid-state graphite-[C₂mpyr][FSI] composite anode with 30 wt % OIPC. The plateau of the curve was shortened and blurred with an increase in the charge C-rate, resulting in a smaller charge capacity at a higher C-rate. The same tendency was found for the other anode compositions and the degree of a decrease in the charge capacity with a C-rate increase dependent on the anode composition.

FIG. 4a presents the charge capacity ratio at each C-rate for the solid-state graphite-[C₂mpyr][FSI] composite anodes with the OIPC composite ratio of 0, 30, and 50 wt % versus the graphite anode with the liquid electrolyte (see below discussion on the charge rate capability of the 15 wt % sample). The difference in the charge rate capability is derived from a difference in the structure inside the anode). The fastest reduction in the charge capacity with increasing C-rate was measured for the solid-state graphite anode without the OIPC composite (0 wt %) followed by the 15 wt %, 30 wt %, 50 wt % electrodes. This could be attributed to three reasons: (i) the smallest contact area (zero) between the bulk OIPC composite and graphite particles, (ii) the relatively unstable contact between graphite particles and the copper current collector when no OIPC is present, and (iii) the loss of favorable edge-edge contacts during charging when no OIPC is present. If the electrolyte/electrode contact area becomes smaller, a larger interfacial resistance will be formed. The solid-state graphite anode has no electrolyte inside (as no liquid is present) and, therefore, the SEI formation on the current collector is not possible. In contrast, the SEI on copper for a liquid electrolyte system is rich in organics, which enhance adhesion of graphite particles to the current collector. However, the electrode/current collector contact in the present solid-state graphite anodes relies dominantly on the polymeric binder (Na-CMC) and van der Waals force of between graphene layers and the bare current collector substrate, which is more likely to incur the partial contact loss between graphite particles and the current collector during charging. A difference in the electrode/current collector contact is discussed below. As for the orientation dependency of graphite particles, it is known that lithium intercalation into graphite occurs across edge planes. Because defect-free basal planes of graphite particles are inactive against lithium intercalation, lithium-ion conduction between graphite particles in the solid-state graphite anode without the OIPC composite is expected to take place at contact points between edge planes. However, if the charge rate increases, lithium intercalation via each contact point will also increase. This causes rapid volume expansion of graphite particles and could slightly slip contact points to change their orientations from edge-edge contacts to unfavorable basal-edge or basal-basal contacts. Such contact modification could be non-negligible because graphite particles expand by 10% along with their c-axes during charging from the delithiated state to the lithiated state.

The decrease in the charge capacity with increasing C-rate becomes less intense as the inside anode OIPC composite ratio in the electrode increases. This is due to the nullification of some or all of the aforementioned three adverse effects. An increase in the OIPC composite ratio provides graphite particles with large electrolyte/electrode contact areas, reducing interfacial resistance between the electrolyte and electrode. In addition, the OIPC composite plays a binder/glue role in the anode, improving and/or maintaining both electrolyte/electrode and electrode/current collector contact, as well as fastening the orientation of graphite particles at the contact points. Some OIPCs (such as [FSI]⁻-based OIPCs) are sticky which is an advantage in terms of binder function. This property is typically displayed by OIPCs which are in the solid phase I state at the temperature of handling (i.e., room temperature). Indeed, the OIPC composite of 90 mol % [C₂mpyr][FSI] and 10 mol % LiFSI used in the present examples is sticky enough to bind graphite particles. The charge rate capability increases with as the OIPC composite ratio increases. Importantly, the capacity ratio of solid-state graphite-[C₂mpyr][FSI] composite anodes with the OIPC composite ratio of 50 wt % (89.5% at 2 C charge) is almost the same as that of the graphite anode with the liquid electrolyte (85.7% at 2 C charge). This suggests that, at 50 wt %, the OIPC composite sufficiently fills voids inside the anode and covers the graphite particles to provide them with favourable lithium-ion conduction pathways from/to the bulk OIPC composite. In addition, solid-state graphite-[C₂mpyr][FSI] composite anodes could operate under a low volume fraction of the electrolyte (i.e. the volume fraction of LiFSI, σelectrolyte ≤1.8%), which was evaluated to be >60% smaller than that of the solid-state graphite anode with the liquid electrolyte (σelectrolyte=5.0%, see Table 3 for details). This is one of the advantages of using the OIPC composite because the amount of the lithium salt required in the OIPC composite to enhance the charge rate capability is smaller than that for the liquid electrolyte (FIG. 4b). A possible reason for this difference is discussed below.

TABLE 3
Composition, volume fractions of voids (φ_{void}), an anode (including graphite,
carbon black, and Na—CMC) (φ_{anode}), an electrolyte (φ_{electrolyte}), and
a solvent (φₛₒₗᵥₑₙₜ), and φ_{electrolyte}/φₛₒₗᵥₑₙₜ

| Graphite anode: | | | | | | |
|---|---|---|---|---|---|---|
| [C₂mpyr][FSI] | | | | | | |
| composite ratio | Solid Interlayer + | | | φ_{electrolyte}^{a} | φₛₒₗᵥₑₙₜ^{b} | φ_{electrolyte}/ |
| [wt %] | Electrolyte | φ_{void} [%] | φ_{anode} [%] | [%] | [%] | φ_{anode} [%] |
| 50:50 | PVdF + [C₂mpyr] | 21.2 | 29.0 | 1.8 | 48.1 | 6.1 |
| | [FSI] composite | | | | | |
| 70:30 | PVdF + [C₂mpyr] | 35.6 | 37.1 | 1.0 | 26.3 | 2.6 |
| | [FSI] composite | | | | | |
| 85:15 | PVdF + [C₂mpyr] | 42.6 | 44.0 | 0.5 | 12.9 | 1.1 |
| | [FSI] composite | | | | | |
| 100:0 | PVdF + [C₂mpyr] | 34.1 | 65.9 | 0 | 0 | 0 |
| | [FSI] composite | | | | | |
| 100:0 | PP + 1M LiPF₆ in EC- | 0^{c} | 50.2 | 5.0 | 44.7 | 10.0 |
| | DEC-DMC (1:1:1 | | | | | |
| | vol %) | | | | | |

^{a}Electrolyte: LiFSI or LiPF₆;
^{b}Solvent: [C₂mpyr][FSI] or EC-DEC-DMC (1:1:1 vol %);
^{c}All voids are assumed to be filled by 1M LiPF₆ in EC-DEC-DMC (1:1:1 vol %)

Cycle life—FIG. 5a shows charge-discharge profiles of the solid-state graphite-[C₂mpyr][FSI] composite anode with the OIPC composite ratio of 30 wt % during the cycle test. The charge capacity was stable at every cycle. In contrast, the discharge capacity gradually improved as the cycle number increased and was stabilized at around the 20^{th} cycle. This can be explained as a preconditioning process. It was reported for not only lithium/lithium symmetric cells with an OIPC composite interlayer, but also half cells composed of a LiFePO₄ (LFP) cathode, an OIPC composite interlayer, and a lithium metal. The preconditioning process is likely to stem from Joule heating, recrystallization of the OIPC followed by the formation of small OIPC grains, and the uneven concentration profile for lithium ions at the electrolyte/electrode interfaces. They provide contact points with more melted eutectic phases and disordered phases of the OIPC composite and hence facilitate lithium-ion conduction. These effects are induced by the cell cycling and can reduce the interfacial resistance. FIG. 5d summarises the discharge capacity retention for the solid-state graphite-[C₂mpyr][FSI] composite anode with the OIPC composite ratio of 0, 30, and 50 wt % during the cycle test (FIGS. 5a-c). Capacities, CEs, discharge capacity retentions at selected cycles are tabulated in Table 4.

TABLE 4
Capacities, Coulombic efficiencies, discharge capacity retentions at
selected cycles

| Graphite anode: | | | | | Discharge |
|---|---|---|---|---|---|
| [C₂mpyr] [FSI] | | Charge | Discharge | | capacity |
| composite | Cycle | capacity | capacity | Efficiency | retention |
| [wt %] | number | [mAh/g] | [mAh/g] | [%] | [%] |
| 50:50 | 1 | 301.5 ^{a} | 281.5 | 93.4 | — |
| | 2 | 290.4 | 278.7 | 96.0 | 100 |
| | 10 | 289.8 | 281.0 | 97.0 | 100.8 |
| | 20 | 289.9 | 282.0 | 97.3 | 101.2 |
| | 50 | 287.4 ^{b} | 288.0 ^{b} | 100.2 ^{b} | 103.3 ^{b} |
| | 100 | 285.5 ^{b} | 310.2 ^{b} | 108.7 ^{b} | 111.3 ^{b} |
| | 101 | 261.4 ^{a,b} | 329.4 ^{b} | 126.0 ^{b} | — |
| 70:30 | 1 | 295.3 ^{a} | 258.3 | 87.5 | — |
| | 2 | 263.7 | 250.5 | 95.0 | 100 |
| | 10 | 262.5 | 254.6 | 97.0 | 101.6 |
| | 20 | 263.8 | 256.9 | 97.4 | 102.5 |
| | 50 | 263.0 | 257.7 | 98.0 | 102.9 |
| | 100 | 257.4 | 261.8 | 98.3 | 102.7 |
| | 101 | 271.1 ^{a} | 266.9 | 98.4 | — |
| 100:0 | 1 | 293.8 ^{a} | 286.6 | 97.6 | — |
| | 2 | 294.0 | 287.6 | 97.8 | 100 |
| | 10 | 293.4 | 290.1 | 98.9 | 100.9 |
| | 20 | 294.8 | 292.1 | 99.1 | 101.6 |
| | 50 | 288.3 | 286.8 | 99.5 | 99.7 |
| | 100 | 275.9 | 275.3 | 99.8 | 95.7 |
| | 101 | 300.8 ^{a} | 300.9 | 100.0 | — |

^{a} Measured at 0.1 C
^{b} Affected by a side reaction

From the first cycle to the 20^{th} cycle, all cells indicated increases in the discharge capacity. After that, each cell presented a different plot of the discharge capacity retention. The solid-state graphite anode without the OIPC composite exhibited a steady decrease in the discharge capacity retention. Its average degradation speed was evaluated to be 0.081% per cycle, reaching the discharge capacity retention of 95.7% (275.3 mAh/g) after 100 cycles. The discharge capacity retention for the solid-state graphite-[C₂mpyr][FSI] composite anode with the OIPC composite ratio of 30 wt % was stable during the cycle test (102.7%, 257.4 mAh/g at the 100^{th} cycle). To the best of our knowledge, such a super stable discharge capacity retention of a solid-state half cell with an OIPC composite interlayer was only reported for the cell comprising LFP cathode, the OIPC composite electrolyte of 90 mol % N-ethyl-N-methylpyrrolidinium bis(trifluoromethylsulfonyl)imide ([C₂mpyr][TFSI]) and 10 mol % LiTFSI, and lithium metal at 80° C. In contrast, a further increase in the OIPC composite ratio to 50 wt % induced a fluctuated increase in the discharge capacity retention because of an unwanted side reaction. As for the Coulombic efficiency (FIG. 5e), a similar trend was found. It was also increased from the first cycle to the 20^{th} cycle. However, the Coulombic efficiency still showed a gradual increase after the 20^{th} cycle. For instance, the Coulombic efficiency of the solid-state graphite-[C₂mpyr][FSI] composite anode with the OIPC composite ratio of 30 wt % rapidly increased from 95.0% at the second cycle to 97.4% at the 20^{th} cycle and then further improved to 98.3% at the 100^{th} cycle. In contrast, the Coulombic efficiency of the solid-state graphite-[C₂mpyr][FSI] composite anode with the OIPC composite ratio of 50 wt % started fluctuating from the 31^{th} cycle. The result suggests that 30 wt % is the most balanced condition in terms of charge rate capability and cycle life and a further increase in the OIPC composite ratio inside the solid-state graphite-[C₂mpyr][FSI] composite anode (i.e. 50 wt %) incurs the risk of fluctuation in the discharge capacity caused by a side reaction.

Structural analysis—The surfaces of the solid-state graphite anode and the solid-state graphite-[C₂mpyr][FSI] composite anodes were observed by SEM. At ×6,000. All surfaces show graphite particles partly covered by the foamy structure of carbon black (FIG. 6a-6c). Clear outlines of each particle were resolved for the solid-state graphite anode without the OIPC composite. As more OIPC composite was incorporated in the anode, the outlines of the particles became more blurred. This suggests that the OIPC composite covers the graphite particles and tightly connects them with each other. Therefore, a higher amount of the OIPC composite inside the anode can provided a smaller contact resistance between the OIPC composite and graphite particles.

The results indicate that the OIPC composite forms a network of lithium-ion conduction pathways inside anode. Although the surface of the solid-state graphite-[C₂mpyr][FSI] composite anodes have some undispersed OIPC composite grains, the overall anode structure appears to be homogeneous enough to evaluate the effect of the incorporated OIPC composite ratio on the half-cell performance. The comparison between the SEM images (FIG. 6a-6c) suggests that a higher OIPC composite ratio provides a solid-state graphite anode with better lithium-ion conduction pathways. However, because too much amount of the OIPC composite (i.e., 50 wt %) causes unpredictable fluctuation of the capacity during the cycle test, the OIPC composite ratio can be fine-tuned based on gravimetric or volumetric energy density at a desired C-rate and cycle stability (e.g., 30 wt % to balance them).

The cross-sections of the solid-state graphite anode and the solid-state graphite-[C₂mpyr][FSI] composite anodes were also resolved to get a further insight about their structural differences. As can be seen in FIG. 6d, 6e and FIG. 6b, the outlines of graphite particles become smooth with an increase in the OIPC composite ratio. In addition, more parts of carbon black are blended with the OIPC composite at a higher OIPC composite ratio. These tendencies are the same as those found for the surface images (FIG. 6a-6c). On the other hand, the cross-sectional images give information about the arrangement of graphite particles. An interesting point is that graphite particles on the surface are densely packed together and face the interlayer with their basal planes, whereas inner graphite particles are randomly oriented with voids and some of them are aligned vertically to the copper current collector. This assures the efficient lithium-ion insertion/extraction of the solid-state graphite-[C₂mpyr][FSI] composite anodes. Because a higher fraction of horizontally orientated graphite particles (i.e., a higher anode density) tends to decelerate lithium-ion conduction, random orientations of inner graphite particles are beneficial.

Overall, the incorporation of the OIPC composite in graphite anode not only facilitates the lithium-ion conduction pathways inside the anode, but also enhances the electrolyte/electrode and electrode/current collector contacts, resulting in the improvement of charge rate capability and cycle life. This opens up a new avenue for the development of ASSBs using an OIPC composite as an incorporated solid electrolyte in electrodes. Coulombic efficiencies and discharge capacities at the first three cycles for 15 wt % samples—Table 5 shows capacities and Coulombic efficiencies for the solid-state graphite-[C₂mpyr][FSI] composite anodes with the OIPC composite ratio of 15 wt %.

TABLE 5
Charge and discharge capacities and Coulombic efficiencies at the
first three cycles for the solid-state graphite-[C₂mpyr][FSI]
composite anodes (85 wt % graphite anode + 15 wt % [C₂mpyr]
[FSI] composite)

| Graphite | | | | | |
|---|---|---|---|---|---|
| anode: | | | | | |
| [C₂mpyr] | | | | | |
| [FSI] | | | Charge | Discharge | |
| composite | Interlayer + | Cycle | capacity | capacity | Efficiency |
| [wt %] | Electrolyte | number | [mAh/g] | [mAh/g] | [%] |
| 85:15 | PVdF + | 1 | 357.5 | 140.4 | 39.3 |
| | [C₂mpyr][FSI] | 2 | 198.2 | 156.8 | 79.1 |
| | composite | 3 | 185.2 | 161.8 | 87.4 |

Notably, the first Coulombic efficiency depends on the OIPC composite ratio inside a graphite anode. As the inside OIPC composite ratio increases from 0 to 30 wt %, the first Coulombic efficiency decreases, but a further increase in the OIPC composite ratio (to 50 wt %) improves the first Coulombic efficiency. As for the discharge capacity, while the graphite anode with the liquid electrolyte indicates 338.1 mAh/g at the third cycle, lower third discharge capacities are measured for the solid-state graphite-[C₂mpyr][FSI] composite anodes, which depends on the OIPC composite ratio as well. The solid-state graphite-[C₂mpyr][FSI] composite anode with 15 wt % OIPC composite shows the lowest third discharge capacity (161.8 mAh/g). In contrast, the highest third discharge capacity is found for the anode with 50 wt % OIPC composite (320.5 mAh/g). Dependency on the OIPC composite ratio inside a graphite anode can be explained as follows: Firstly, small additions of the OIPC composite into a graphite anode would generate disturbance layers between graphite particles. The layers are the OIPC composite grains that are separated from the bulk OIPC composite (in the anode and the PVdF fiber) and hamper Li⁺ diffusion from one graphite particle to another via the separated OIPC composite grains. Because the solid-state graphite anode without the OIPC composite shows a higher capacity than that with a small amount of the OIPC composite (15 wt %), it can be said that Li⁺ diffusion between graphite particles is more favorable than that through the two interfaces of graphite |[C₂mpyr][FSI]+LiFSI (90:10 mol %)| graphite. Therefore, a small addition of the OIPC composite might impose unfavorable Li⁺ conduction paths on some graphite particles and make them inactive during cycling, decreasing the achievable capacity of the solid-state graphite-[C₂mpyr][FSI] composite anode. Secondly, further addition of the OIPC composite would connect separated OIPC composite grains to the bulk one and, thus, reduces the amount of inactivated graphite particles. This effect appears as the improvement of the capacity after addition of the OIPC composite from 15 to 30 wt %. Thirdly, the discharge capacity improvement can be enhanced by an additional increase in the OIPC composite ratio from 30 to 50 wt %. Most of all graphite particles might be accessible with an extra amount of the OIPC composite inside the anode, where OIPC composite grains are connected well with each other and provide graphite particles with sufficient Li+ conduction pathways to/from the bulk OIPC composite. Indeed, the anode with 50 wt % OIPC composite reaches 320.5 mAh/g at the third cycle, which is close to the capacity observed for the anode with proper electrolyte/active material connections using the liquid electrolyte (338.1 mAh/g). Hence, the large addition of the OIPC composite (>30 wt %) into a graphite anode is advantageous in terms of the charge-discharge performance for the first three cycles.

Charge rate capability—Table 6 shows the charge capacity and capacity ratio at each charge C-rate for the solid-state graphite-[C₂mpyr][FSI] composite anodes with the OIPC composite ratio of 15 wt %. All charge capacities were lower than those for the other solid-state graphite-[C₂mpyr][FSI] composite anodes and the solid-state graphite anode without the [C₂mpyr][FSI] composite at the same charge C-rate. As stated previously, this is likely to be attributed to disturbance layers (i.e., OIPC composite grains separated from the bulk OIPC composite) between graphite particles. However, the capacity ratio of the 15 wt % sample was evaluated to be between those of the 0 wt % and 30 wt % samples at the same charge C-rate. The addition of the OIPC composite in the graphite anode improved the charge rate capability of its half cell.

TABLE 6
Charge rate capability for the solid-state graphite-[C₂mpyr][FSI]
composite anodes (85 wt % graphite anode + 15 wt % [C₂mpyr]
[FSI] composite)

| Graphite anode: | Solid | | Charge | Capacity |
|---|---|---|---|---|
| [C₂mpyr][FSI] | Interlayer + | | capacity | ratio |
| composite [wt %] | Electrolyte | C-rate | [mAh/g] | [%] |
| 85:15 | PVdF + | 0.1 C | 174.1 | 96.3 |
| | [C₂mpyr][FSI] | 0.2 C | 173.4 | 95.9 |
| | composite | 0.5 C | 160.4 | 88.7 |
| | | 1 C | 143.9 | 79.6 |
| | | 2 C | 99.3 | 54.9 |
| | | 0.1 C (final) | 180.8 | 100.0 |

Discussions for the relatively low volume fraction of the electrolyte for the graphite-[C₂mpyr][FSI] composite anode—It was evaluated that the amount of the transport ion salt required in the OIPC composite is smaller than that in the liquid electrolyte to show the same charge rate capability (FIG. 4). A possible reason for the relatively low amount of the electrolyte in the OIPC composite is the presence of liquid phases inside the OIPC composite, which are likely to be generated during charging/discharging.

To get some insights into this, firstly, the amount of lithium ions required to fully lithiated graphite and that in the PVdF fiber with the OIPC composite were calculated. If the capacity is 0.246 mAh (estimated based on the active material ratio and the loading of the solid-state graphite anode without the OIPC composite in Table S1 and the capacity of graphite, 340 mAh/g), dividing this value by Faraday constant (96,485 A s mol⁻¹) provides the amount of Li⁺ ions for the full lithiation of graphite (9.2×10⁻⁶ mol). However, the amount of lithium ions in the PVdF fiber is 2.0×10⁻⁶ mol (using the thickness of the PVdF fiber:100 μm, the area of the PVdF fiber: 0.503 cm², and the tabulated information in Table 7). This means many lithium ions come from lithium metal during charging.

TABLE 7
The molecular weight (Mᵢ), density (dᵢ), and concentration (Cᵢ)
of the material i and the mass fraction (w_{i, PVdF}), volume
fraction (φ_{i, PVdF}), and concentration (C_{i, PVdF}) of the material i in the
PVdF fiber with the [C₂mpyr][FSI] composite (PVdF:[C₂mpyr][FSI]
composite = 90:10 wt % and [C₂mpyr][FSI]:LiFSI = 90:10 mol %)

| | Mᵢ | dᵢ | | w_{i, PVdF} | φ_{i, PVdF} | C_{i, PVdF} |
|---|---|---|---|---|---|---|
| Name | [g/mol] | [g/cm³] | Cᵢ [M] | [wt %] | [%] | [M] |
| [C₂mpyr] | 294.34 | 1.2 | 4.1 | 84.1 | 88.7 | 3.6 |
| [FSI] | | | | | | |
| LiFSI | 187.07 | 2.32 | 12 | 5.9 | 3.2 | 0.40 |
| PVdF | 534,000 | 1.74 | 3.26 × | 10.0 | 8.1 | 2.6 × |
| | | | 10⁻³ | | | 10⁻³ |

Conclusion for Example 1—OIPC Binder for Graphite Anode—A promising approach to enhance the charge rate capability and cycle life of ASSBs by incorporating the [C₂mpyr][FSI] composite into graphite anode is demonstrated. The effect of the inside the electrode OIPC composite ratio on the charge-discharge profile and anode structure was systematically investigated by battery tests, SEM, EDX, and EIS. Half cells comprising either a solid-state graphite anode or a graphite-[C₂mpyr][FSI] composite anode, an electrospun PVdF fiber filled with the [C₂mpyr][FSI] composite, and lithium metal presented relatively large irreversible capacity at the first charging, but Coulombic efficiency gradually improved with an increase in the cycle number. The charge rate capability was improved with an increase in the inside OIPC composite ratio and, at 50 wt %, it became competitive (the charge capacity ratio: 89.5%, 295.7 mAh/g at 2 C charge) with that of the graphite anode with a liquid electrolyte (85.7%, 295.9 mAh/g at 2 C charge). This improvement has been elucidated as the structural difference in the solid-state graphite-[C₂mpyr][FSI] composite anodes. As the amount of the OIPC composite increased, favorable lithium-ion conduction pathways were established in the anode, where graphite particles and carbon black were well covered with the OIPC composite. The best cycle stability was measured for the solid-state graphite-[C₂mpyr][FSI] composite anode with the OIPC composite ratio of 30 wt %. The preconditioning took about 20 cycles to be stabilized and, after that, the discharge capacity retention did not show an obvious decrease trend, reaching 102.7%, 257.4 mAh/g at the 100th cycle. The results provide useful insights into the structure-property relationship of the graphite-[C₂mpyr][FSI] composite anode, which will lay the robust foundation for the development of ASSBs using OIPC composites.

Example 2—OIPC as Binder in Conversion Material Electrodes—The examples presented describe new types of conversional reaction electrodes based on a redox couple/centre which is include in the electrode an ionic binder in the form of an OIPC or OIPC composite as described herein. The conversion reaction material electrodes described are particularly suitable for a solid-state battery. It is believed that the conversion reaction material electrodes described herein could mitigate undesirable reaction between the electrolyte and the conversion material actives. Furthermore, it is believed that the OIPC improves interfacial contact between the electrode/electrolyte and/or the electrode/current collector. The OIPC operates as a novel type of ionic binder for conversion reaction electrodes. The OIPC was introduced into the solid system to improve the interfacial adhesion between the electrode-layer and the solid electrolyte, however, the ion conductivity in the resulting electrodes is also enhanced.

In some preferred, but not necessarily all cases, mixing an OIPC or OIPC composite and a conversion reaction material (e.g., the transition metal material) can result in formation of a new phase in the solid electrode composition. The phase transformations associated with the preferred electrode composites which arise from inclusion of OIPC are believed to allow reversible changes to the phase composition and distribution of the composite electrode when an electrochemical potential is applied. It is further believed that the new phase(s) may solvate or otherwise incorporate the redox couple material present in the electrode composite in a way that facilitates ion transport of a charge carrier present and/or facilitates the change transfer to and from redox centre.

Suitably, the conversion reaction material electrodes are cathodes. Suitable the solid state electrode compositions of the invention can be readily formed into coatings and are thus applicable to thin film processing technologies. It is believed that the current materials represent the first time OIPCs have been used in conversion material manufacture, at least for Li and Na batteries.

### Examples of OIPC Conversion Material Cathodes

A number of examples are provided below involving several conversion reaction materials as exemplary transition metal salt redox active materials.

Conversion Cathode Example A—Fe(BF₄)₂·6H₂O is used in combination with a series of different OIPCs and inorganic lithium salts as described to form a number of novel OIPC cathode materials. Graphene is included in the OIPC cathode materials as a typical conductivity enhancing additive though any suitable conductivity enhancing additive known in the art can be used. In the experiments report herein, the fraction of conductive additive(graphene) is varied. The novel OIPC cathodes were then tested in cells comprising a Li metal anode, a solid state poly(IL) electrolyte membrane (described below). The results are presented below in Table 9.

While the precise nature of the phase and composition formed are under investigation, in the case of the composite involving Fe(BF₄)₂·6H₂O, C₂mpyrBF₄ and UiBF₄—the generalised reactions are considered as follows:

$${Li}^{+} + {e}^{∼} = {Li}^{0}$$

$${[ {C}_{2} {mpyr}^{+} ] [ {Fe}^{2 +} ] [ {BF}_{4} ]}_{B} [ {Li}^{+} ] = {[ {C}_{2} {mpyr}^{+} ] [ {Fe}^{3 +} ] [ {BF}_{4} ]}_{B} + [ {Li}^{+} ] + {e}^{-}$$

TABLE 9
Cycling results for cells including OIPC cathodes using Fe(BF₄)₂ 6H₂O as active material

| | | | | | | | | 1^{st} cycle | |
|---|---|---|---|---|---|---|---|---|---|
| | Fe(BF₄)₂•6H₂O | Graphene | OIPCs | Salts | Cut off | | Loading | discharge | 10^{th} cycle |
| # | wt. % | wt. % | wt. % | wt. % | voltage | electrolyte | mg/cm² | mAhg⁻¹ | retainability |
| F1 | 80% | 5% | C₂mpyrBF₄ | LiBF₄ | 2-4 V | PVDF film supported | 1 | 44 | 111% |
| | | | 10% | 5% | | Pdadma/C₃mpyrFSI/ | | | |
| | | | | | | LiFSI | | | |
| F2 | 76% | 10% | C₂mpyrBF₄ | LiBF₄ | 2-4 V | PVDF film supported | 0.8 | 77 | 68% |
| | | | 9% | 5% | | Pdadma/C₃mpyrFSI/ | | | |
| | | | | | | LiFSI | | | |
| F3 | 72% | 15% | C₂mpyrBF₄ | LiBF₄ | 2-4 V | PVDF film supported | 0.8 | 53 | 99% |
| | | | 14% | 14% | | Pdadma/C₃mpyrFSI/ | | | |
| | | | | | | LiFSI | | | |
| F4 | 68% | 20% | C₂mpyrBF₄ | LiBF₄ | 2-4 V | PVDF film supported | 0.8 | 58 | 77% |
| | | | 14% | 14% | | Pdadma/C₃mpyrFSI/ | | | |
| | | | | | | LiFSI | | | |
| F5 | 80% | 5% | C₂mpyrBF₄ | LiSFI | 2-4 V | PVDF film supported | 0.8 | 82 | 75% |
| | | | 12% | 12% | | Pdadma/C₃mpyrFSI/ | | | |
| | | | | | | LiFSI | | | |
| F6 | 76% | 10% | C₂mpyrBF₄ | LiSFI | 2-4 V | PVDF | 0.6 | 110 | 57% |
| | | | 7% | 7% | | film supported | | | |
| | | | | | | Pdadma/CampyrFSI/ | | | |
| | | | | | | LiFSI | | | |
| F7 | 76% | 10% | C₂mpyrBF₄ | LiSFI | 1.8-4.3 | PVDF | 0.72 | 103 | 122% |
| | | | 7% | 7% | V | powder/C₂mpyrFSI/ | | | |
| | | | | | | LiFSI | | | |
| F8 | 76% | 10% | C₂mpyrBF₄ | NaFSI | 1.6-4.5 | PVDF | 0.64 | 134 | 84% |
| | | | 9% | 5% | V | powder/C₂mpyrFSI/ | | | |
| | | | | | | NaFSI | | | |
| F9 | 80% | 5% | C₂mpyrFSI | LiSFI | 2.1-4 | PVDF film supported | 0.4 | 60 | 76% |
| | | | 9% | 6% | V | Pdadma/C₃mpyrFSI | | | |
| | | | | | | FSI/LiSFI | | | |
| F10 | 75% | 10% | C₂mpyrTFSI | LiSFI | 2-4 V | PVDF film supported | 0.8 | 22 | 77% |
| | | | 10% | 5% | | Pdadma/C₃mpyrFSI | | | |
| | | | | | | FSI/LiSFI | | | |
| F11 | 75% | 10% | CMC | LiSFI | 1.8-4.3 | PVDF film supported | 0.6 | 5 | 128% |
| | | | 10% | 5% | V | Pdadma/CampyrFSI | | | |
| | | | | | | FSI/LiSFI | | | |

*All cells charge rate is 0.05 C.

Electrochemical Characterization—The electrochemical behaviour of Fe(BF₄)₂6H₂O with different OIPC/Li salts composites were investigated. Sample F6 (Fe(BF₄)₂6H₂O—C₂mpyrBF₄/LiBF₄-Graphene) will be presented as a main example. FIG. 9a-d shows the SEM images of Fe(BF₄)₂6H₂O, C₂mpyrBF₄ and final cathode material. Comparing the XRD patterns (FIG. 9e) of pristine Fe(BF₄)₂6H₂O, and C₂mpyrBF₄/LiFSI, there is no new characteristic peak emergent in the XRD spectrum of Fe(BF₄)₂6H₂O—C₂mpyrBF₄-LiFSI (Fe-PBL). This indicates that both structures of Fe(BF₄)₂6H₂O and C₂mpyrBF₄-LiFSI maintain their structure after mixing. When graphene was added into the Fe(BF₄)₂6H₂O—C₂mpyrBF₄-LiFSI mixture as an electronic conductor to make electrode composite, named as Fe(BF₄)₂6H₂O—C₂mpyrBF₄-LiFSI-Graphene, the peaks of Fe(BF₄)₂6H₂O—C₂mpyrBF₄-LiFSI were broadened. Some peaks at 5.9°, 7.9°, 8.9°, 9.4° and 13.9° which belong to Fe(BF₄)₂6H₂O even disappear. A new peak at 12.1° appears in the Fe(BF₄)₂6H₂O-graphene mixture. These results suggest that the addition of graphene could change the Fe(BF₄)₂6H₂O's crystal structure to some extent.

The cyclic voltammogram (CV) of the Fe(BF₄)₂×6H₂O—C₂mpyrBF₄-LiFSI-Graphene electrode is displayed in FIG. 10a. There are two sets of oxidation and reduction peaks between 2.0-4.0 V. The two phases of oxidation and reduction peak potentials are at 2.59/2.28 V and 3.28/3.08 V, respectively, when the scanning rate is 0.1 mV/s. The theoretical specific capacity of Fe(BF₄)₂6H₂O is 158.8 mAhg⁻¹ based on the proposed 2 electron electrochemical reaction.

A comparison of the rate capability of cathode Fe(BF₄)₂6H₂O—C₂mpyrBF₄-LiFSI-Graphene with OIPC as binder and cathode using commercial binder CMC (Fe(BF₄)₂×6H₂O—CMC-LiFSI-graphene) is presented in FIG. 10b. The cells cycled at different current densities from C/20 to 2 C within the voltage range 2.0-4.2 V at 50° C. It can be seen that the SSIB using Fe(BF₄)₂6H₂O—CMC-LiFSI-Graphene as cathode can only achieve discharge capacity of 7.8 mAh g⁻¹ at current rate of C/20. Clearly, the capacities of Fe(BF₄)₂6H₂O—C₂mpyrBF₄-LiFSI-Graphene are much larger than Fe(BF₄)₂6H₂O—CMC-LiFSI-g Graphene for all C rates tested. The first cycle of Fe(BF₄)₂6H₂O—C₂mpyrBF₄-LiFSI-Graphene composite with loading ˜0.4 mg/cm² offers a high capacity of 120 mAh g⁻¹ at C/20, 80 mAh g⁻¹ at C/10, 64 mAh g⁻¹ at C/5, 55 mAh g⁻¹ at 1 C and 42 mAh g⁻¹ at 2 C. When the charge/discharge rate returns to C/20, the capacity is back to 78 mAh g⁻¹. Discharge capacities decrease as the current rate increases, which might be associated with the polarization. FIG. 10d provides the corresponding galvanostatic discharge/lithiation and charge/delithiation curves of the Fe(BF₄)₂·6H₂O—C₂mpyrBF₄-LiFSI-Graphene composite electrode first cycle at different C rates, revealing average voltage plateau is around 3.2 V at all Crates. The initial discharge capacity at C/20 achieved 82% of theoretical specific capacity and remained a constant of half-theoretical specific capacity. This result may be concluded that only the second phase lithium ion reaction (3.28/3.08 V) is reversible.

Compared to Fe(BF₄)₂×6H₂O—CMC-LiFSI-Graphene, Fe(BF₄)₂·6H₂O—C₂mpyrBF₄-LiFSI-Graphene experiences lower interfacial resistance (FIG. 10c) due to the soft interfacial contact between the electrode and the solid electrolyte. OIPC not only serves as a binder in the cathode creating a soft interface, but also facilitates fast lithium ion diffusivity in the cathode. These results show that the battery

When the charge/discharge rate returns to C/20, the capacity is back to 78 mAh g⁻¹. Discharge capacities decrease as the current rate increases, which might be associated with the polarization. FIG. 10d provides the corresponding galvanostatic discharge/lithiation and charge/delithiation curves of the Fe(BF₄)₂6H₂O—C₂mpyrBF₄-LiFSI-Graphene composite electrode first cycle at different C rates, revealing average voltage plateau is around 3.2 V at all C rates. The initial discharge capacity at C/20 achieved 82% of theoretical specific capacity and remained a constant of half-theoretical specific capacity. This result may be concluded that only the second phase lithium ion reaction (3.28/3.08 V) is reversible.

Compared to Fe(BF₄)₂6H₂O—CMC-LiFSI-Graphene, Fe(BF₄)₂6H₂O—C₂mpyrBF₄-LiFSI-Graphene experiences lower interfacial resistance (FIG. 10c) due to the soft interfacial contact between the electrode and the solid electrolyte. OIPC not only serves as a binder in the cathode creating a soft interface, but also facilitates fast lithium ion diffusivity in the cathode. These results show that the battery performance can be significantly improved by utilizing an optimal battery structure constructed using a soft interface between cathode and electrolyte.

Electrolyte Effect—When the electrolyte is changed to PVDF-C₂mpyrBF₄/LiFSI the voltage range could be extended up to 4.6 V and the capacity of the battery can be maintained at around 110 mAhg⁻¹ for over 50 cycles at 0.05 C (FIG. 12). When using the OIPC electrolyte PVDF-C₂mpyrBF₄/LiFSI, the Fe(BF₄)₂×6H₂O—CMC-LiFSI-Graphene cells fails when charged to 4.6V (FIG. 11), unlike the Fe(BF₄)₂6H₂O—C₂mpyrBF₄-LiFSI-Graphene electrode which high specific capacity over 160 mAhg⁻¹. Similarly, when the Fe(BF₄)₂6H₂O—CMC-LiFSI-Graphene electrode is used with a related ionic liquid electrolyte, C₃mpyrFSI/LiFSI (liquid), with similar electrochemical stability and conductivity to the PVDF powder/C2mpyrFSI/LiFSI (solid) electrolyte (FIG. 14) the cell immediately fails, in this case most likely due to dissolution of the electrode components within the ionic liquid solvent.

This result shows that the OIPC used in the electrolyte can have an impact on the performance of batteries. In some embodiments, in a preferred cell, the lithium salt used in the electrolyte and the lithium salt used in the electrode have different counter anions. In other embodiments, the anions are the same.

Summary—The experiments show that a new OIPC electrode material based on conversion reaction material Fe(BF₄)₂6H₂O can be prepared. The performance of the OIPC electrode material can be tailored by formulation of the composite matrix, including the choice of OIPC/salts, conductive filler and the ratios of OIPC and salt used. In addition, in a cell, the choice of solid-state electrolyte also can be used to tailor performance. Notably, the OIPC solid state electrodes described are readily formed into coatings and are thus applicable to thin film processing technologies.
Conversion Cathode Example B—To display the versatility of the above conversion electrode composition, the analogous cell was prepared using a sodium metal anode and with incorporated NaFSI salt (replacing LiFSI) (FIG. 13). Using the analogous OIPC electrolyte (PVDF powder/C₂mpyrFSI/NaFSI), the Fe(BF₄)₂6H₂O—C₂mpyrBF₄-NaFSI-Graphene cell can be seen to display stable performance at near 120 mAhg⁻¹ and 3.2V average discharge voltage. This example highlights the use of the OIPC conversion electrode material with alternative transport metal ions and corresponding anode chemistry indicating the broad application of the new OIPC electrode materials.
Conversion Cathode Example C—Other conversion electrode materials such as metal halides, metal oxides, metal sulfides, etc., can also be dispersed within the OIPC matrix. Herein, the active material is thought to remain as a separate phase within the OIPC/salt composite. Hence, the mechanism may be distinctly different to the iron example above. However, it is believed that without the OIPC binder, these electrodes would not show any cycling behaviour.

A CuF₂/C₂mpyrBF₄/LiBF₄/graphene cathode and CuF₂/PVDF/LiBF₄/graphene cathode were prepared and the cell performance comparison is shown in FIG. 15. Superior capacity and stability are shown when the OIPC is incorporated within the electrode. In these examples it is believed that the optimal combination and composition of OIPC, Li salt and conversion electrode material (CuF₂) has not been obtained in order to stablise the cycling performance. Table 10 provides alternative combinations of CuF₂ conversion electrode material with different OIPC, binder, Li salt and solid electrolyte compositions with the electrochemical performance obtained for each composition. Dependence of the cell performance on each of the components is clearly shown.

TABLE 10
Cycling results for cells including OIPC cathodes using CuF₂ as active material

| | CuF₂ | | | | | | | 1^{st} cycle | |
|---|---|---|---|---|---|---|---|---|---|
| | wt. | Graphene | OIPCs | Salts | Cut off | | Loading | discharge | 10^{th} cycle |
| Sample | % | wt. % | wt. % | wt. % | voltage | electrolyte | mg/cm² | mAhg⁻¹ | retainability |
| T1 | 76% | 10% | C₂mpyrFSI | LiSFI | 2-4 V | PVDF film supported | 0.6 | 103 | 23% |
| | | | 8.5% | 5.5% | | Pdadma/C₃mpyrFSI/ | | | |
| | | | | | | LiFSI | | | |
| T2 | 76% | 10% | C₂mpyrBF₄ | LiBF₄ | 1.8-4.2 | PVDF film supported | 0.6 | 412 | 22% |
| | | | 9.5% | 4.5% | V | Pdadma/C₃mpyrFSI/ | | | |
| | | | | | | LiFSI | | | |
| T3 | 57% | 10% | C₂mpyrBF₄ | LiBF₄ | 2.3-4.2 | PVDF film supported | 0.6 | 53.2 | 121% |
| | | | 30% | 15% | V | Pdadma/C₃mpyrFSI/ | | | |
| | | | | | | LiFSI | | | |
| T4 | 23% | 10% | C₂mpyrBF₄ | LiBF₄ | 2-4.1 | PVDF film supported | 0.6 | 35.5 | 14% |
| | | | 45% | 22% | V | Pdadma/C₃mpyrFSI/ | | | |
| | | | | | | LiFSI | | | |
| T5 | 12% | 10% | C₂mpyrBF₄ | LiBF₄ | 2-4.1 | PVDF film supported | 0.6 | 53.3 | 13% |
| | | | 53% | 25% | V | Pdadma/C₃mpyrFSI/ | | | |
| | | | | | | LiFSI | | | |
| T6 | 75% | 10% | C₂mpyrTFSI | LiTFS | 2.3-4.1 | PVDF film supported | 1.2 | 29.8 | 84% |
| | | | 9% | 16% | V | Pdadma/C₃mpyrFSI/ | | | |
| | | | | | | LiFSI | | | |
| T7 | 76% | 10% | C₂mpyrTFSI | LiSFI | 1.8-4.2 | PVDF film supported | 0.8 | 215 | 42% |
| | | | 9% | 5% | V | Pdadma/C₃mpyrFSI/ | | | |
| | | | | | | LiFSI | | | |
| T8 | 78% | 10% | C₂mpyrTFSI | LiBF₄ | 1.8-4.2 | PVDF film supported | 0.8 | 368 | 13% |
| | | | 10% | 2% | V | Pdadma/C₃mpyrFSI/ | | | |
| | | | | | | LiFSI | | | |
| T9 | 73% | 10% | C₂mpyrBF₄ | LiSFI | 1.8-4.2 | PVDF film supported | 1 | 170 | 48% |
| | | | 9% | 8% | V | Pdadma/C₃mpyrFSI/ | | | |
| | | | | | | LiFSI | | | |
| T10 | 80% | 10% | PVDF | — | 2-4 V | PVDF film supported | 1.1 | 237 | 5% |
| | | | 10% | | | Pdadma/C₃mpyrFSI/ | | | |
| | | | | | | LiFSI | | | |

*All cells charge rate is 0.05 C.

Conversion Cathode Examples D and E—Alternative conversion cathode materials were prepared using the same method and general composition to further demonstrate the breadth of the new OIPC electrode material using different conversion electrode materials. The utilisation of the conversion electrode active material capacity is demonstrated in the solid state using OIPC electrolytes and the OIPC electrode material. The cell performance data shown in Table 11 provides results of the general composition active material (FeCl₃, FeTriflate, COCl₂, CoTFSI, CoF₃) 80 wt %, graphene 5 wt %, OIPC 9 wt % and Li salt 6 wt %. In all cases the active material is shown to function but with varying degrees of capacity fade upon subsequent charge/discharge cycling. In this case the limited range of compositions trialed requires further optimisation to enhance the utilisation and cycling stability, however the utility and function of the OIPC in enabling ASSB using conversion electrode type material was demonstrated. FIG. 16 highlights the use of the new OIPC electrode material with a novel metaphosphate cathode material, Ni(PO₃P2 (e.g., see ChemElectroChem 2020, 7, 2831), showing the comparison with an electrode without OIPC binder and highlighting the improved capacity and stability provided by the C₂mpyrFSI OIPC binder. A high capacity of 205 mAh/g of cathode with OIPC as binder is obtained in the 2^{nd} cycle, which is much higher than the capacity (43 mAh/g) of cathode using commercial binder CMC. After 100 cycles, the capacity of cathode with OIPC still remained at 32 mAh/g, while the capacity of cathode without OIPC is only 0.5 mAh/g remained. Table 12 shows the dependence on the cycle performance of the Ni(PO₃P2 on the electrode loading amount and in the absence of OIPC (sample N3) again showing the enhanced performance contributed by the OIPC.

TABLE 11
Cycling results for cells including OIPC cathodes using Fe salts (FeCl₃,
FeTriflate) and Co salts (CoCl₂, CoTFSI, CoF₃) salts as active material

| | Active | | | | | | | 1^{st} cycle | |
|---|---|---|---|---|---|---|---|---|---|
| | material | Graphene | OIPCs | Salts | Cut off | | Loading | discharge | 10^{th} cycle |
| Sample | wt. % | wt. % | wt. % | wt. % | voltage | electrolyte | mg/cm² | mAhg⁻¹ | retainability |
| FeCl₃ | 80% | 5% | C₂mpyrFSI | LiSFI | 2.0-3.5 | PVDF film | 2.8 | 121 | 20% |
| | | | 9% | 6% | V | supported | | | |
| | | | | | | Pdadma/C₃mpyrFSI/ | | | |
| | | | | | | LiSFI | | | |
| FeTrifalte | 80% | 5% | C₂mpyrFSI | LiSFI | 2.0-4.0 | PVDF film | 1.6 | 9.4 | 80% |
| | | | 9% | 6% | V | supported | | | |
| | | | | | | Pdadma/C₃mpyrFSI/ | | | |
| | | | | | | LiSFI | | | |
| CoCl₂ | 80% | 5% | C₂mpyrFSI | LiSFI | 1.8-3.2 | PVDF film | 1.8 | 67 (2^{nd}) | 28% |
| | | | 9% | 6% | V | supported | | | |
| | | | | | | Pdadma/C₃mpyrFSI/ | | | |
| | | | | | | LiSFI | | | |
| CoTFSI | 80% | 10% | C₂mpyrTFSI | LiTFS | 1.8-3.5 | PVDF film | 1 | 4.8 | 52% |
| | | | 6% | 14% | V | supported | | | |
| | | | | | | Pdadma/C₃mpyrFSI/ | | | |
| | | | | | | LiSFI | | | |
| CoF₃ | 76% | 10% | C₂mpyrFSI | LiSFI | 2.0-4.0 | PVDF film | 1.4 | 5.3 | 42% |
| | | | 8% | 6% | V | supported | | | |
| | | | | | | Pdadma/C₃mpyrFSI/ | | | |
| | | | | | | LiSFI | | | |
| CoF₃ | 76% | 10% | C₂mpyrBF₄ | LiBF₄ | 2.0-4.0 | PVDF film | 1.2 | 14 | 46% |
| | | | 10% | 4% | V | supported | | | |
| | | | | | | Pdadma/C₃mpyrFSI/ | | | |
| | | | | | | LiSFI | | | |

*All batteries charge rate is 0.05 C.

TABLE 12
Cycling results for cells including OIPC cathodes using Ni(PO₃)₂ as active material

| | | | | | | | | 2^{nd} | |
|---|---|---|---|---|---|---|---|---|---|
| | | | | | | | | cycle | 10^{th} |
| | Ni(PO₃)₂ | Carbon | OIPCs | Salts | Cut off | | Loading | discharge | cycle |
| Sample | wt. % | wt. % | wt. % | wt. % | voltage | electrolyte | mg/cm² | mAhg⁻¹ | retainability |
| N1 | 80% | 10% | C₂mpyrFSI | LiFSI | 1-3.7 V | PVDF | 1.2 | 223 | 80% |
| | | (Graphene) | 5.5% | 4.5% | | powder/C₂mpyrFSI/LiFSI | | | |
| N2 | 80% | 10% | C₂mpyrFSI | LiFSI | 1-3.7 V | PVDF | 3 | 205 | 69% |
| | | | 5.5% | 4.5% | | powder/C₂mpyrFSI/LiFSI | | | |
| N3 | 80% | 10% | PVDF | LiSFI | 1-3.7 V | PVDF | 1 | 43 | 22% |
| | | | 5.5% | 4.5% | | powder/C₂mpyrFSI/LiFSI | | | |

*All batteries charge rate is 0.05 C.

Discussion on OIPC binder in Conversion Electrode Materials:—The experiments reported herein show that conversion electrode materials, (e.g., Fe(BF₄)₂6H₂O, CuF₂, CoF₃, FeCl₃, FeTriflate, COCl₂, CoTFSI, CoF₃ etc.) can be prepared and formulated as OIPC cathodes which support charge and discharge on cycling for at least 50 cycles. The battery performance is related to the nature of the composite matrix, which can be tailored by choice of OIPC/salts, conductive filler and the ratios and amounts of component used.

For some compositions, a high initial specific capacity was obtained (e.g., COCl₂ 6H₂O—C2mpyrFSI/LiFSI). However, unlike the preferred phase compositions formed from Fe(BF₄)₂6H₂O where salt dissolution within the OIPC matrix was indicated by DSC, the conversion electrode composites tended to exhibit capacity fade.

Nonetheless, the examples demonstrate that dispersal of conversion active materials within a OIPC matrix shows promise to enable solid-state electrodes with good capacity and stability. The 3-4V devices described herein can be optimised to achieve theoretical specific energy (e.g. 477 Wh/kg in the Fe(BF₄)₂6H₂O example), high thermal and cycling stability and safe, all solid-state batteries.

To enrich the conversion-type electrodes, we demonstrate here that OIPC electrode design is an effective approach to deliver promising performance for ASSBs. Conversion-type electrodes, including transition metal salts with an anion from the group of oxygen, halogens, chalcogenides, or pnictides, have attracted attention due to their high theoretical specific capacities. At the same time, the scope of known OIPCs is steadily increasing, and considerable progress has been made towards superior electrochemical performance, such as increased ionic conductivity, improved stability, and higher transference number.

New OIPCs with pyrrolidinium, imidazolium, phosphonium, guanidinium, oxazolidinium and metallocenium cations, coupled with a range of anions, such as tetracyanoborate, tetrahalogenoferrate(III), camphorsulfonate, and nonaflate have been discovered and studied intensively. The OIPC electrode strategy opens a new area for developing advanced electrodes based on extensive OIPC families and conversion electrode materials. The strategy revealed here in the cathode materials field could also be applied to the anode, and has the potential to further extend the scope of sodium battery, as well as enriching the battery electrodes library. This pioneering work in the field of organic metal ion hybrid electrode and beyond, with guidelines for future energy metrics to advance towards practical implementations. What is more, in terms of novel materials development, this work offers numerous possibilities for chemical and structural modifications to further increase the redox potential, along with the stored capacity, and improving the cycling stability in the search for practical high-energy batteries.

Example F—OIPC Binders in intercalation type layered oxide and polyanionic cathodes—An OIPC was used as a binder for a LiFePO₄ cathode material in the form of an OIPC-mixed ionic electronic conductor (MIEC) polymer composite binder. The exemplary MIEC polymer used in the OIPC binder composite material herein is PEDOT:PSS which was found to have excellent ionic and electronic conductivities. An OIPC composite binder having an 80/20 ratio of PEDOT:PSS/C2mpyrFSI composite was selected for testing in a battery cell as an electronic and ionic conducting binder. Due to the high electronic and ionic conductivities of the composites, together with the good mechanical properties, they were applied as a conductive binder in solid-state lithium-ion batteries. For the solid-state battery cycling, a source of a certain amount of lithium ions is needed within the electrode to help the cathode discharge. Due to the already reported good interaction between LiFSI salt and C2mpyrFSI OIPC, which leads to even higher ionic conductivity, 80/20 PEDOT:PSS/C2mpyrFSI composite was selected for battery application, to preserve the ion compatibility. The excellent ionic and electronic conductivity of this OIPC-MIEC composite material meant that the electrode could be a carbon-free electrode. A solid-state Li|LiFePO₄ cell comprising the OIPC composite as cathode binder was prepared. taking into account that solid-state battery electrodes normally contain 60 wt. % of active material, the following formulation was proposed and characterized: 60% LFP, 35% of 80/20 PEDOT:PSS/C2mpyrFSI composite and 5% LiFSI. A previously studied ternary polymer electrolyte system (PILBLOC) based on a poly(ionic liquid) block copolymer, N-methyl-N-propylpyrrolidinium bis(fluorosulfonyl)imide (C₃mpyrFSI) ionic liquid and LiFSI was used as solid electrolyte for having good compatibility with lithium metal and stable cycling performance up to 0.20 mA cm⁻² (see U.S. patent application Ser. No. 16/649,753, 2020, Journal of The Electrochemical Society 167 (7), 070525). The cell was tested by galvanostatic charge-discharge using a poly(ionic liquid) solid state electrolyte. The solid-state Li|LiFePO₄ cell with OIPC-MIEC binder showed enhanced discharge capacity (156 mAh g⁻¹ at C/10) and rate capability in comparison to the cell with ionic conducting binder (FIG. 17). Specific capacity of 145 mAh g⁻¹ at C/2 rate was achieved with almost 100% capacity retention after 70 cycles at 70° C. The performance of the cell was better than using a typical ionic conducting binder (130 mAh g⁻¹ at C/2 and 70° C.). It is believed that the OIPC binder in the form of a OIPC-MIEC composite provides an excellent electronic-ionic interconnection within a non-porous electrode for all-solid-state batteries. The measured electronic conductivity of the composites was higher (469 S cm⁻¹) than C65 pellet (2.01±0.17 S cm⁻¹, 583 μm). When the C rate is increased up to C/2, the overpotentials became larger as a consequence of diffusion limitations. This effect is much more evident for PILBLOC electrode than for 80/20 PEDOT:PSS/C₂mpyrFSI cell, whose strongly polarised profile, might be due to the capacitive nature of the binder, led to reach high capacity density. Low overpotentials can be seen at C/10 for both systems, higher capacity for the OIPC-MIEC binder may be due to a better electronic interconnection within the electrode commonly seen when electronic conducting polymers are used in electrode formulations. The summary of obtained values are listed in Table 11 and compared to the reported performances of similar cells. The obtained performances with P:PSS/C₂mpyrFSI binder are highly promising and confirm the ability of PEDOT:PSS/OIPC composites to behave both as high Li⁺ supplier for the active material, in a non-porous configuration, and as outstanding electronic conducting agent.

TABLE 13
Literature review of solid state Li|LFP cells based on inorganic and polymer electrolytes.

| | | Current | | | | |
|---|---|---|---|---|---|---|
| | Cathode formulation | density | C | Specific capacity | LFP loading | Cycling |
| Electrolyte | [LFP/C₆₅/ionic binder] | [mAh cm⁻²] | rate | [mAh g⁻¹] | [mg cm⁻²] | life |
| PILBLOC^{a} | 60/40 P:PSS-OIPC-LiFSI | 0.1 | C/2 | 145 | 1.2 | >70 |
| PILBLOC^{a} | 60/10/30 PILBLOC | 0.1 | C/2 | 130 | 1.2 | 55 |
| PILBLOC-EC-LiFSI^{b} | 60/10/30 PILBLOC | 0.046 | C/10 | 150 | 2.7 | 100 |
| LAGP^{c} | 50/5/45 | 0.272 | C/5 | 120 | 8 | 50 |
| LPO-LLZO^{d} | 50/5/45 | 0.1 | 1.5 C | 120 | 1 | 400 |
| PPE-PEO-PPE (LiTFSI^{e} | 60/10/30 | 0.051 | C/10 | 112 | 3 | 100 |
| P(EO-co-PO)^{f} | 70/15/15 | 0.034 | C/10 | 159 | 2 | 50 |
| PEO (LiTFSI)^{g} | 60/15/25 | 0.128 | C/2 | 122 | 1.5 | 150 |
| PI/DBDPE/PEO/LiTFSI^{h} | 60/15/25 | 0.128 | C/2 | 143 | 1.5 | 300 |

^{a}Poly(ionicliquid)—C₃mpyrFSI—LiFSI;
^{b}Poly(ionic liquid)—ethylene carbonate—LiFSI;
^{c}Li_{1.5}Al_{0.5}Ge_{1.5}(PO₄)₃;
^{d}Li₃PO₄—Li_{6.5}La₃Zr_{1.5}Ta_{0.5}O₁₂;
^{e}Crosslinked poly(ethylene oxide-co-polyphosphoester)—LiTFSI;
^{f}Poly(ethylene oxide)—LiTFSI
^{g}Poly(ethylene oxide-co-polypropylene oxide)—LiTFSI;
^{h}Polyimide—decabromodiphenyl ethane—poly(ethylene oxide)—LiTFSI

In a further example, the OIPC binder was combined with LiFePO₄ intercalation electrode (FIG. 19, FIG. 20) and with Li₂MnO₄ intercalation electrode (FIG. 21) at thicker electrode loadings, 1.1 mAhcm⁻². In these examples the previously used PILBLOC electrolyte was employed and the OIPC binder was used with conventional PVdF polymer and C65 carbon additive. The LiFePO₄ cells demonstrated excellent stability retaining almost 100% capacity after 50 cycles at C/20-C/10 at 50° C. (FIG. 19). The same electrodes also showed excellent stability up to 70 cycles at 50° C. at higher rates, up to C/2, with high cycling efficiency (FIG. 20). An equivalent cell, prepared with a higher voltage Li₂MnO₄ cathode (FIG. 21), also sustained reliable cycling, retaining 98 mAhg⁻¹ and 84.5% of the initial discharge capacity after 180 cycles. These results highlight the use of the OIPC binder in a conventional electrode formulation and the effective use in ASSBs, using conventional electrode thin film processing techniques and binders and conductive additives.

### Experimental Section

Materials: Poly(3,4-ethylenedioxythiophene):Poly(styrene sulfonate) (Clevios PH 1000), 1.3 wt. % solids in water, was supplied by Heraeus Inc. N-ethyl-N-methylpyrrolidinium bis(trifluoromethylsulfonylimide) (C₂mpyrTFSI) (99%) was purchased from IoLiTec while N-ethyl-N-methylpyrrolidinium bis(fluorosulfonylimide) (C₂mpyrFSI) was synthesized as previously reported.^{[25]} N-propyl-N-methylpyrrolidinium bis(fluorosulfonyl)imide (C₃mpyrFSI, 99.5%) was supplied by Solvionic. Lithium iron phosphate (LiFePO₄) (ALEEES) and Super C65 (Timcal). 1-Methyl-2-pyrrolidinone (NMP) (99.5%) was purchased from Sigma Aldrich. PILBLOC polymer was obtained as in previously reported work. (See U.S. patent application Ser. No. 16/649,753, 2020 and Journal of The Electrochemical Society 167 (7), 070525, the content of which is incorporated by reference.

### Solid-State Electrolyte:

Cathode preparation: The mixed conducting binder-LiFePO₄ based slurry was prepared by first dispersing freeze dried PEDOT:PSS, C2mpyrFSI and LiFSI in DMSO and finally the active material powder in weighted ratio of 60/28/7/5 (LiFePO₄/PEDOT:PSS/C2mpyrFSI/LiFSI). The PILBLOC-LiFePO₄ electrodes were obtained by mixing an optimized PILBLOC (LiFSI: 2 mol; C₃mpyrFSI: 1 mol) from a previous work with the corresponding amounts in weighted ratio: 60 LiFePO₄/10 C₆₅/30 PILBLOC in NMP. The prepared slurries was casted onto carbon coated aluminium current collector by using a doctor blade, then dried at room temperature and finally dried at 60° C. under vacuum overnight. No liquid electrolyte was used to wet the cathode as the ionic conduction of lithium is ensured by the use of mixed conductor binder and lithium salt. The resulting mass loading of the electrodes was 1.2 mg cm⁻² in both systems.

Cell characterization: Li|LiFePO₄ cells (CR2032) were assembled inside an argon glovebox using 50 μm lithium foil. Galvanostatic cycling was performed using a battery tester (Neware) at 70° C., which was the optimum temperature for the electrolyte.

Example G—OIPC Binder in Silicon Anode—A silicon anode with a [C₂mpyr][FSI] composite binder as described here was prepared and cell performance compared with that of a Si anode with a liquid electrolyte binder (LP30−1 M LiPF₆ in EC-DMC (1:1 vol %)).

The Si/[C₂mpyr][FSI] electrode was used with a PVdF/[C₂mpyr][FSI] OIPC interlayer and a lithium metal anode as described elsewhere herein. The Si/[C₂mpyr][FSI] composite anode electrode has a Si:carbon black: Na-CMC:[C₂mpyr][FSI]:LFSI content as follows: 59.5:12.8:9.2:5.8 wt %. The Si/[C₂mpyr][FSI] composite anode was used at an loading of 0.22-0.28 mg/cm² and a density of 0.20-0.43 g/cm3. The Si electrode was used with a LP30 electrolyte and Celgard 3501 separator and a lithium metal anode as described elsewhere herein. The Si anode used as a Si:carbon black:Na-CMC content as follows: 70:15:15 wt %. The test conditions were as follows: Charging—0.07V, 0.02 C-CC; Discharging—1.0 V, 0.02 C-CC; rest—10 mins between charge and discharge; temperature −50° C.

The charge-discharge profiles are shown in FIG. 18. The thin coatings led to error in the determined specific capacity values, hence the larger than theoretical specific capacity values obtained. However, the coatings were obtained by the same process and hence comparison between the cells are valid. The OIPC binder electrode performance is shown to generally match the performance of the liquid electrolyte, both electrodes exhibiting relatively rapid capacity fade with cycling, a well-known problem with high utilization cycling of Si anodes. The OIPC/Si electrode displayed 79.4% 1^{st} cycle efficiency and 5879 mAhg⁻¹ delithiation capacity (56.9% retention of the 1st cycle delithiation) by the 5^{th} cycle. In comparison, the Si anode without OIPC displayed 78.6% 1^{st} cycle efficiency and 4975 mAhg⁻¹ (59.7% retention) by the 5^{th} cycle. The results show that the performance of the ASSB Si/OIPC electrode can match the performance of the liquid cell using a commercial electrolyte.

1. An electrochemical energy storage device comprising at least one positive electrode and at least one negative electrode pair, wherein at least one electrode is a solid-state electrode in the form of a dry electrode composition comprising:
particles of an electrochemically active material;
optional particles of electronically conductive additive;
optional particles of a non-ionically conducting polymer binder; and
an internal ionic binder in the form of a preformed intimate composite of organic ionic plastic crystal (OIPC) and transport ion salt, wherein a majority of voids between particles are fully or partially filled with a concentrated or discrete portion of the preformed intimate composite.

2. The device of claim 1, wherein voids between the particles blocking ion conducting pathways in the electrode are substantially filed with the internal ionic binder in composite form thereby unblocking and/or increasing ion conducting pathways in the electrode.

3. The device of claim 1, wherein the dry electrode composition is free of one or more of: ionically conducting polymer electrolyte or monomer of ionically conducting polymer electrolyte, organic solvent, ionic liquid that is not an OIPC, polymerizable ionic liquid monomer and/or a polymerised poly(ionic liquid), ionogel, polyionic liquid ionogel and/or a polymerisation initiator such as AIBN.

4. The device of claim 1, configured as an all-solid state energy storage device and further comprising an ion transport interlayer disposed between each pair of the electrodes, where a separated portion of interlayer is in direct contact with each electrode in a pair, and contact between the ion transport interlayer and each electrode involves substantially void free contact.

5. The device of claim 4, wherein the ion transport interlayer is an ion transport membrane incorporating one or more of an OIPC, an ionic liquid, and an ion transport salt, e.g., a solid electrolyte composite including an OIPC and an ion transport salt.

6. The device of claim 4, wherein the ion transport interlayer comprises OPIC and an ion transport salt which are the same as the OIPC and ion transport salt of the solid state electrode.

7. The device of claim 4, wherein the ion transport interlayer is a membrane which is a polypropylene separator filled with Li-doped [C₂mpyr][FSI] electrolyte, or a polypropylene separator filled with Li-doped [P₁₂₂₂][FSI] electrolyte, preferably 50:50 mol % OIPC to ion transport salt.

8. The device of claim 1, wherein the OIPC to transport ion salt ratio in the composite is between about 9:1 to about 1:9 mol % or between about 9:1 to about 1:9 wt %, preferably, about 1:1 mol % or about 1:1 wt %.

9. The device of claim 1, wherein the internal ionic binder is present in an amount of at least about 15 wt % and not more than about 50 wt % of the total electrode composition.

10. The device of claim 1, wherein the internal ionic binder is homogeneously dispersed throughout the dry electrode composition once compacted.

11. The device of claim 1, wherein the internal ionic binder coats particles of the electrochemically active agent only, coats particles of conductivity enhancing additive included in the electrode composition only, or simultaneously coats particles of the electrochemically active agent and particles of conductivity enhancing agent included in the composition.

12. (canceled)

13. (canceled)

14. The device of claim 1, wherein the ion transport salt is an alkali metal, alkaline earth metal salt, or transition metal salt, preferably LiFSI, LiBF₄, LiTFSI, LiOTf₂, NaFSI, NaBF₄, NaTSI, NaTFSI, or NaOTf₂.

15. The device of claim 1, wherein one electrode of each electrode pair is a positive electrode (cathode) comprising a positive electrochemically active material selected from a layered metal oxide; a polyanionic compound; sulfur; and a conversion reaction material involving a redox centre.

16. The device of claim 15, wherein the positive electrochemically active material comprises a transition metal material selected from lithium cobalt oxide (LCO), lithium iron phosphate (LFP), lithium manganese phosphate (LMP), lithium nickel manganese cobalt oxide (NMC), lithium nickel cobalt oxide doped with alumina (NCA), lithium manganese oxide (LMO) or the positive electrochemically active conversion reaction material involving a redox centre is a transition metal ion based redox couple selected from Fe²⁺/Fe³⁺, Co²⁺/Co³⁺, Ni²⁺/Ni³⁺, Mn²⁺/Mn³⁺ or Cu²⁺/Cu³⁺ or the positive electrochemically active conversion reaction material involving a redox centre is a transition metal ion based redox couple involving Fe(BF₄)·6H₂O, Fe(BF₄)₂·6H₂O, Co(II)TFSI, Fe(II)Triflate or Ni(PO₃)₂.

17. The device of claim 1, wherein one electrode of each electrode pair is a negative electrode comprising a negative electroactive material selected from hard carbon; graphite; silicon; lithium; sodium; iron; manganese, phosphorus; antimony; bismuth, selenium, lithium alloys such as lithium titanates particularly lithium titanium oxide.

18. The device of claim 1, wherein a cation of the organic ionic plastic crystal (OPIC) compound of the ionic internal binder is selected from the group consisting of: [N_{1,1,1,1}], [N_{1,2,2,2}], [hexamethylguanidinium], [C₂mpyr], [P_{1,2,2,2}], [P_{1,2,2,i4}], [P_{1,4,4,4}], [H₂im], [Hmim], [N_{2,2,3,3}], [N_{3,3,3,3}], [C₂epyr], [C₁moxa][FSI], [C₂mmor], [C₁₀₁mpyr], [C₁mpyr], [C₄mpyr], [(NH₂)₃], [2-Me-im], and [TAZm], and an anion of the organic ionic plastic crystal (OPIC) compound of the ionic internal binder is selected from the group consisting of: [DCA], [BF₄], [TFSI], [FSI], [PF₆],[Tf], [BBu₄], [TCM], [DFTFSI], [FTFSI], [(FH)₂F], [PFBS], preferably the OIPC is selected from [N_{1,1,1,1}][DCA], [N_{1,2,2,2}][BF₄], [P_{1,2,2,2}][TFSI], [hexamethylguanidinium][TFSI], [hexamethylguanidinium][BF₄], [hexamethylauanidinium][FSI], [C₂mpyr][BF₄], [C₂mpyr][FSI], [C₂mpyr][TFSI], [C₂mpyr][BF₄], [P_{1,2,2,2}][FSI], [P_{1,2,2,i4}][PF₆], [P_{1,4,4,4}][FSI], [H₂im][Tf], [Hmim][Tf], [N_{2,2,3,3}][BBu₄], [N_{3,3,3,3}][BF₄], [C₂epyr][TFSI], [C₂epyr][FSI], [C₂epyr][PF₆], [C₂epyr][BF₄], [C₁moxa][FSI], [C₂moxa][FSI], [C₁moxa][TFSI](oxa=oxazolidinium), [C₂mmor][FSI], [C₂mmor][TFSI], [C₂mmor][BF₄](mor=morpholinium), [C₁₀₁mpyr][FSI], [C₂mpyr][TCM], [C₂mpyr][DFTFSI], [C₂mpyr][FTFSI], [C₁mpyr][(FH)₂F] and [C₂mpyr][(FH)₂F], [C₄mpyr][TFSI], [(NH₂)₃][Tf], [2-Me-im][Tf], and [TAZm][PFBS].

19. (canceled)

20. The device of claim 1, wherein the OPIC of the internal ionic binder is selected from the group consisting of: C₂mpyrBF₄; C₂mpyrFSI; and C₂mpyrTFSI.

21. (canceled)

22. An all-solid-state energy device comprising at least one positive electrode and at least one negative electrode pair,
wherein the negative electrode is an alloying or an insertion type solid state negative electrode, comprising a dry electrode composition including:
particles of an electrochemically active material selected from hard carbon, graphite; silicon; phosphorus; selenium; antimony; bismuth; lithium alloys such as lithium titanates, particularly lithium titanium oxide; or metallic anode materials such as lithium metal and sodium metal;
optional particles of electronically conductive additive;
optional particles of a non-ionically conducting polymer binder; and
an internal ionic binder in the form of a preformed intimate composite of organic ionic plastic crystal (OIPC) selected from the group consisting of:
C₂mpyrBF₄; C₂mpyrFSI; and C₂mpyrTFSI, and transport ion salt selected from the group consisting of LiFSI, LiBF₄, LiTFSI, LiOTf₂, NaFSI, NaBF₄, NaTSI, NaTFSI, or NaOTf₂.

23. An all-solid-state energy device comprising at least one positive electrode and at least one negative electrode pair, and an ion transport interlayer comprising at least an organic ionic plastic crystal (OIPC) selected from the group consisting of: C₂mpyrBF₄; C₂mpyrFSI; and C₂mpyrTFSI, and transport ion salt selected from the group consisting of LiFSI, LiBF₄, LiTFSI, LiOTf₂, NaFSI, NaBF₄, NaTSI, NaTFSI, or NaOTf₂, disposed between each pair of the electrodes, where a separate portion of interlayer is in direct contact with each electrode in a pair,
wherein the negative electrode is an alloying or an insertion type solid-state negative electrode free of ionically conducting polymer electrolyte or monomer of ionically conducting polymer electrolyte, comprising a dry electrode composition including:
particles of an electrochemically active material selected from hard carbon, graphite; silicon; phosphorus; selenium; antimony; bismuth; lithium alloys such as lithium titanates, particularly lithium titanium oxide; or metallic anode materials such as lithium metal and sodium metal;
optional particles of electronically conductive additive;
optional particles of a non-ionically conducting polymer binder; and
an internal ionic binder in the form of a preformed intimate composite of organic ionic plastic crystal (OIPC) and transport ion salt which are the same as the OIPC and the transport ion salt in the ion transport interlayer.

24. (canceled)

25. (canceled)

26. The electrochemical energy storage device of claim 1, wherein the electrochemically active material of the positive electrode (cathode) comprises a conversion reaction material involving a redox centre,
wherein the conversion reaction material comprises a transition metal ion based redox couple selected from Fe²⁺/Fe³⁺, CO²⁺/CO³⁺, Ni²⁺/Ni³⁺, Mn²⁺/Mn³⁺ or Cu²⁺/Cu³⁺ or the positive electrochemically active conversion reaction material involving a redox centre is a transition metal ion based redox couple involving Fe(BF₄)·6H₂O, Fe(BF₄)₂·6H₂O, Co(II)TFSI, Fe(II)Triflate or Ni(PO₃)₂.
